(19) United States
(12) Patent Application Publication
(10) Pub. No.: US 2018/0192076 A1
(43) Pub. Date: Jul. 5, 2018

(54) IMAGE DECODING DEVICE IMAGE CODING DEVICE

(71) Applicant: Sharp Kabushiki Kaisha, Sakai City, Osaka (JP)

(72) Inventors: Tomohiro IKAI, Sakai City (JP); Takeshi TSUKUBA, Sakai City (JP)

(21) Appl. No.: 15/735,979

(22) PCT Filed: Jun. 2, 2016
(86) PCT No.: PCT/JP2016/066495

§ 371 Date: Dec. 13, 2017

(30) Foreign Application Priority Data
Jun. 16, 2015 (JP) 2015-120967

(51) Int. Cl. H04N 19/96; H04N 19/44; H04N 19/157; H04N 19/46

(52) U.S. Cl. CPC H04N 19/96; H04N 19/46; H04N 19/157; H04N 19/44

(57) ABSTRACT

A method of reducing information about the residual in a partial region and a method of switching prediction blocks and transform blocks with a high degree of freedom by quadtree partitioning are combined to realize an efficient coding/decoding process. In an image decoding device that decodes by partitioning a picture into coding tree block units, there are provided: a coding tree partitioning section that recursively partitions the coding tree block as a root coding tree; a CU partitioning flag decoding section that decodes a coding unit partitioning flag indicating whether or not to partition the coding tree; and a residual mode decoding section that decodes a residual mode indicating whether to decode a residual of the coding tree and below in a first mode, or in a second mode different from the first mode.

### TECHNICAL FIELD

The present invention relates to an image decoding device that decodes coded data expressing an image, and an image coding device that generates coded data by coding an image.

### BACKGROUND ART

In order to efficiently transmit or record video images, there are used a video image coding device that generates coded data by coding video images, and a video image decoding device that generates decoded images by decoding such coded data.

Specific video image coding schemes include, for example, H.264/MPEG-4 AVC, and the scheme (see NPL 1) proposed in the successor codec, High-Efficiency Video Coding (HEVC).

In such video image coding schemes, an image (picture) constituting a video image is managed with a hierarchical structure made up of slices obtained by partitioning an image, coding units (CUs) obtained by partitioning slices, as well as prediction units (PUs) and transform units (TUs), which are blocks obtained by partitioning coding units. Ordinarily, an image is coded on a per-block basis.

Also, in such video image coding schemes, ordinarily a predicted image is generated on the basis of a locally decoded image obtained by coding/decoding an input image, and the prediction residual (also called the “differential image” or “residual image”) obtained by subtracting the predicted image from the input image (original image) is coded. Also, inter-frame prediction (inter prediction) and intra-frame prediction (intra prediction) may be cited as methods of generating predicted images.

In NPL 1, there is known technology that, by using quadtree partitioning to realize the coding units and transform units described above, selects block sizes with a high degree of freedom, and strikes a balance between code rate and precision.

In NPL 2, NPL 3, and NPL 4, there is known technology called adaptive resolution coding (ARC) or reduced resolution update (RRU) that reduces the code rate by lowering the internal resolution in units of pictures.

### CITATION LIST

### Non Patent Literature

NPL 1: ITU-T Rec. H.265(V2), (published 29 Oct. 2014)

NPL 2: ITU-T Rec. H.263 Annex P and Annex Q

NPL 3: T. Davies, P. Topiwala, “AHG18: Adaptive Resolution Coding (ARC)”, JCTVC-G264, 7th Meeting: Geneva, CH, 21-30 Nov. 2011

NPL 4: Alexis Tourapis, Lowell Winger, “Reduced resolution update mode for enhanced compression”, JCTVC-H0447, 8th Meeting: San Jose, Calif., USA, 1-10 February, 2012

### SUMMARY OF INVENTION

### Technical Problem

However, in NPL 2, NPL 3, and NPL 4, there is a problem in that a method of effectively combining slice partitioning and quadtree partitioning that conducts block size selection with a high degree of free with a method of reducing the internal resolution is unclear.

Furthermore, in the case of conducting a resolution change, since the influence on the reduction amount (quantization) of coded data in related to the resolution change is not considered, there is a problem in that a static code rate drop and quality drop occur. In other words, a method of controlling the code rate reduction and quality drop with respect to a region on which to conduct a resolution transform is not known.

### Solution to Problem

One aspect of the present invention is an image decoding device that decodes by partitioning a picture into coding tree block units, characterized by comprising: a coding tree partitioning section that recursively partitions the coding tree block as a root coding tree; a CU partitioning flag decoding section that decodes a coding unit partitioning flag indicating whether or not to partition the coding tree; and a residual mode decoding section that decodes a residual mode indicating whether to decode a residual of the coding tree and below in a first mode, or in a second mode different from the first mode.

One aspect of the present invention is characterized in that the residual mode decoding section decodes the residual mode (rru_flag) from the coded data only in the highest-layer coding tree, and does not decode the residual mode (rru_flag) in lower coding trees.

One aspect of the present invention is characterized in that the residual mode decoding section decodes the residual mode only in the coding tree of a designated layer, and skips the decoding of the residual mode outside the coding tree of a designated layer in lower coding trees.

One aspect of the present invention is characterized in that, in a case in which the residual mode indicates decoding in the second mode, the CU partitioning flag decoding section decreases the partitioning depth by 1 compared to a case in which the residual mode indicates decoding in the first mode.

One aspect of the present invention is characterized in that the CU partitioning flag decoding section, in a case in which the residual mode is the first mode, decodes the CU partitioning flag from the coded data in a case in which a size of the coding tree, namely a coding block size (log2CbSize) is greater than a minimum coding block (MinCbLog2Size), in a case in which the residual mode is the second mode, decodes the CU partitioning flag from the coded data in a case in which the size of the coding tree, namely the coding block size (log2CbSize) is greater than the minimum coding block (MinCbLog2Size+1), and in all other cases, skips the decoding of the CU partitioning flag, and derives the CU partitioning flag as 0, which indicates not to partition.

One aspect of the present invention is characterized in that the residual mode decoding section decodes the residual mode in a leaf coding tree, namely a coding unit.

One aspect of the present invention is characterized by additionally comprising: a skip flag decoding section that, in the leaf coding tree, namely the coding unit, decodes a skip flag indicating whether or not to decode by skipping the decoding of the residual, wherein the residual mode decoding section, in the coding unit, decodes the residual mode in a case in which the skip flag indicates not to decode the residual, and in all other cases, does not decode the residual mode.

One aspect of the present invention is characterized by additionally comprising: a CBF flag decoding section that decodes a CBF flag indicating whether or not the coding unit includes the residual, wherein the residual mode decoding section, decodes the residual mode in a case in which the CBF flag indicates that the residual exists, and in all other cases, derives the residual mode indicating that the residual mode is the first mode.

One aspect of the present invention is characterized in that the residual mode decoding section decodes the residual mode from the coded data in a case in which a size of the coding tree, namely a coding block size (log2CbSize), is greater than a predetermined minimum coding block size (MinCbLog2Size), and in all other cases, derives the residual mode as the first mode in a case in which the residual mode does not exist in the coded data.

One aspect of the present invention is characterized by additionally comprising: a PU partitioning mode decoding section that decodes a PU partitioning mode indicating whether or not to further partition the coding unit into prediction blocks, wherein the residual mode decoding section decodes the residual mode only in a case in which the PU partitioning mode is a value indicating not to PU partition, and in all other cases, does not decode the residual mode.

One aspect of the present invention is characterized by additionally comprising: a PU partitioning mode decoding section that decodes a PU partitioning mode indicating whether or not to further partition the coding unit into prediction blocks, wherein the PU partitioning mode decoding section, in a case in which the residual mode indicates the second mode, skips the decoding of the PU partitioning mode, and derives a value indicating not to PU partition, and in a case in which the residual mode indicates the first mode, decodes the PU partitioning mode.

One aspect of the present invention is characterized by additionally comprising: a PU partitioning mode decoding section that decodes a PU partitioning mode indicating whether or not to further partition the coding unit into prediction blocks, wherein the PU partitioning mode decoding section, in a case in which the residual mode indicates the second mode, decodes the PU partitioning mode if the coding block size (log2CbSize) is equal to the sum of the minimum coding block (MinCbLog2Size) and 1 (MinCbLog2Size+1), in a case in which the residual mode indicates the first mode, decodes the PU partitioning mode if inter or if the coding block size (log2CbSize) is equal to the minimum coding block (MinCbLog2Size), and in all other cases, skips the decoding of the PU partitioning mode, and derives a value indicating not to PU partition.

One aspect of the present invention is characterized by additionally comprising: a TU partitioning mode decoding section that decodes a TU partitioning mode indicating whether or not to further partition the coding unit into transform blocks, wherein the TU partitioning mode decoding section, in a case in which the residual mode indicates the second mode, decodes the TU partitioning flag if the coding block size (log2CbSize) is less than or equal to the sum of a maximum transform block (MaxTbLog2SizeY) and 1 (MaxTbLog2SizeY+1) and also greater than the sum of a minimum transform block (MinCbLog2Size) and 1 (MinCbLog2Size+1), in a case in which the residual mode indicates the first mode, decodes the TU partitioning flag if the coding block size (log2CbSize) is less than or equal to the maximum transform block (MaxTbLog2SizeY) and also greater than the minimum transform block (MinCbLog2Size), and in all other cases, skips the decoding of the TU partitioning flag, and derives a value of the TU partitioning flag indicating not to partition.

One aspect of the present invention is characterized by additionally comprising: a TU partitioning mode decoding section that decodes a TU partitioning mode indicating whether or not to further partition the coding unit into transform blocks, wherein the TU partitioning mode decoding section, in a case in which the residual mode indicates the second mode, decodes the TU partitioning flag if a coding transform depth (trafoDepth) is less than the difference between a maximum coding depth (MaxTrafoDepth) and 1 (MaxTrafoDepth−1), in a case in which the residual mode indicates the first mode, decodes the TU partitioning flag if the coding transform depth (trafoDepth) is less than the maximum coding depth (MaxTrafoDepth), and in all other cases, skips the decoding of the TU partitioning flag, and derives a value indicating not to partition.

One aspect of the present invention is characterized by additionally comprising: a residual decoding section that decodes the residual; and an inverse quantization section that inversely quantizes that inversely quantizes the decoded residual, wherein the inverse quantization section, in a case in which the residual mode is the first mode, performs inverse quantization according to a first quantization step, and in a case in which the residual mode is the second mode, performs inverse quantization according to a second quantization step derived from the first quantization step.

One aspect of the present invention is characterized by additionally comprising: a quantization step control information decoding section that decodes a quantization step correction value, wherein the inverse quantization section derives the second quantization step by adding the quantization step correction value of the first quantization step.

One aspect of the present invention is an image decoding device that partitions a picture into units of slices, and further partitions each slice into units of coding tree blocks, characterized in that a highest-layer block size inside each slice is made to be variable.

One aspect of the present invention is characterized in that a value indicating a horizontal position and a value indicating a vertical position of a beginning of a slice are decoded.

One aspect of the present invention is characterized in that a value indicating a beginning address of the beginning of the slice is decoded, and on a basis of a smallest block size among highest-layer block sizes available for selection, the horizontal position and the vertical position of a slice beginning position or a target block are derived.

### Advantageous Effects of Invention

The present invention, by coding a residual mode that codes the residual at a lower code rate in a layer containing the beginning of a slice or a quadtree, exhibits an advantageous effect of being able to combine slice partitioning and quadtree partitioning that conduct block size selection with a high degree of freedom with a residual reduction in a specific region, and achieve optimal coding efficiency.

### BRIEF DESCRIPTION OF DRAWINGS

FIG. 1 is a function block diagram illustrating an exemplary configuration of a CU information decoding section and a decoding module provided in a video image decoding device according to an embodiment of the present invention.

FIG. 2 is a function block diagram illustrating a schematic configuration of the above video image decoding device.

FIG. 3 is a diagram illustrating the data structure of coded data generated by a video image coding device according to an embodiment of the present invention, and decoded by the above video image decoding device, in which FIGS. 3(a) to 3(d) are diagrams illustrating the picture layer, the slice layer, the tree block layer, and the CU layer, respectively.

FIG. 4 is a diagram illustrating patterns of PU partition types, in which (a) to (h) illustrate the partition format for the case of the PU partition type being 2N×2N, 2N×N, 2N×nU, 2N×nD, N×2N, nL×2N, nR×2N, and N×N, respectively.

FIG. 5 is a flowchart explaining the schematic operation of a CU information decoding section 11 (CTU information decoding S1300, CT information decoding S1400) according to an embodiment of the invention.

FIG. 6 is a flowchart explaining the schematic operation of the CU information decoding section 11 (CT information decoding S1500), a PU information decoding section (PU information decoding S1600), and a TU information decoding section 13 (TU information decoding S1700) according to an embodiment of the invention.

FIG. 7 is a flowchart explaining the schematic operation of the TU information decoding section 13 (TT information decoding S1700) according to an embodiment of the invention.

FIG. 8 is a flowchart explaining the schematic operation of the TU information decoding section 13 (TU information decoding S1760) according to an embodiment of the invention.

FIG. 9 is a diagram illustrating an exemplary configuration of a CU information syntax table according to an embodiment of the present invention.

FIG. 10 is a diagram illustrating an exemplary configuration of a CU information, PT information PTI, and TT information TTI syntax table according to an embodiment of the present invention.

FIG. 11 is a diagram illustrating an exemplary configuration of a PT information PTI syntax table according to an embodiment of the present invention.

FIG. 12 is a diagram illustrating an exemplary configuration of a TT information TTI syntax table according to an embodiment of the present invention.

FIG. 13 is a diagram illustrating an exemplary configuration of a TU information syntax table according to an embodiment of the present invention.

FIG. 14 is a diagram illustrating an exemplary configuration of a prediction residual syntax table according to an embodiment of the present invention.

FIG. 15 is a diagram illustrating an exemplary configuration of a prediction residual information syntax table according to an embodiment of the present invention.

FIG. 16 is a flowchart explaining the schematic operation of the TU information decoding section 13 (TU information decoding S1760A) according to an embodiment of the invention.

FIG. 17 is a flowchart explaining the schematic operation of a prediction image generating section 14 (prediction residual generation S2000), an inverse quantization/inverse transform section 15 (inverse quantization/inverse transform S3000A), and an adder 17 (decoded image generation S4000) according to an embodiment of the invention.

FIG. 18 is a flowchart explaining the schematic operation of the prediction image generating section 14 (prediction residual generation S2000), the inverse quantization/inverse transform section 15 (inverse quantization/inverse transform S3000A), and the adder 17 (decoded image generation S4000) according to an embodiment of the invention.

FIG. 19 is a flowchart explaining the schematic operation of the inverse quantization/inverse transform section 15 (inverse quantization/inverse transform S3000B) according to an embodiment of the invention.

FIG. 20 is a flowchart explaining the schematic operation of the inverse quantization/inverse transform section 15 (inverse quantization/inverse transform S3000B) according to an embodiment of the invention.

FIG. 21 is a diagram illustrating the data structure of coded data generated by the video image coding device according to an embodiment of the present invention, and decoded by the above video image decoding device.

FIG. 22 is a diagram illustrating an exemplary configuration of a CU information syntax table according to an embodiment of the present invention.

FIG. 23 is a flowchart explaining the schematic operation of the CU information decoding section 11 (CTU information decoding S1300, CT information decoding S1400A) according to an embodiment of the invention.

FIG. 24 is a flowchart explaining the schematic operation of a CU information decoding section 11 (CTU information decoding S1300, CT information decoding S1400) according to an embodiment of the invention.

FIG. 25 is a diagram illustrating the data structure of coded data generated by the video image coding device according to an embodiment of the present invention, and decoded by the above video image decoding device.

FIG. 26 is a diagram illustrating an exemplary configuration of a CU information syntax table according to an embodiment of the present invention.

FIG. 27 is a flowchart explaining the schematic operation of a CU information decoding section 11 (CTU information decoding S1300, CT information decoding S1400) according to an embodiment of the invention.

FIG. 28 is a flowchart explaining the schematic operation of the CU information decoding section 11 (CTU information decoding S1300, CT information decoding S1400) according to an embodiment of the invention.

FIG. 29 is a diagram illustrating the data structure of coded data generated by the video image coding device according to an embodiment of the present invention, and decoded by the above video image decoding device.

FIG. 30 is a diagram illustrating an exemplary configuration of a CU information syntax table according to an embodiment of the present invention.

FIG. 31 is a flowchart explaining the schematic operation of the CU information decoding section 11 (CTU information decoding S1300, CT information decoding S1400) according to an embodiment of the invention.

FIG. 32 is a flowchart explaining the schematic operation of the CU information decoding section 11 (CTU information decoding S1300, CT information decoding S1400) according to an embodiment of the invention.

FIG. 33 is a diagram illustrating the data structure of coded data generated by the video image coding device according to an embodiment of the present invention, and decoded by the above video image decoding device.

FIG. 34 is a diagram illustrating an exemplary configuration of a CU information, PT information PTI, and TT information TTI syntax table according to an embodiment of the present invention.

FIG. 35 is a flowchart explaining the schematic operation of the CU information decoding section 11 (CU information decoding S1500), the PU information decoding section 12 (PU information decoding S1600), and the TU information decoding section 13 (TU information decoding S1700) according to an embodiment of the invention.

FIG. 36 is a diagram illustrating the data structure of coded data generated by the video image coding device according to an embodiment of the present invention, and decoded by the above video image decoding device.

FIG. 37 is a diagram illustrating an exemplary configuration of a CU information, PT information PTI, and TT information TTI syntax table according to an embodiment of the present invention.

FIG. 38 is a flowchart explaining the schematic operation of the CU information decoding section 11 (CU information decoding S1500), the PU information decoding section 12 (PU information decoding S1600), and the TU information decoding section 13 (TU information decoding S1700) according to an embodiment of the invention.

FIG. 39 is a diagram illustrating the data structure of coded data generated by the video image coding device according to an embodiment of the present invention, and decoded by the above video image decoding device.

FIG. 40 is a diagram illustrating an exemplary configuration of a transform tree information TTI syntax table according to an embodiment of the present invention.

FIG. 41 is a flowchart explaining the schematic operation of the TU information decoding section 13 (TU information decoding S1700) according to an embodiment of the invention.

FIG. 42 is a diagram illustrating an exemplary configuration of a CU information, PT information PTI, and TT information TTI syntax table according to an embodiment of the present invention.

FIG. 43 is a flowchart explaining the schematic operation of the CU information decoding section 11 (CU information decoding S1500), the PU information decoding section 12 (PU information decoding S1600), and the TU information decoding section 13 (TU information decoding S1700) according to an embodiment of the invention.

FIG. 44 is a diagram illustrating an exemplary configuration of a CU information, PT information PTI, and TT information TTI syntax table according to an embodiment of the present invention.

FIG. 45 is a flowchart explaining the schematic operation of the CU information decoding section 11 (CU information decoding S1500), the PU information decoding section 12 (PU information decoding S1600), and the TU information decoding section 13 (TU information decoding S1700) according to an embodiment of the invention.

FIG. 46 is a diagram illustrating an exemplary configuration of a TT information TTI syntax table according to an embodiment of the present invention.

FIG. 47 is a flowchart explaining the schematic operation of the TU information decoding section 13 (TU information decoding 1700) according to an embodiment of the invention.

FIG. 48 is a diagram illustrating the data structure of coded data generated by the video image coding device according to an embodiment of the present invention, and decoded by the above video image decoding device.

FIG. 49 is a diagram explaining a configuration that uses a different coding tree block for each picture according to an embodiment of the present invention.

FIG. 50 is a diagram explaining a configuration that uses a different coding tree block (highest-layer block size) for each slice within a picture according to an embodiment of the present invention.

FIG. 51 is a diagram explaining the problem of the slice beginning position in the case of using a different coding tree block (highest-layer block size) for each slice within a picture according to an embodiment of the present invention.

FIG. 52 is a diagram explaining an example of including the horizontal position and vertical position of the slice beginning position in coded data in the case of using a different coding tree block (highest-layer block size) for each slice within a picture according to an embodiment of the present invention.

FIG. 53 is a diagram explaining a method of deriving the horizontal position and vertical position of the slice beginning position from the slice address slice_segment_address in the case of using a different coding tree block (highest-layer block size) for each slice within a picture according to an embodiment of the present invention.

FIG. 54 is a diagram explaining the problem of the slice beginning position in the case of using a different coding tree block (highest-layer block size) for each slice within a picture according to an embodiment of the present invention.

FIG. 55 is a flowchart explaining a resolution change mode decoding process in the case of using a different coding tree block (highest-layer block size) for each slice within a picture according to an embodiment of the present invention.

FIG. 56 is a function block diagram illustrating a schematic configuration of the video image coding device according to an embodiment of the present invention.

FIG. 57 is a diagram illustrating a configuration of a transmitting device equipped with the above video image coding device, and a receiving device equipped with the above video image decoding device, in which (a) illustrates the transmitting device equipped with the above video image coding device, and (b) illustrates the receiving device equipped with the above video image decoding device.

FIG. 58 is a diagram illustrating a configuration of a recording device equipped with the above video image coding device, and a playback device equipped with the above video image decoding device, in which (a) illustrates the recording device equipped with the above video image coding device, and (b) illustrates the playback device equipped with the above video image decoding device.

### DESCRIPTION OF EMBODIMENTS

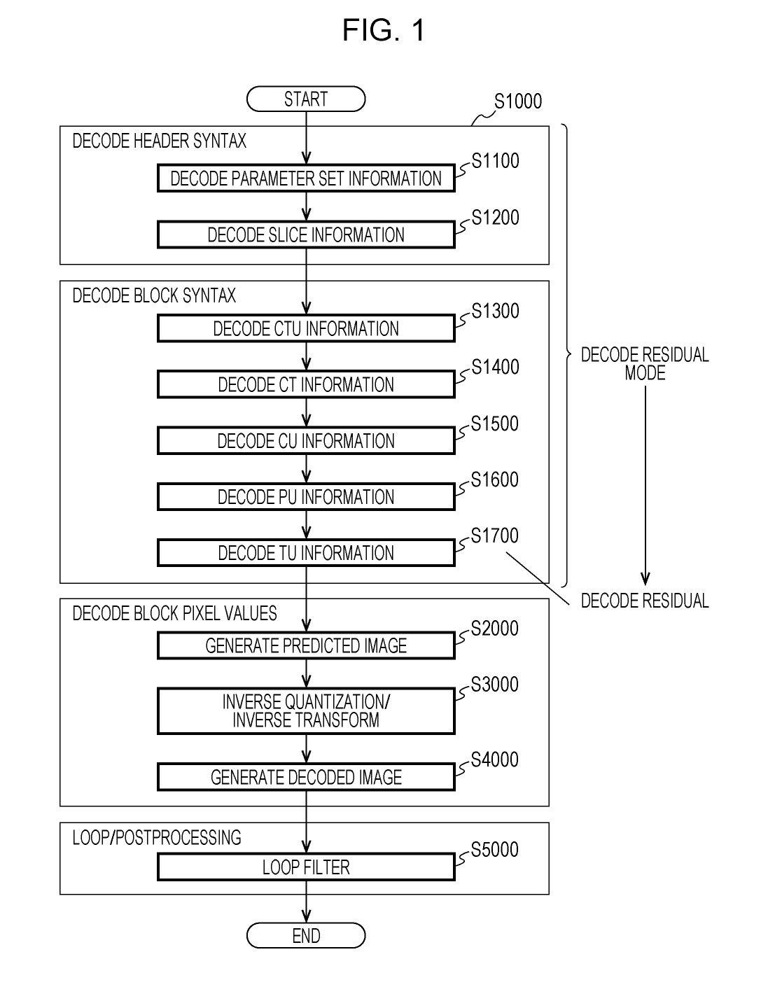

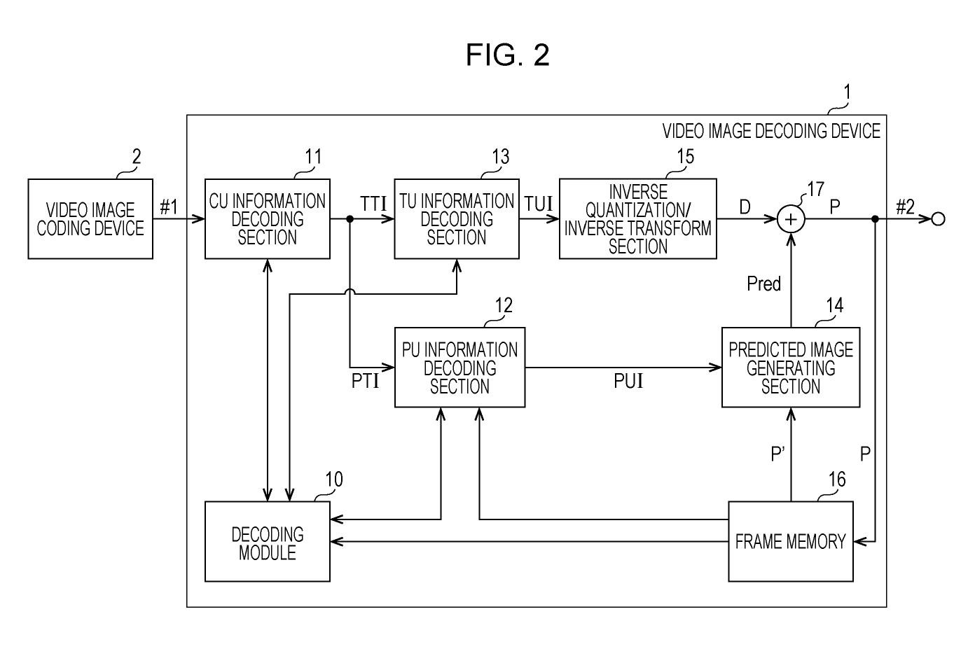

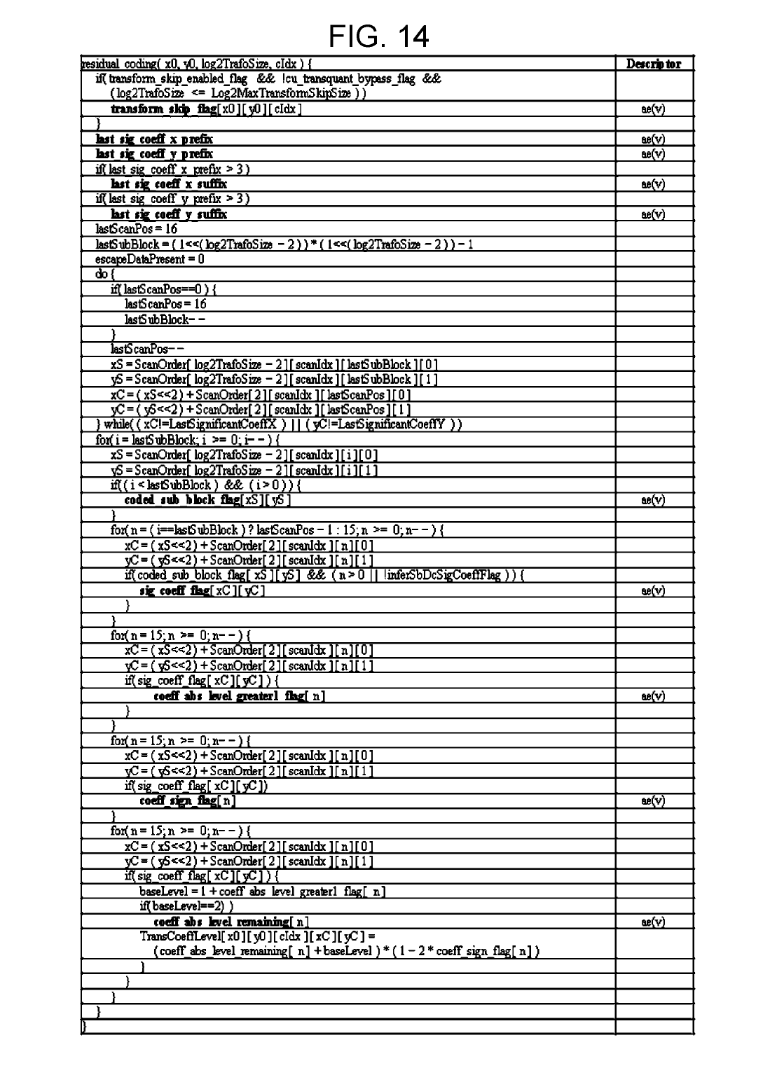

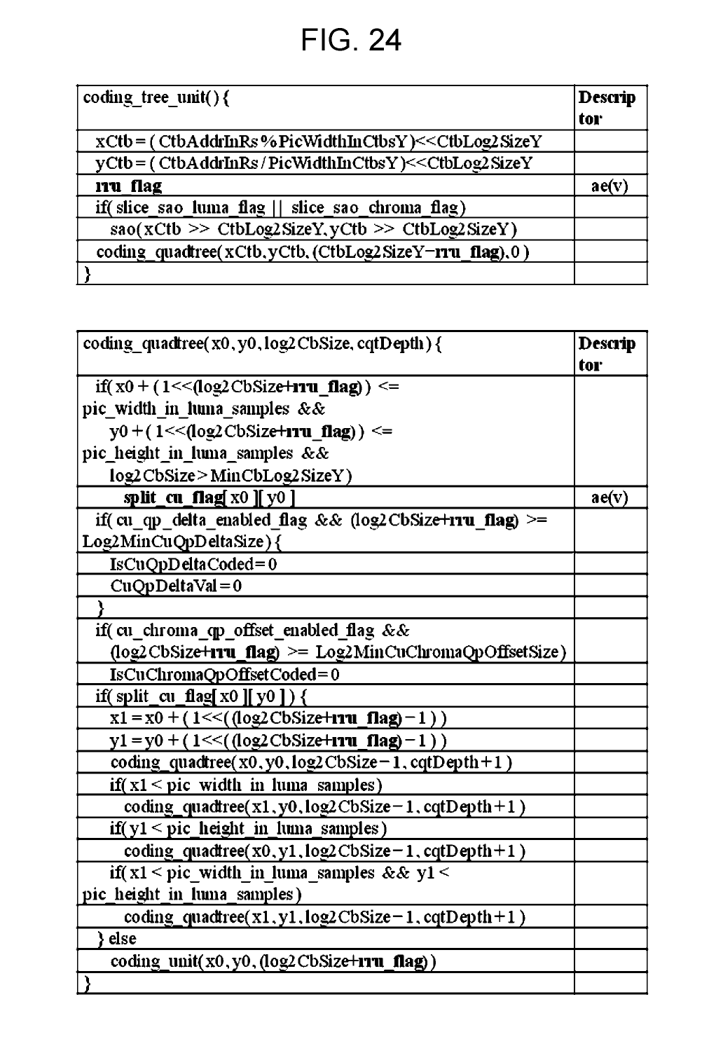

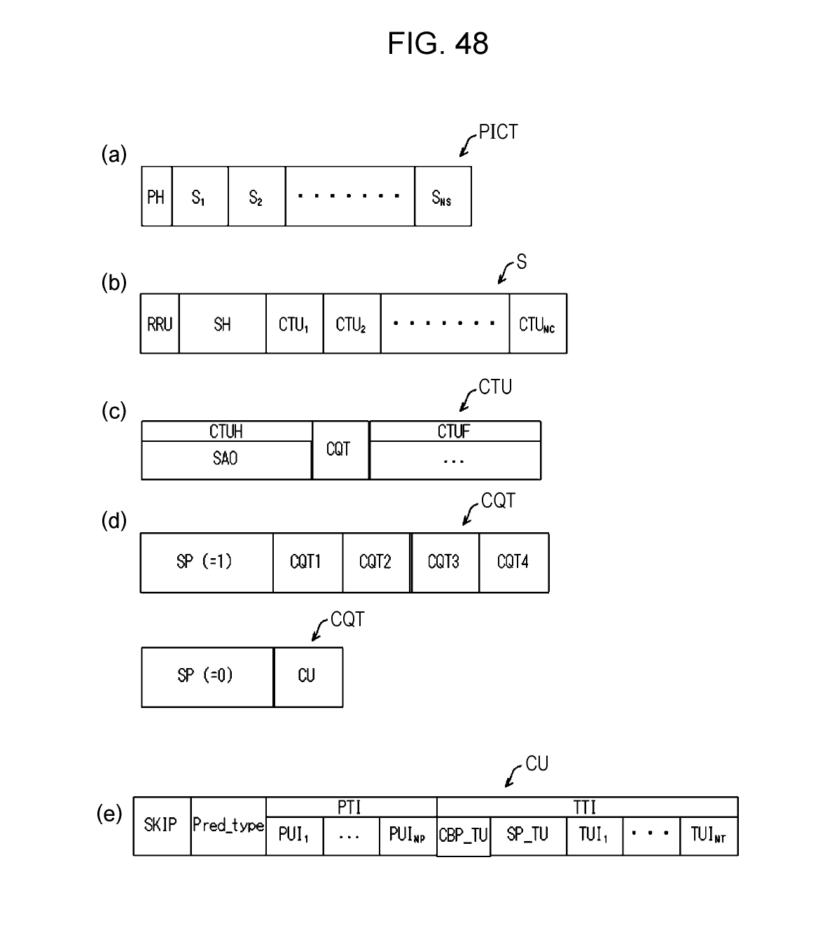

An embodiment of the present invention will be described with reference to FIGS. 1 to 58. First, FIG. 2 will be referenced to describe an overview of a video image decoding device (image decoding device) 1 and a video image coding device (image coding device) 2. FIG. 2 is a function block diagram illustrating a schematic configuration of the video image decoding device 1.

The video image decoding device 1 and the video image coding device 2 illustrated in FIG. 2 implement technology adopted by High-Efficiency Video Coding (HEVC). The video image coding device 2 generates coded data #1 by entropy-coding syntax values whose transmission from the encoder to the decoder is prescribed in these video image coding schemes.

Established entropy coding schemes include context-based adaptive variable-length coding (CAVLC) and context-based adaptive binary arithmetic coding (CABAC).

With coding/decoding according to CAVLC and CABAC, a process adapted to the context is conducted. Context refers to the coding/decoding conditions, and is determined by the previous coding/decoding results of related syntax. The related syntax may be, for example, various syntax related to intra prediction and inter prediction, various syntax related to luminance (luma) and chrominance (chroma), and various syntax related to the coding unit (CU) size. Also, with CABAC, a binary position to be coded/decoded in binary data (a binary sequence) corresponding to syntax may also be used as context in some cases.

With CAVLC, a VLC table used for coding is adaptively modified to code various syntax. On the other hand, with CABAC, a binarization process is performed on syntax that may take multiple values, such as the prediction mode and the transform coefficients, and the binary data obtained by this binarization process is adaptively coded by arithmetic coding according to the probability of occurrence. Specifically, multiple buffers that hold the probability of occurrence for a binary value (0 or 1) are prepared, one of the buffers is selected according to context, and arithmetic coding is conducted on the basis of the probability of occurrence recorded in that buffer. Also, by updating the probability of occurrence in that buffer on the basis of the binary value to decode/code, a suitable probability of occurrence may be maintained according to context.

The coded data #1 representing a video image coded by the video image coding device 2 is input into the video image decoding device 1. The video image decoding device 1 decodes the input coded data #1, and externally outputs a video image #2. Before giving a detailed description of the video image decoding device 1, the structure of the coded data #1 will be described below.

(Structure of Coded Data)

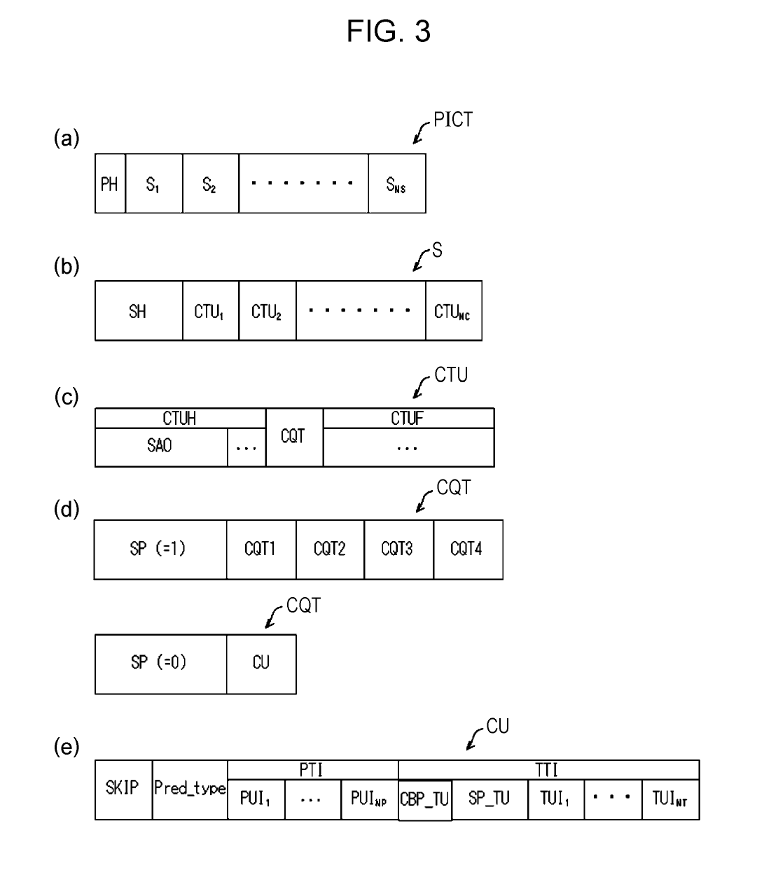

FIG. 3 will be used to describe an exemplary structure of coded data #1 that is generated by the video image coding device 2 and decoded by the video image decoding device 1. As an example, the coded data #1 includes a sequence, as well as multiple pictures constituting the sequence.

FIG. 3 illustrates the hierarchical structure of the picture layer and below in the coded data #1. FIGS. 3(a) to 3(e) are diagrams that illustrate the picture layer that defines a picture PICT, the slice layer that defines a slice S, the tree block layer that defines a coding tree block CTB, the coding tree layer that defines a coding tree (CT), and the CU layer that defines a coding unit (CU) included in the coding tree block CTU, respectively.

(Picture Layer)

In the picture layer, there is defined a set of data that the video image decoding device 1 references in order to decode a picture PICT being processed (hereinafter also referred to as the target picture). As illustrated in FIG. 3(a), a picture PICT includes a picture header PH, as well as slices S₁ to S_{NS} (where NS is the total number of slices included in the picture PICT).

Note that the subscripts of the sign may be omitted in cases where distinguishing each of the slices S₁ to S_{NS} is unnecessary. The above similarly applies to other data given subscripts from among the data included in the coded data #1 described hereinafter.

The picture header PH includes a coding parameter group that the video image decoding device 1 references in order to decide a decoding method for the target picture. Note that the picture header PH may also be referred to as the picture parameter set (PPS).

(Slice Layer)

In the slice layer, there is defined a set of data that the video image decoding device 1 references in order to decode a slice S being processed (hereinafter also referred to as the target slice). As illustrated in FIG. 3(b), a slice S includes a slice header SH, as well as tree blocks CTU₁ to CTU_{NC} (where NC is the total number of tree blocks included in the slice S).

The slice header SH includes a coding parameter group that the video image decoding device 1 references in order to determine a decoding method for the target slice. Slice type designation information (slice_type) that designates a slice type is one example of a coding parameter included in the slice header SH.

Examples of slice types that may be designated by the slice type designation information include (1) I slices that use only intra prediction when coding, (2) P slices that use uni-prediction or intra prediction when coding, and (3) B slices that use uni-prediction, bi-prediction, or intra prediction when coding.

In addition, the slice header SH may also include filter parameters referenced by a loop filter (not illustrated) provided in the video image decoding device 1.

(Tree Block Layer)

In the tree block layer, there is defined a set of data that the video image decoding device 1 references in order to decode a tree block CTU being processed (hereinafter also referred to as the target tree block). The tree block CTB is a block that partitions a slice (picture) into a fixed size. Note that the tree block which is a block of fixed size may be called a tree block in the case of focusing on the image data (pixels) of a region, and may also be called a tree unit in the case in which not only the image data of the region but also information for decoding the image data (such as partition information, for example) is also included. Hereinafter, such data will simply be called the tree block CTU without distinction. Hereinafter, the coding tree, the coding unit, and the like will also be treated as including not only the image data of the corresponding region, but also information for decoding the image data (such as partition information, for example).

The tree block CTU includes a tree block header CTUH and coding unit information CQT. Herein, first, the relationship between the tree block CTU and the coding tree CT will be described as follows.

The tree block CTU is a unit that partitions a slice (picture) into a fixed size.

The tree block CTU includes a coding tree (CT). The coding tree is recursively partitioned by quadtree partitioning. The tree structure and nodes thereof obtained by such recursive quadtree partitioning is hereinafter designated a coding tree.

Hereinafter, units that correspond to the leaves, that is, the end nodes of a coding tree, will be referred to as coding nodes. Also, since coding nodes become the basic units of the coding process, hereinafter, coding nodes will also be referred to as coding units (CUs). In other words, the highest coding tree CT is the CTU (CQT), while the endmost coding tree CT is the CU.

In other words, coding unit information CU₁ to CU_{NL} is information corresponding to respective coding nodes (coding units) obtained by recursive quadtree partitioning of the tree block CTU.

Also, the root of the coding tree is associated with the tree block CTU. In other words, the tree block CTU (CQT) is associated with the highest node of the tree structure of the quadtree partitioning that recursively contains multiple coding nodes (CT).

Note that the size of a particular coding node is half, both vertically and horizontally, of the size of the coding node to which the particular coding node directly belongs (that is, the unit of the node that is one layer higher than the particular coding node).

Also, the size that a particular coding node may take depends on coding node size designation information as well as the maximum hierarchical depth included in the sequence parameter set (SPS) of the coded data #1. For example, in the case where the size of a tree block CTU is 64×64 pixels and the maximum hierarchical depth is 3, coding nodes in the layers at and below that tree block CTU may take one of four types of size, namely, 64×64 pixels, 32×32 pixels, 16×16 pixels, and 8×8 pixels.

(Tree Block Header)

The tree block header CTUH includes coding parameters that the video image decoding device 1 references in order to decide a decoding method for the target tree block. Specifically, as illustrated in FIG. 3(c), an SAO that designates the filter method of the target tree block is included. The information including in the CTU, such as the CTUH, is called coding tree unit information (CTU information).

(Coding Tree)

The coding tree CT includes tree block partitioning information SP, which is information for partitioning the tree block. Specifically, as illustrated in FIG. 3(d), for example, the tree block partitioning information SP may be the CU partitioning flag (split_cu_flag), which is a flag indicating whether or not to quarter the entire target tree block or a partial region of the tree block. When the CU partitioning flag split_cu_flag is 1, the coding tree CT is partitioned further into four coding trees CT. When split_cu_flag is 0, this means that the coding tree CT is an end node which is not partitioned. Information such as the CU partitioning flag split_cu_flag which is included in the coding tree is called coding tree information (CT information). Besides the CU partitioning flag split_cu_flag which indicates whether or not to partition the coding tree further, the CT information may also include parameters to be applied to the coding tree and lower coding units. For example, in the case in which coded data is provided with a residual mode, in the CT information, the value of a certain decoded residual mode is applied as the value of the residual mode for the coding tree that decoded the residual mode, and for the lower coding units.

(CU Layer)

In the CU layer, there is defined a set of data that the video image decoding device 1 references in order to decode a CU being processed (hereinafter also referred to as the target CU).

At this point, before describing the specific content of data included in the coding unit information CU, the tree structure of data included in the CU will be described. A coding node becomes the root node of a prediction tree (PT) and a transform tree (TT). The prediction tree and transform tree are described as follows.

In the prediction tree, a coding node is partitioned into one or multiple prediction blocks, and the position and size of each prediction block are defined. Stated differently, prediction blocks are one or more non-overlapping areas that constitute a coding node. In addition, the prediction tree includes the one or more prediction blocks obtained by the above partitioning.

A prediction process is conducted on each prediction block. Hereinafter, these prediction blocks which are the units of prediction will also be referred to as prediction units (PUs).

Roughly speaking, there are two types of partitions in a prediction tree: one for the case of intra prediction, and one for the case of inter prediction.

In the case of intra prediction, the partitioning method may be 2N×2N (the same size as the coding node) or N×N.

Also, in the case of inter prediction, the partitioning method may be 2N×2N (the same size as the coding node), 2N×N, N×2N, N×N, or the like.

Meanwhile, in the transform tree, a coding node is partitioned into one or multiple transform blocks, and the position and size of each transform block are defined. Stated differently, transform blocks are one or more non-overlapping areas that constitute a coding node. In addition, the transform tree includes the one or more transform blocks obtained by the above partitioning.

A transform process is conducted on each transform block. Hereinafter, these transform blocks which are the units of transformation will also be referred to as transform units (TUs).

(Data Structure of Coding Unit Information)

Next, the specific content of data included in the coding unit information CU will be described with reference to FIG. 3(e). As illustrated in FIG. 3(e), the coding unit information CU specifically includes CU information (skip flag SKIP, CU prediction type information Pred_type), PT information PTI, and TT information TTI.

[Skip Flag]

The skip flag SKIP is a flag (skip_flag) indicating whether or not a skip mode is applied to the target CU. In the case in which the skip flag SKIP has a value of 1, that is, in the case where skip mode is applied to the target CU, the PT information PTI and the TT information TTI in that coding unit information CU is omitted. Note that the skip flag SKIP is omitted in I slices.

[CU Prediction Type Information]

The CU prediction type information Pred_type includes CU prediction mode information (PredMode) and PU partition type information (PartMode).

The CU prediction mode information (PredMode) designates whether to use skip mode, intra prediction (intra CU), or inter prediction (inter CU) as the method of generating a predicted image for each PU included in the target CU. Note that in the following, the classifications of skip, intra prediction, and inter prediction for the target CU are called the CU prediction mode.

The PU partition type information (PartMode) designates the PU partition type, which is the pattern of partitioning the target coding unit (CU) into each PU. Hereinafter, the partitioning of the target coding unit (CU) into each PU in accordance with the PU partition type will be called PU partitioning.

As an illustrative example, the PU partition type information (PartMode) may be an index indicating the type of PU partition pattern, or the shape, size, and position within the target prediction tree of each PU included in the target prediction tree may be designated. Note that PU partitioning is also called the prediction unit partition type.

Note that the selectable PU partition types are different depending on the CU prediction mode and the CU size. Furthermore, the PU partition types which can be selected are different in the case of inter prediction and intra prediction, respectively. Further details about PU partition types will be described later.

Additionally, in cases other than an I slice, the value of the CU prediction mode information (PredMode) and the value of the PU partition type information (PartMode) may be configured to be specified by an index (cu_split_pred_part_mode) that designates the combination of the CU partitioning flag (split_cu_flag), the skip flag (skip_flag), a merge flag (merge_flag; described later), the CU prediction mode information (PredMode), and the PU partition type information (PartMode). An index such as cu_split_pred_part_mode is also called combined syntax (or joint codes).

[PT Information]

The PT information PTI is information related to a PT included in the target CU. In other words, the PT information PTI is a set of information related to each of one or more PUs included in the PT. As described earlier, since a predicted image is generated in units of PUs, the PT information PTI is referenced when a predicted image is generated by the video image decoding device 1. As illustrated in FIG. 3(d), the PT information PTI includes PU information PUI₁ to PUI_{NP} (where NP is the total number of PUs included in the target PT), which includes prediction information and the like for each PU.

The prediction information PUI includes intra prediction information or inter prediction information, depending on which prediction method is designated by the prediction type information Pred_mode. Hereinafter, a PU to which intra prediction is applied will be designated an intra PU, while a PU to which inter prediction is applied will be designated an inter PU.

The inter prediction information includes coding parameters that are referenced in the case in which the video image decoding device 1 generates an inter-predicted image by inter prediction.

Examples of inter prediction parameters include the merge flag (merge_flag), a merge index (merge_idx), an estimated motion vector index (mvp_idx), a reference image index (ref_idx), an inter prediction flag (inter_pred_flag), and a motion vector difference (mvd).

The intra prediction information includes coding parameters that are referenced in the case in which the video image decoding device 1 generates an intra-predicted image by intra prediction.

Examples of intra prediction parameters include an estimated prediction mode flag, an estimated prediction mode index, and a residual prediction mode index.

Note that in the intra prediction information, a PCM mode flag indicating whether or not to use a PCM mode may also be coded. In the case in which the PCM mode flag is coded, when the PCM mode flag indicates use of the PCM mode, each process of the prediction process (intra), the transform process, and the entropy coding is omitted.

[TT Information]

The TT information TTI is information related to a TT included in a CU. In other words, the TT information TTI is a set of information related to each of one or more TUs included in the TT, and is referenced in the case in which the video image decoding device 1 decodes residual data. Note that hereinafter, a TU may also be referred to as a block.

As illustrated in FIG. 3(e), the TT information TTI includes a CU residual flag CBP_TU which is information indicating whether or not the target CU includes residual data, TT partitioning information SP_TU that designates a partitioning pattern for partitioning the target CU into each transform block, as well as TU information TUI₁ to TUI_{NT} (where NT is the total number of blocks included in the target CU).

When the CU residual flag CBP_TU is 0, the target CU does not residual data, that is, TT information TTI. When the CU residual flag CBP_TU is 1, the target CU includes residual data, that is, TT information TTI. The CU residual flag CBP_TU may also be a residual root flag rqt_root_cbf (residual quadtree root coded block flag), which indicates that no residual exists in all of the residual blocks obtained by partitioning the target block and lower, for example. Specifically, the TT partitioning information SP_TU is information for determining the shape and size of each TU included in the target CU, as well as the position within the target CU. For example, the TT partitioning information SP_TU can be realized from a TU partitioning flag (split_transform_flag) indicating whether or not to partition the node being processed, and a TU depth (TU layer, trafoDepth) indicating the depth of the partitioning. The TU partitioning flag split_transform_flag is a flag indicating whether or not to partition the transform block to transform (inverse transform), and in the case of partitioning, the transform (inverse transform, inverse quantization, quantization) is conducted using even smaller blocks.

Also, in the case of a CU size of 64×64, for example, each TU obtained by partitioning may take a size from 32×32 pixels to 4×4 pixels.

The TU information TUI₁ to TUI_{NT} is individual information related to each of the one or more TUs included in the TT. For example, the TU information TUI includes a quantized prediction residual.

Each quantized prediction residual is coded data generated due to the video image coding device 2 performing the following processes 1 to 3 on a target block, that is, the block being processed.

Process 1: Apply the discrete cosine transform (DCT) to the prediction residual obtained by subtracting a predicted image from the image to be coded;

Process 2: quantize the transform coefficients obtained in Process 1;

Process 3: code the quantized transform coefficients obtained in Process 2 into variable-length codes.

Note that the quantization parameter qp described earlier expresses the size of the quantization step QP used in the case of the video image coding device 2 quantizing transform coefficients (QP=2^{qp/6}).

(PU Partition Type)

Provided that the size of the target CU is 2N×2N, the PU partition type (PartMode) may be any of the following eight patterns. Namely, there are four symmetric splittings of 2N×2N pixels, 2N×N pixels, N×2N pixels, and N×N pixels, as well as four asymmetric splittings of 2N×nU pixels, 2N×nD pixels, nL×2N pixels, and nR×2N pixels. Note that N=2m (where m is an arbitrary integer of 1 or greater). Hereinafter, a region obtained by partitioning a symmetric CU is also called a partition.

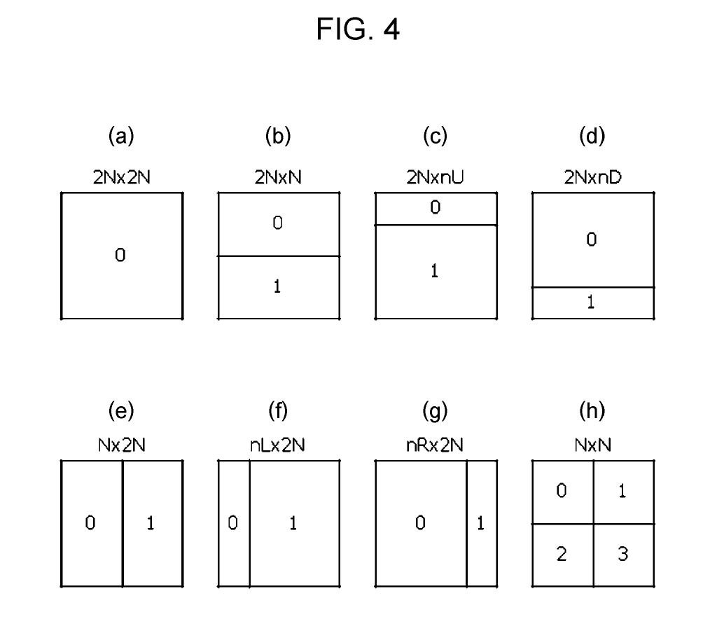

FIGS. 4(a) to 4(h) specifically illustrate the position of the PU partition boundary in the CU for each partition type.

Note that FIG. 4(a) illustrates the 2N×2N PU partition type in which the CU is not partitioned.

Also, FIGS. 4(b), 4(c), and 4(d) illustrate the shape of the partition for the PU partition types 2N×N, 2N×nU, and 2N×nD, respectively. Hereinafter, the partitions in the case of the 2N×N, 2N×nU, and 2N×nD PU partition types will be collectively termed the landscape partitions.

Also, FIGS. 4(e), 4(f), and 4(g) illustrate the shape of the partition for the PU partition types N×2N, nL×2N, and nR×2N, respectively. Hereinafter, the partitions in the case of the N×2N, nL×2N, and nR×2N PU partition types will be collectively termed the portrait partitions.

Additionally, the landscape partitions and the portrait partitions will be collectively termed the rectangular partitions.

Also, FIG. 4(h) illustrates the shape of the partition for the PU partition type N×N. The PU partition types in FIGS. 4(a) and 4(h) are also termed the square partitions, on the basis of the shapes of the partitions. Also, the PU partition types in FIGS. 4(b) to 4(g) are also termed the non-square partitions.

Also, in FIGS. 4(a) to 4(h), the numbers labeling respective regions represent identification numbers for the regions, and the regions are processed in order of identification number. In other words, the identification number represents the scan order of the regions.

Also, in FIGS. 4(a) to 4(h), the upper left is taken to be the base point (origin) of the CU.

[Partition Types in the Case of Inter Prediction]

In an inter PU, seven of the above eight partition types, excluding only N×N (FIG. 4(h)), are defined. Note that the above four asymmetric partitions are also called asymmetric motion partitions (AMPs). Generally, a CU partitioned by an asymmetric partition includes partitions with different shapes or sizes. Also, symmetric splittings are also called symmetric partitions. Generally, a CU partitioned by a symmetric partition includes partitions with matching shapes and sizes.

Note that the specific value of N described above is specified by the size of the CU to which the relevant PU belongs, while the specific values of nU, nD, nL, and nR are determined according to the value of N. For example, an inter CU of 128×128 pixels can be partitioned into inter PUs of 128×128 pixels, 128×64 pixels, 64×128 pixels, 64×64 pixels, 128×32 pixels, 128×96 pixels, 32×128 pixels, and 96×128 pixels.

[Partition Types in the Case of Intra Prediction]

In an intra PU, the following two types of partition patterns are defined. Namely, there is a partition pattern 2N×2N in which the target CU is not partitioned, or in other words, the target CU itself is treated as a single PU, and a partition pattern N×N in which the target CU is partitioned symmetrically into four PUs.

Consequently, given the examples illustrated in FIG. 4, an intra PU can take the partition patterns of (a) and (h).

For example, a 128×128 pixel intra CU can be partitioned into a 128×128 pixel intra PU, or into 64×64 pixel intra PUs.

Note that in the case of an I slice, the coding unit information CU may also include an intra partitioning mode (intra_part_mode) for specifying the PU partition type (PartMode).

<Video Image Decoding Device>

Hereinafter, a configuration of the video image decoding device 1 according to the present embodiment will be described with reference to FIGS. 1 to 24.

(Overview of Video Image Decoding Device)

The video image decoding device 1 generates a predicted image for each PU, generates a decoded image #2 by adding together the generated predicted image and the prediction residual decoded from the coded data #1, and externally outputs the generated decoded image #2.

Herein, the generation of a predicted image is conducted by referencing coding parameters obtained by decoding the coded data #1. Coding parameters refer to parameters that are referenced in order to generate a predicted image. Coding parameters include prediction parameters such as motion vectors referenced in inter frame prediction and prediction modes referenced in intra frame prediction, and additionally include information such as the sizes and shapes of PUs, the sizes and shapes of blocks, and residual data between an original image and a predicted image. Hereinafter, from among the information included in the coding parameters, the set of all information except the above residual data will be called side information.

Also, in the following, a picture (frame), slice, tree block, block, and PU to be decoded will be called the target picture, target slice, target tree block, target block, and target PU, respectively.

Note that the size of the tree block is 64×64 pixels, for example, and the size of the PU is 64×64 pixels, 32×32 pixels, 16×16 pixels, 8×8 pixels, 4×4 pixels, and the like, for example. However, these sizes are merely illustrative examples, and the sizes of the tree block and the PU may also be sizes other than the sizes indicated above.

(Configuration of Video Image Decoding Device)

Referring to FIG. 2 again, a schematic configuration of the video image decoding device 1 is described as follows. FIG. 2 is a function block diagram illustrating a schematic configuration of the video image decoding device 1.

As illustrated in FIG. 2, the video image decoding device 1 is provided with a decoding module 10, a CU information decoding section 11, a PU information decoding section 12, a TU information decoding section 13, a predicted image generating section 14, an inverse quantization/inverse transform section 15, frame memory 16, and an adder 17.

[Basic Decoding Flow]

FIG. 1 is a flowchart explaining the schematic operation of the video image decoding device 1.

(S1100) The decoding module 10 decodes parameter set information such as the SPS and PPS from the coded data #1.

(S1200) The decoding module 10 decodes the slice header (slice information) from the coded data #1.

Hereinafter, the decoding module 10 derives a decoded image of each CTB by repeating the processes from S1300 to S4000 for each CTB included in the target picture.

(S1300) The CU information decoding section 11 decodes coding tree unit information (CTU information) from the coded data #1.

(S1400) The CU information decoding section 11 decodes coding tree information (CT information) from the coded data #1.

(S1500) The CU information decoding section 11 decodes coding unit information (CU information) from the coded data #1.

(S1600) The PU information decoding section 12 decodes prediction unit information (PT information PTI) from the coded data #1.

(S1700) The TU information decoding section 13 decodes transform unit information (TT information TTI) from the coded data #1.

(S2000) The predicted image generating section 14 generates a predicted image on the basis of the PT information PTI for each PU included in the target CU.

(S3000) The inverse quantization/inverse transform section 15 executes an inverse quantization/inverse transform process on the basis of the TT information TTI for each TU included in the target CU.

(S4000) The decoding module 10 uses the adder 17 to add together the predicted image Pred supplied by the predicted image generating section 14 and the prediction residual D supplied by the inverse quantization/inverse transform section 15, thereby generating a decoded image P for the target CU.

(S5000) The decoding module 10 applies a loop filter such as a deblocking filter or a sample adaptive offset (SAO) filter to the decoded image P.

Hereinafter, the schematic operation of each module will be described.

[Decoding Module]

The decoding module 10 conducts a decoding process that decodes syntax values from binary. More specifically, on the basis of coded data and a syntax class supplied from a source, the decoding module 10 decodes syntax values coded by an entropy coding scheme such as CABAC or CAVLC, and returns the decoded syntax values to the source.

In the example illustrated below, the sources of the coded data and the syntax class are the CU information decoding section 11, the PU information decoding section 12, and the TU information decoding section 13.

[CU Information Decoding Section]

The CU information decoding section 11 uses the decoding module 10 to conduct a decoding process at the tree block and CU level on one frame's worth of the coded data #1 input from the video image coding device 2. Specifically, the CU information decoding section 11 decodes the CTU information, the CT information, the CU information, the PT information PTI, and the TT information TTI from the coded data #1 according to the following procedure.

First, the CU information decoding section 11 reference various headers included in the coded data #1, and sequentially separates the coded data #1 into slices and tree blocks.

At this point, the various headers include (1) information about the partitioning method for partitioning the target picture into slices, and (2) information about the size and shape of a tree block belonging to the target slice, as well as the position within the target slice.

Subsequently, the CU information decoding section 11 decodes the tree block partition information SP_CTU included in the tree block header CTUH as CT information, and partitions the target tree block into CUs. Next, the CU information decoding section 11 acquires coding unit information (hereinafter termed CU information) corresponding to the CUs obtained by partitioning. The CU information decoding section 11 sequentially treats each CU included in the tree block as the target CU, and executes a process of decoding the CU information corresponding to the target CU.

The CU information decoding section 11 demultiplexes the TT information TTI related to the transform tree obtained for the target CU, and the PT information PTI related to the prediction tree obtained for the target CU. Note that, as described earlier, the TT information TTI includes TU information TUI corresponding to TUs included in the transform tree. Also, as described earlier, the PT information PTI includes PU information PUI corresponding to PUs included in the target prediction tree.

The CU information decoding section 11 supplies the PT information PTI obtained for the target CU to the PU information decoding section 12. Also, the CU information decoding section 11 supplies the TT information TTI obtained for the target CU to the TU information decoding section 13.

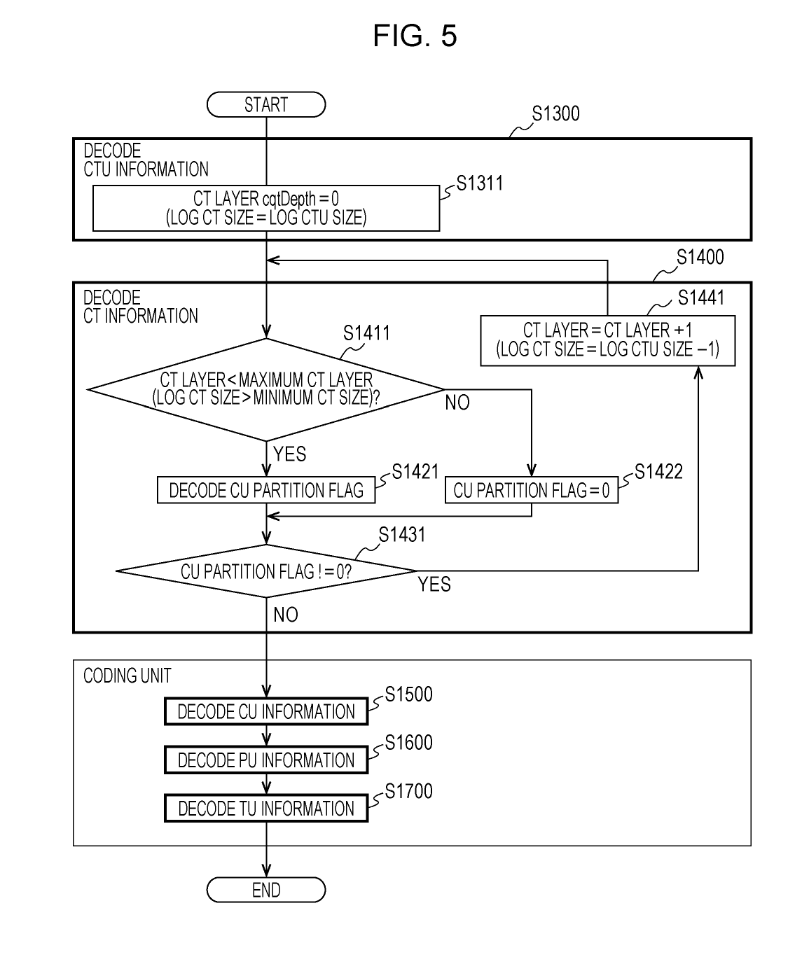

More specifically, the CU information decoding section 11 conducts the following operations as illustrated in FIG. 5. FIG. 5 is a flowchart explaining the schematic operation of the CU information decoding section 11 (CTU information decoding S1300, CT information decoding S1400) according to an embodiment of the invention.

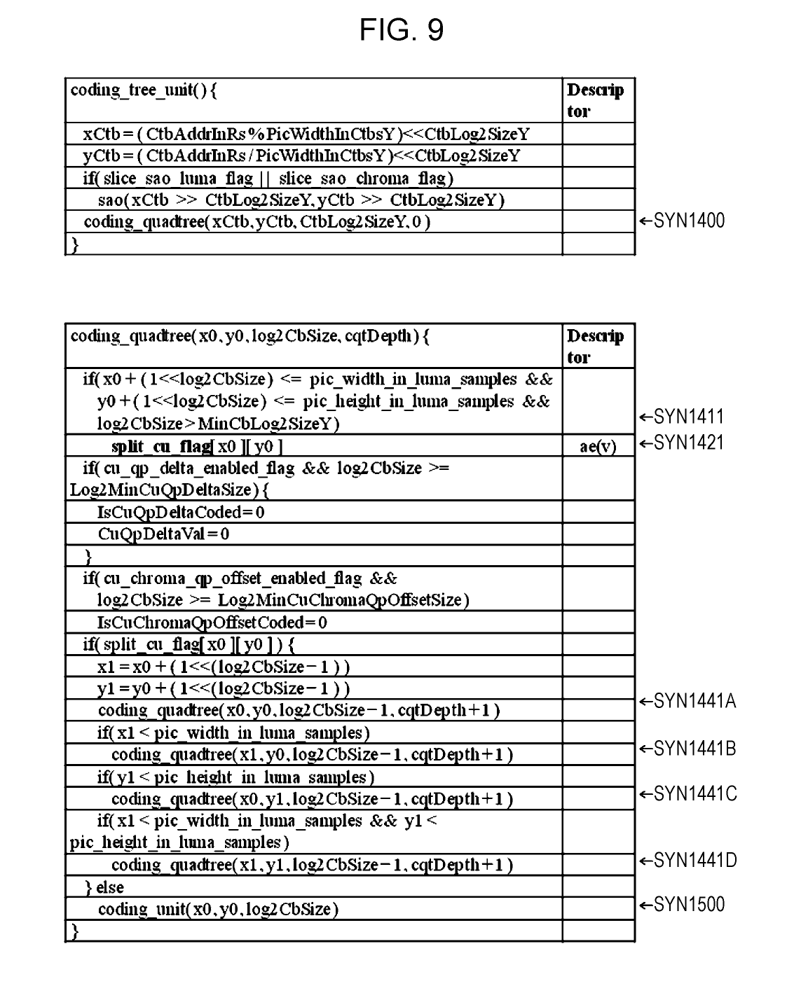

FIG. 9 is a diagram illustrating an exemplary configuration of a CU information syntax table according to an embodiment of the present invention.

(S1311) The CU information decoding section 11 decodes the CTU information from the coded data #1, and initializes a variable for managing the recursively partitioned coding tree CT. Specifically, like the formula below, the CT layer (CT depth, CU layer, CU depth) cqtDepth indicating the layer of the coding tree is set to 0, and the CTB size CtbLog2SizeY (CtbLog2Size), which is the size of the coding tree block, is set as the CU size, which is the coding unit size (herein, the logarithm of the CU size log2CbSize equals the size of the transform tree block).

cqtDepth=0

log2CbSize=CtbLog2SizeY

Note that the CT layer (CT depth) cqtDepth is taken to be 0 at the highest layer, and to increase by 1 with each deeper layer, but is not limited thereto. In the above, by limiting the CU size and the CTB size to powers of 2 (4, 8, 16, 32, 64, 128, 256, and so on), the sizes of these blocks are treated as logarithms with a base of 2, but are not limited thereto. Note that in the case of the block sizes 4, 8, 16, 32, 64, 128, and 256, the logarithmic values becomes 2, 3, 4, 5, 6, 7, and 8, respectively.

Hereinafter, the CU information decoding section 11 decodes the coding tree TU (coding_quadtree) recursively (S1400). The CU information decoding section 11 decodes the highest (root) coding tree coding_quadtree(xCtb, yCtb, CtbLog2SizeY, 0) (SYN1400). Note that xCtb and yCtb are the upper-left coordinates of the CTB, while CtbLog2SizeY is the block size of the CTB (for example, 64, 128, or 256).

(S1411) The CU information decoding section 11 determines whether or not the logarithm of the CU size log2CbSize is greater than a predetermined minimum CU size MinCbLog2SizeY (minimum transform block size) (SYN1411). If the logarithm of the CU size log2CbSize is greater than MinCbLog2SizeY, the flow proceeds to S1421, otherwise the flow proceeds to S1422.

(S1421) In the case of determining that the logarithm of the CU size log2CbSize is greater than MinCbLog2SizeY, the CU information decoding section 11 decodes the syntax element indicated in SYN1421, namely the CU partitioning flag (split_cu_flag).

(S1422) Otherwise (that is, if the logarithm of the CU size log2CbSize is less than or equal to MinCbLog2SizeY), or in other words, in the case in which the CU partitioning flag split_cu_flag does not appear in the coded data #1, the CU information decoding section 11 skips the decoding of the CU partitioning flag split_cu_flag from the coded data #1, and derives the CU partitioning flag split_cu_flag as 0.

(S1431) In the case in which the CU partitioning flag split_cu_flag is non-zero (=1) (SYN1431), the CU information decoding section 11 decodes the one or more coding trees included in the target coding tree. Herein, the four lower coding trees CT at the positions (x0, y0), (x1, y0), (x0, y1), and (x1, y1) with the logarithm of the CT size log2CbSize−1 and the CT layer cqtDepth+1 are decoded. Even in the lower coding trees CT, the CU information decoding section 11 continues the CT decoding process S1400 started from S1411.

coding_quadtree(x0,y0,log2CbSize−1,cqtDepth+1) (SYN1441A)

coding_quadtree(x1,y0,log2CbSize−1,cqtDepth+1) (SYN1441B)

coding_quadtree(x0,y1,log2CbSize−1,cqtDepth+1) (SYN1441C)

coding_quadtree(x1,y1,log2CbSize−1,cqtDepth+1) (SYN1441D)

Herein, x0 and y0 are the upper-left coordinates of the target coding tree, while x1 and y1 are coordinates derived by adding ½ of the target CT size (1<<log2CbSize) to the CT coordinates, like in the formulas below.

x1=x0+(1<<(log2CbSize−1))

y1=y0+(1<<(log2CbSize−1))

Note that << denotes a left shift. 1<<N is the same value as 2^{N} (the same applies hereinafter). Similarly, in the following, >> denotes a right shift.

Otherwise (in the case in which the CU partitioning flag split_cu_flag is 0), the flow proceeds to S1500 to decode the coding unit.

(S1441), As described above, before recursively decoding the coding tree coding_quadtree, the CT layer cqtDepth indicating the layer of the coding tree is incremented by 1 and updated, and the logarithm of the CU size log2CbSize, which is the coding unit size, is decremented by 1 (the coding unit size is halved) and updated, like the formulas below.

cqtDepth=cqtDepth+1

log2CbSize=log2CbSize−1

(S1500) The CU information decoding section 11 decodes the coding unit CU coding_unit(x0, y0, log2CbSize) (SYN1450). Herein, x0 and y0 are the coordinates of the coding unit. The size of the coding tree log2CbSize is equal to the size of the coding unit at this point.

[PU Information Decoding Section]

The PU information decoding section 12 uses the decoding module 10 to conduct a decoding process at the PU level on the PT information PTI supplied from the CU information decoding section 11. Specifically, the PU information decoding section 12 decodes the PT information PTI according to the following procedure.

The PU information decoding section 12 references the PU partition type information Part_type to decide the PU partition type in the target prediction tree. Next, the PU information decoding section 12 sequentially treats each PU included in the target prediction tree as the target PU, and executes a process of decoding the PU information corresponding to the target PU.

In other words, the PU information decoding section 12 conducts a process of decoding each parameter used in the generation of the predicted image from the PU information corresponding to the target PU.

The PU information decoding section 12 supplies the PU information decoded for the target PU to the predicted image generating section 14.

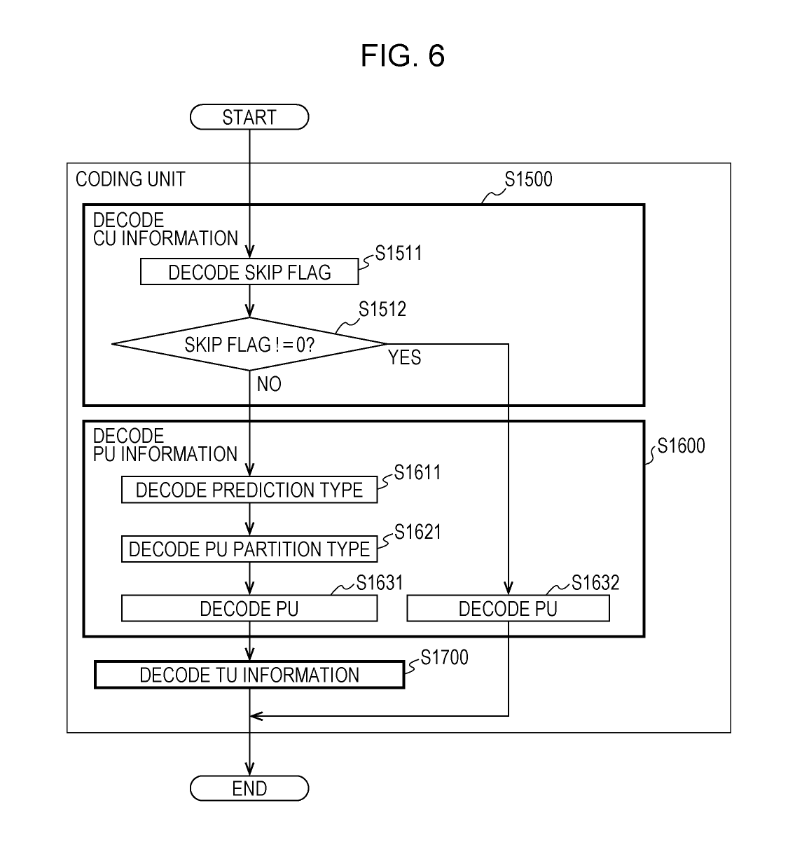

More specifically, the CU information decoding section 11 and the PU information decoding section 12 conduct the following operations as illustrated in FIG. 6. FIG. 6 is a flowchart explaining the schematic operations of the PU information decoding illustrated in S1600.

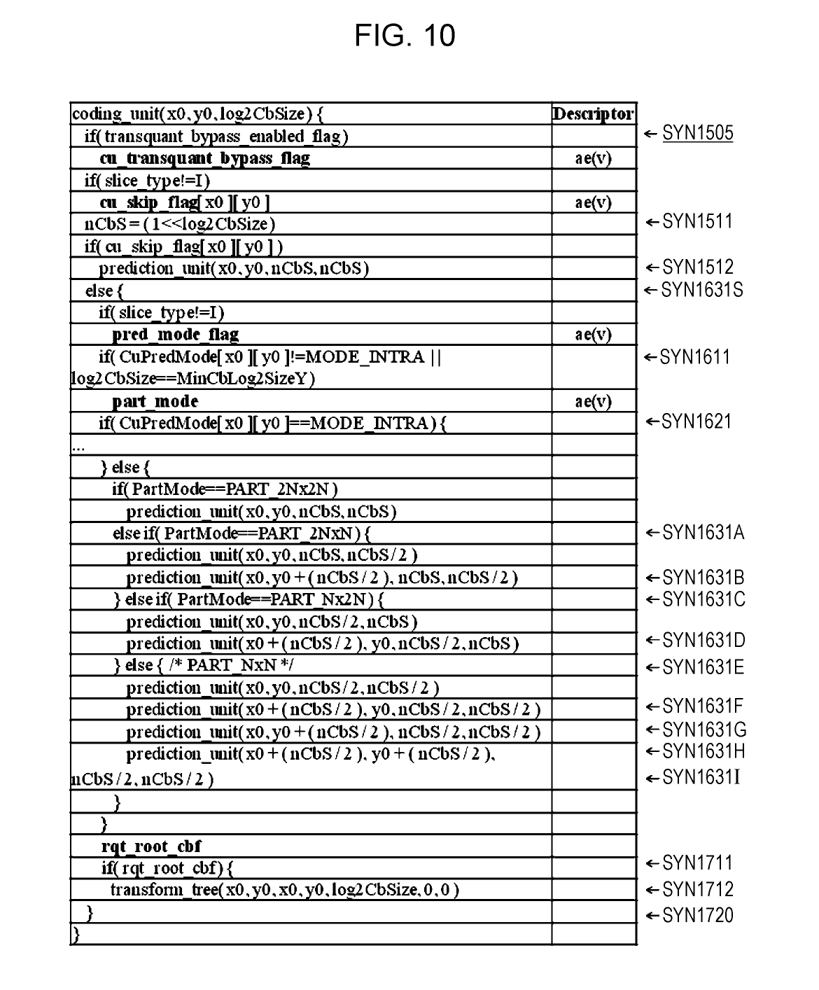

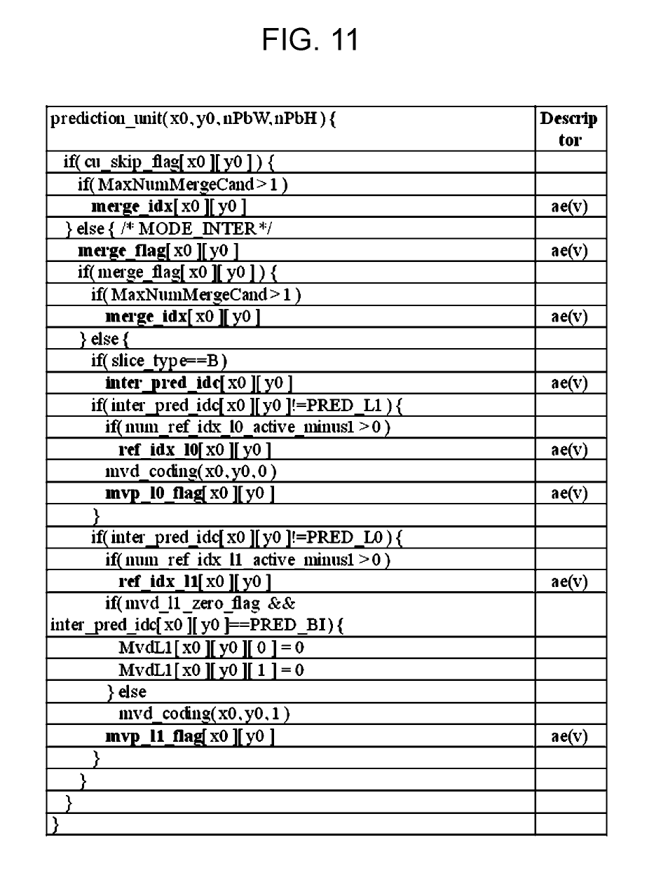

FIG. 10 is a diagram illustrating an exemplary configuration of a CU information, PT information PTI, and TT information TTI syntax table according to an embodiment of the present invention. FIG. 11 is a diagram illustrating an exemplary configuration of a PT information PTI syntax table according to an embodiment of the present invention.

S1511 The CU information decoding section 11 decodes the skip flag skip_flag from the coded data #1.

S1512 The CU information decoding section 11 determines whether or not the skip flag skip_flag is non-zero (=1). In the case in which the skip flag skip_flag is non-zero (=1), the PU information decoding section 12 skips the decoding of the prediction type, namely the CU prediction mode information PredMode and the PU partition type information PartMode, from the coded data #1, and derives inter prediction and no partitioning (2N×2N), respectively. Also, in the case in which the skip flag skip_flag is non-zero (=1), the TU information decoding section 13 skips the process of decoding the TT information TTI from the coded data #1 illustrated in S1700, and derives that the target CU has no TU partitions, and the quantized prediction residual TransCoeffLevel[ ][ ] of the target CU is 0.

S1611 The PU information decoding section 12 decodes the CU prediction mode information PredMode (syntax element pred_mode_flag) from the coded data #1.

S1621 The PU information decoding section 12 decodes the PU partition type information PartMode (syntax element part_mode) from the coded data #1.

S1631 The PU information decoding section 12 decodes each piece of PU information included in the target CU from the coded data #1, in accordance with the number of PU partitions indicated by the PU partition type information Part_type.

For example, in the case in which the PU partition type is 2N×2N, the following single piece of PU information PUI treating the CU as a single PU is decoded.

prediction_unit(x0,y0,nCbS,nCbS) (SYN1631A)

In the case in which the PU partition type is 2N×N, the following two pieces of PU information PUI partitioning the CU top and bottom are decoded.

prediction_unit(x0,y0,nCbS,nCbS) (SYN1631B)

prediction_unit(x0,y0+(nCbS/2),nCbS,nCbS/2) (SYN1631C)

In the case in which the PU partition type is N×2N, the following two pieces of PU information PUI partitioning the CU left and right are decoded.

prediction_unit(x0,y0,nCbS,nCbS) (SYN1631D)

prediction_unit(x0+(nCbS/2),y0,nCbs/2,nCbS) (SYN1631E)

In the case in which the PU partition type is N×N, the following four pieces of PU information PUI quartering the CU are decoded.

prediction_unit(x0,y0,nCbS,nCbS) (SYN1631F)

prediction_unit(x0+(nCbS/2),y0,nCbs/2,nCbS) (SYN1631G)

prediction_unit(x0,y0+(nCbS/2),nCbS,nCbS/2) (SYN1631H)

prediction_unit(x0+(nCbS/2),y0+(nCbS/2),nCbs/2,nCbS/2) (SYN1631I)

S1632 In the case in which the skip flag is 1, the PU partition type is set to 2N×2N, and a single piece of PU information PUI is decoded.

prediction_unit(x0,y0,nCbS,nCbS) (SYN1631S)

S1700 A flowchart explaining the schematic operation of the CU information decoding section 11 (CU information decoding S1500), the PU information decoding section 12 (PU information decoding S1600), and the TU information decoding section 13 (TT information decoding S1700) according to an embodiment of the invention.

[TU Information Decoding Section]

The TU information decoding section 13 uses the decoding module 10 to conduct a decoding process at the TU level on the TT information TTI supplied from the CU information decoding section 11. Specifically, the TU information decoding section 13 decodes the TT information TTI according to the following procedure.

The TU information decoding section 13 references the TT partitioning information SP_TU, and partitions the target transform tree into nodes or TUs. Note that if further partitioning is designated for the target node, the TU information decoding section 13 conducts the TU partitioning process recursively.

When the partitioning process ends, the TU information decoding section 13 sequentially treats each TU included in the target prediction tree as the target TU, and executes a process of decoding the TU information corresponding to the target TU.

In other words, the TU information decoding section 13 conducts a process of decoding each parameter used to reconstruct the transform coefficients from the TU information corresponding to the target TU.

The TU information decoding section 13 supplies the TU information decoded for the target TU to the inverse quantization/inverse transform section 15.

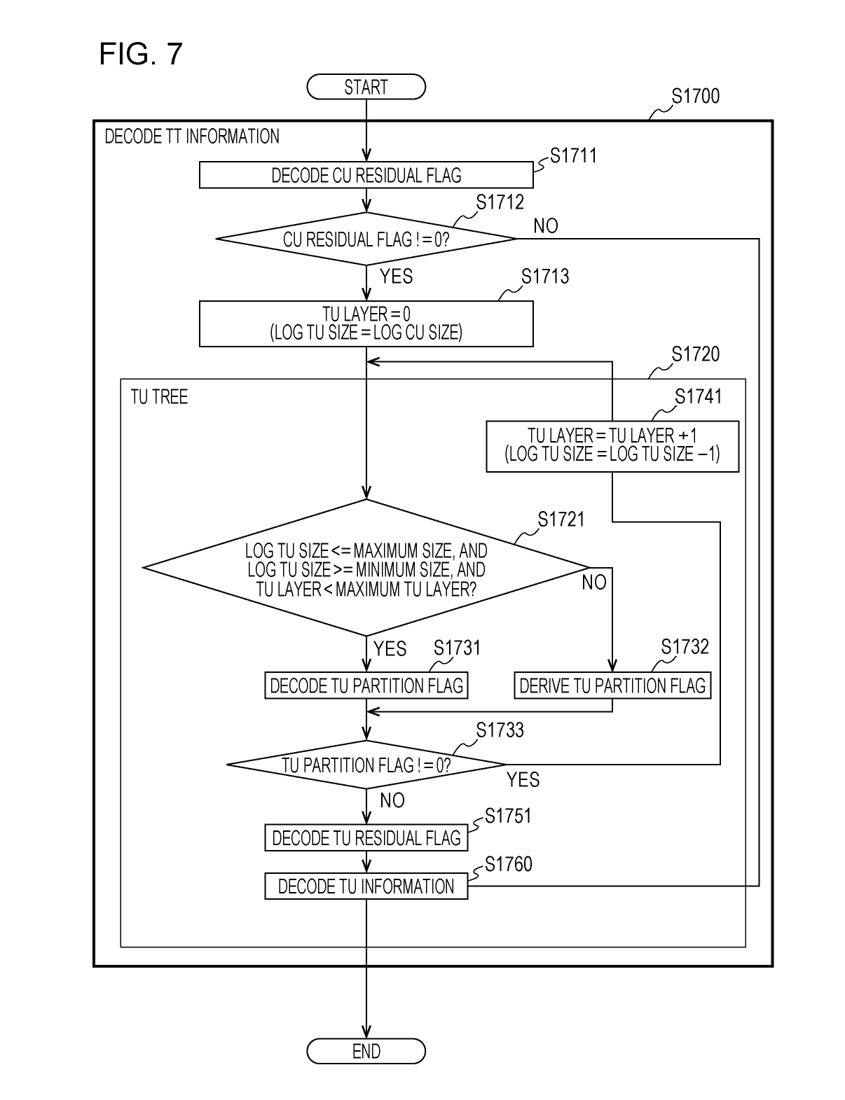

More specifically, the TU information decoding section 13 conducts the following operations as illustrated in FIG. 7. FIG. 7 is a flowchart explaining the schematic operation of the TU information decoding section 13 (TT information decoding S1700) according to an embodiment of the invention.

(S1711) The TU information decoding section 13 decodes, from the coded data #1, a CU residual flag rqt_root_cbf (the syntax element labeled SYN1711) indicating whether or not the target CU has a non-zero residual (quantized prediction residual).

(S1712) In the case in which the CU residual flag rqt_root_cbf is non-zero (=1) (SYN1712), the TU information decoding section 13 proceeds to S1721 to decode the TU. Conversely, in the case in which the CU residual flag rqt_root_cbf is 0, the process of decoding the TT information TTI of the target CU from the coded data #1 is skipped, and as the TT information TTI, it is derived that the target CU has no TU partitions, and the quantized prediction residual of the target CU is 0.

(S1713) The TU information decoding section 13 initializes a variable for managing the recursively partitioned transform tree. Specifically, like the formulas below, a TU layer trafoDepth indicating the layer of the transform tree is set to 0, and the size of the coding unit (herein, the logarithm of the CT size log2CbSize) is set as the transform unit size, that is, the TU size (herein, the logarithm of the TU size log2TrafoSize).

trafoDepth=0

log2TrafoSize=log2CbSize

Next, the highest (root) transform tree transform_tree (x0, y0, x0, y0, log2CbSize, 0, 0) is decoded (SYN1720). Herein, x0 and y0 are the coordinates of the target CU.

Hereinafter, the TU information decoding section 13 decodes the transform tree TU (transform tree) recursively.

(S1720). The transform tree TU is partitioned so that the size of the leaf node (transform block) obtained by the recursive partitioning becomes a predetermined size, namely, less than or equal to a maximum size MaxTbLog2SizeY of the transform, and equal to or greater than a minimum size MinTbLog2SizeY. For example, an appropriate value of the maximum size MaxTbLog2SizeY is 6, which indicates 64×64, and an appropriate value of the minimum size MinTbLog2SizeY is 2, which indicates 4×4.

In the case in which the transform tree TU is greater than the maximum size MaxTbLog2SizeY, unless the transform tree is partitioned, the transform block will not become less than or equal to the maximum size MaxTbLog2SizeY, and thus the transform tree TU is always partitioned in this case. Also, if the transform tree TU is partitioned in the case in which the transform tree TU is the minimum size MinTbLog2SizeY, the transform block will become less than the minimum size MinTbLog2SizeY, and thus the transform tree TU is not partitioned in this case. Also, it is appropriate to set a limit whereby the layer trafoDepth of the target TU becomes less than or equal to a maximum TU layer (MaxTrafoDepth), so that the recursive hierarchy does not become too deep. (S1721) A TU partitioning flag decoding section included in the TU information decoding section 13 decodes a TU partitioning flag (split_transform_flag) in the case in which the target TU size (for example, the logarithm of the TU size log2TrafoSize) is within a predetermined transform size range (herein, less than or equal to MaxTbLog2SizeY, and greater than MinTbLog2SizeY), and the layer trafoDepth of the target TU is less than a predetermined layer MaxTrafoDepth. More specifically, in the case in which the logarithm of the TU size log2TrafoSize<=the maximum TU size MaxTbLog2SizeY, and the logarithm of the TU size log2TrafoSize>the minimum TU size MinTbLog2SizeY, and the TU layer trafoDepth<the maximum TU layer MaxTrafoDepth, the TU partitioning flag (split_transform_flag) is decoded.

(S1731) The TU partitioning flag decoding section included in the TU information decoding section 13 obeys the condition of S1721, and decodes the TU partitioning flag split_transform_flag.

(S1732) Otherwise, that is, in the case in which split_transform_flag does not appear in the coded data #1, the TU partitioning flag decoding section included in the TU information decoding section 13 skips the decoding of the TU partitioning flag split_transform_flag from the coded data #1, and in the case in which the logarithm of the TU size log2TrafoSize is greater than the maximum TU size MaxTbLog2SizeY, derives that the TU partitioning flag split_transform_flag is set to partition (=1). Otherwise (if the logarithm of the TU size log2TrafoSize is equal to the minimum TU size MaxTbLog2SizeY, or the TU layer trafoDepth is equal to the maximum TU layer MaxTrafoDepth), the TU partitioning flag decoding section included in the TU information decoding section 13 derives that the TU partitioning flag split_transform_flag is set not to partition (=0).

(S1741) In the case in which the TU partitioning flag split_transform_flag is non-zero (=1) indicating to partition, the TU partitioning flag decoding section included in the TU information decoding section 13 decodes the transform tree included in the target coding unit CU. Herein, the four lower transform trees TT at the positions (x0, y0), (x1, y0), (x0, y1), and (x1, y1) with the logarithm of the CT size log2CbSize−1 and the TU layer trafoDepth+1 are decoded. Even in the lower coding trees TT, the TU information decoding section 13 continues the TT information decoding process S1700 started from S1711.

transform_tree(x0,y0,x0,y0,log2TrafoSize−1,trafoDepth+1,0) (SYN1741A)

transform_tree(x1,y0,x0,y0,log2TrafoSize−1,trafoDepth+1,1) (SYN1741B)

transform_tree(x0,y1,x0,y0,log2TrafoSize−1,trafoDepth+1,2) (SYN1741C)

transform_tree(x1,y1,x0,y0,log2TrafoSize−1,trafoDepth+1,3) (SYN1741D)

Herein, x0 and y0 are the upper-left coordinates of the target transform tree, while x1 and y1 are coordinates derived by adding ½ of the target TU size (1<<log2TrafoSize) to the transform tree coordinates (x0, y0), like in the formulas below.

x1=x0+(1<<(log2TrafoSize−1))

y1=y0+(1<<(log2TrafoSize−1))

Otherwise (in the case in which the TU partitioning flag split_transform_flag is 0), the flow proceeds to S1751 to decode the transform unit.

As described above, before recursively decoding the transform tree transform tree, the TU layer trafoDepth indicating the layer of the transform tree is incremented by 1 and updated, and the logarithm of the CT size log2TrafoSize, which is the target TU size, is decremented by 1 and updated, like the formulas below.

trafoDepth=trafoDepth+1

log2TrafoSize=log2TrafoSize−1

(S1751) In the case in which the TU partitioning flag split_transform_flag is 0, the TU information decoding section 13 decodes a TU residual flag indicating whether a residual is included in the target TU. Herein, a luminance residual flag cbf_luma indicating whether a residual is included in the luminance component of the target TU is used as the TU residual flag, but the configuration is not limited thereto.

(S1760) In the case in which the TU partitioning flag split_transform_flag is 0, the TU information decoding section 13 decodes the transform unit TU transform_unit(x0, y0, xBase, yBase, log2TrafoSize, trafoDepth, blkIdx) labeled SYN1760.

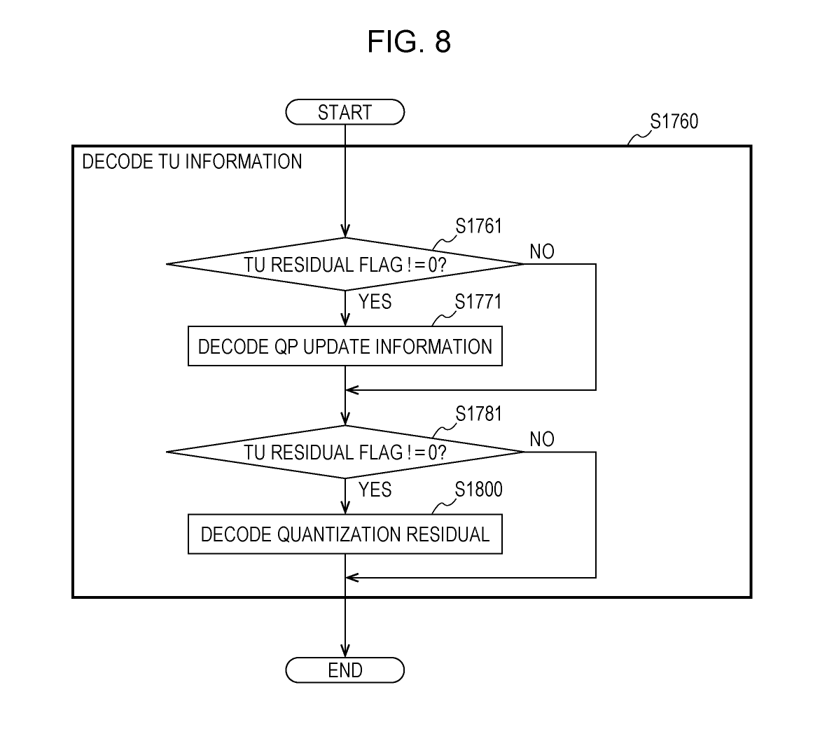

FIG. 8 is a flowchart explaining the schematic operation of the TU information decoding section 13 (TU information decoding S1600) according to an embodiment of the invention.

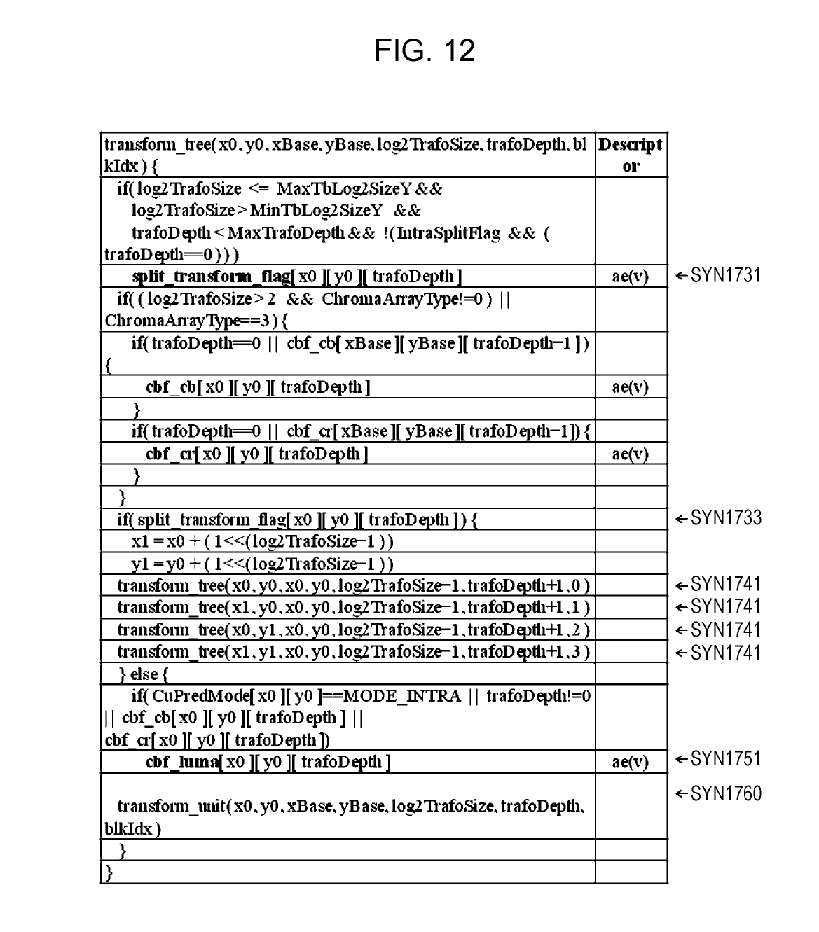

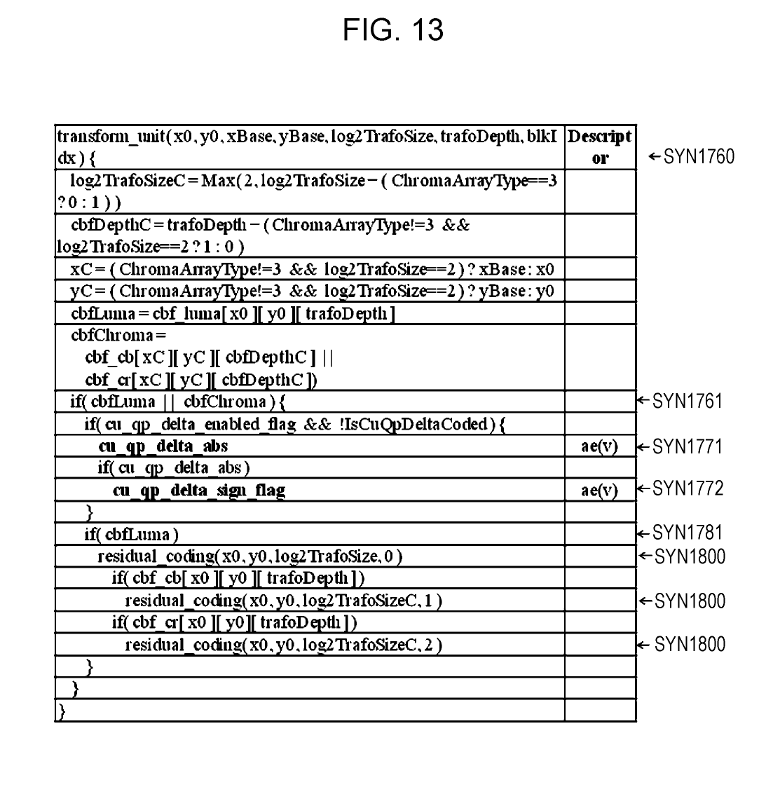

FIG. 12 is a diagram illustrating an exemplary configuration of a TT information TTI syntax table according to an embodiment of the present invention. FIG. 13 is a diagram illustrating an exemplary configuration of a TU information syntax table according to an embodiment of the present invention.

(S1761) The TU information decoding section 13 determines whether a residual is included in the TU (whether or not the TU residual flag is non-zero). Note that in (SYN1761) at this point, whether a residual is included in the TU is determined by cbfLuma∥cbfChroma derived by the following formulas, but the configuration is not limited thereto. In other words, the luminance residual flag cbf_luma indicating whether a residual is included in the luminance component of the target TU may also be used as the TU residual flag.

cbfLuma=cbf_luma[x0][y0][trafoDepth]

cbfChroma=cbf_cb[xC][yC][cbfDepthC]∥cbf_cr[xC][yC][cbfDepthC])

Note that cbf_cb and cbf_cr are flags decoded from the coded data #1 indicating whether a residual is included in the chrominance components Cb and Cr of the target TU, while ∥ indicates a logical sum. Herein, a luminance TU residual flag cbfLuma and a chrominance TU residual flag cbfChroma are derived from the syntax elements cbf_luma cbf_cb, and cbf_cr of the luminance position (x0, y0), the chrominance position (xC, yC), the TU depth trafoDepth and cfbDepthC of the TU, and their sum (logical sum) is derived as the TU residual flag of the target TU.

(S1771) In the case in which a residual is included in the TU (the case in which the TU residual flag is non-zero, the TU information decoding section 13 decodes QP update information (a quantization correction value). Herein, the QP update information is a value indicating the value of a difference from a predicted value of the quantization parameter QP, namely a quantization parameter predicted value qPpred. Herein, the value of the difference is decoded from an absolute value cu_qp_delta_abs and a sign cu_qp_delta_sign_flag which act as syntax elements of the coded data, but the configuration is not limited thereto.

(S1781) The TU information decoding section 13 determines whether or not the TU residual flag (herein, cbfLuma) is non-zero.

(S1800) In the case in which the TU residual flag (herein, cbfLuma) is non-zero, the TU information decoding section 13 decodes the quantized prediction residual. Note that the TU information decoding section 13 may also sequentially decode multiple color components as the quantized prediction residual. In the illustrated example, the TU information decoding section 13 decodes a luminance quantized prediction residual (first color component) residual_coding (x0, y0, log2TrafoSize-rru_flag, 0) in the case in which the TU residual flag (herein, cbfLuma) is non-zero, and decodes residual_coding (x0, y0, log2TrafoSize-rru_flag, 0) and a third color component quantized prediction residual residual_coding(x0, y0, log2trafoSizeC-rru_flag, 2) in the case in which the second color component residual flag cbf_cb is non-zero.

[Predicted Image Generating Section]

The predicted image generating section 14 generates a predicted image on the basis of the PT information PTI for each PU included in the target CU. Specifically, for each target PU included in the target prediction tree, the predicted image generating section 14 conducts intra prediction or inter prediction in accordance with the parameters included in the PU information PUI corresponding to the target PU, thereby generating a predicted image Pred from a locally decoded image P′, which is an already-decoded image. The predicted image generating section 14 supplies the generated predicted image Pred to the adder 17.

Note that the technique by which the predicted image generating section 14 generates a predicted image of the PU included in the target CU on the basis of motion compensation prediction parameters (motion vector, reference image index, inter prediction flag) is described as follows.

In the case in which the inter prediction flag indicates uni-prediction, the predicted image generating section 14 generates a predicted image corresponding to the decoded image positioned at the location indicated by the motion vector of the reference image indicated by the reference image index.

On the other hand, in the case in which the inter prediction flag indicates bi-prediction, the predicted image generating section 14 generates a predicted image by motion compensation for each combination of two pairs of reference image indices and motion vectors, and computes the average, or performs weighted addition of each predicted image on the basis of the display time interval between the target picture and each reference image, and thereby generates a final predicted image.

[Inverse Quantization/Inverse Transform Section]

The inverse quantization/inverse transform section 15 executes an inverse quantization/inverse transform process on the basis of the TT information TTI for each TU included in the target CU. Specifically, for each target TU included in the target transform tree, the inverse quantization/inverse transform section 15 applies an inverse quantization and an inverse orthogonal transform to the quantized prediction residual included in the TU information TUI corresponding to the target TU, thereby reconstructing a prediction residual D for each pixel. Note that the orthogonal transform at this point refers to an orthogonal transform from the pixel domain to the frequency domain. Consequently, an inverse orthogonal transform is a transform from the frequency domain to the pixel domain. Also, examples of the inverse orthogonal transform include the inverse discrete cosine transform (inverse DCT transform) and the inverse discrete sine transform (inverse DST transform). The inverse quantization/inverse transform section 15 supplies the reconstructed prediction residual D to the adder 17.

[Frame Memory]

Decoded images P that have been decoded are successively recorded to the frame memory 16, together with parameters used in the decoding of each decoded image P. In the case of decoding a target tree block, decoded images corresponding to all tree blocks decoded prior to that target tree block (for example, all preceding tree blocks in the raster scan order) are recorded in the frame memory 16. Examples of decoding parameters recorded in the frame memory 16 include the CU prediction mode information (PredMode) and the like.

[Adder]

The adder 17 adds together the predicted image Pred supplied by the predicted image generating section 14 and the prediction residual D supplied by the inverse quantization/inverse transform section 15, thereby generating a decoded image P for the target CU. Note that the adder 17 additionally ma execute a process of enlarging the decoded image P, as described later.

Note that in the video image decoding device 1, when the per-tree block decoded image generation process has finished for all tree blocks within an image, a decoded image #2 corresponding to the one frame's worth of coded data #1 input into the video image decoding device 1 is externally output.

<Configuration of Present Invention>

The video image decoding device 1 of the present invention is an image decoding device that decodes by partitioning a picture into coding tree block units, and is provided with a coding tree partitioning section (CU information decoding section 11) that recursively partitions a coding tree block as a root coding tree;

a CU partitioning flag decoding section that decodes a CU partitioning flag indicating whether or not to partition the coding tree; and
a residual mode decoding section that decodes a residual mode RRU (rru_flag, resolution transform mode) indicating whether to decode a residual of the coding tree and below in a first mode, or in a second mode different from the first mode.

Hereinafter, an example will be described in which the residual mode rru_flag=0 is the first mode and the residual mode rru_flag=1 is the second mode, but the assignment of values is not limited thereto. In addition, the residual mode is not limited to the two of a normal resolution (first mode) and a reduced resolution (second mode), for example, and for the second mode, a horizontally-reduced resolution (rru_mode=1), a vertically-reduced resolution (rru_mode=2), and a horiztonally- and vertically-reduced resolution (rru_mode=3) may also be used, for example.

Hereinafter, regarding the video image decoding device 1 of the present invention, P1: TU information decoding by TU information decoding section 13 according to residual mode, P2: block pixel value decoding according to residual mode, P3: quantization control according to residual mode, P4: decoding of residual mode rru_flag, P5: limitations of flag decoding according to residual mode, and P6: resolution change (residual mode change) at slice level will be described in order.

<<P1: TU Information Decoding According to Residual Mode>>

As described already using FIG. 7 (S1751, SN1751), in the case in which the TU partitioning flag split_transform_flag is 0, the TU information decoding section 13 decodes the TU residual flag cbf_luma.

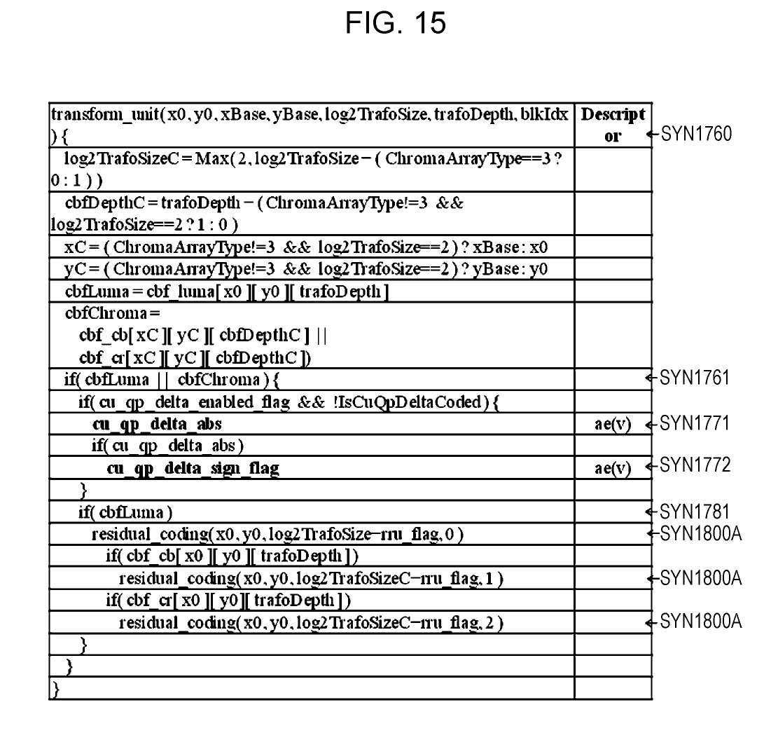

(S1760) The TU information decoding section 13 decodes the transform unit TU transform_unit (x0, y0, xBase, yBase, log2TrafoSize, trafoDepth, blkIdx), and obtains the quantized prediction residual. FIG. 15 is a diagram illustrating an exemplary configuration of a prediction residual information syntax table according to an embodiment of the present invention.

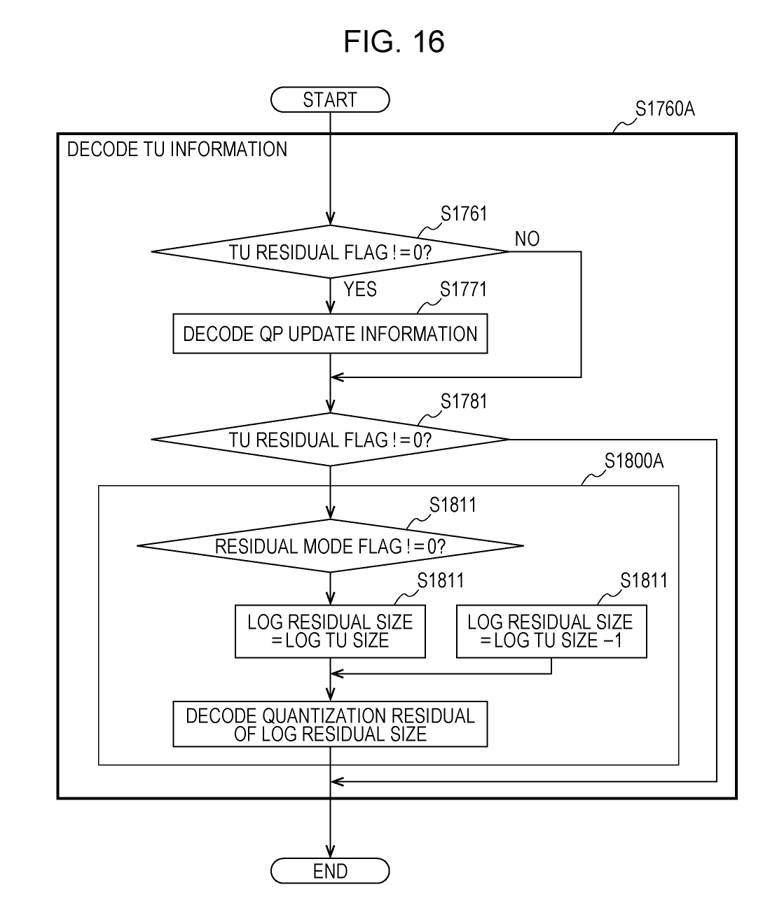

FIG. 16 is a flowchart explaining the schematic operation of the TU information decoding section 13 (TU information decoding 1760A) according to an embodiment of the invention. Since S1761, S1771, and S1781 have been described already in the TU information decoding S1760, description will be omitted. In the TU information decoding 1760A, the process of S1800A is conducted instead of S1800.

(S1800A) In the case in which the TU residual flag (herein, cbfLuma) is non-zero, the TU information decoding section 13 decodes the quantized prediction residual of the target region (target TU). In the present embodiment, in the case in which the residual mode rru_flag is the first mode (=0), the quantized prediction residual of the size (TU size) of the region corresponding to the target TU is decoded, whereas in the case in which the residual mode rru_flag is the second mode (!=0), the quantized prediction residual of half the size of the TU size is decoded. For example, in the case in which the TU size is 32×32, if the residual mode rru_flag is the first mode (=0), a 32×32 residual is decoded, whereas if the residual mode rru_flag is the first mode (=0), a 16×16 residual is decoded. In the case in which the TU size is the logarithm of the quantization size log2TrafoSize, the quantized prediction residual of the size (1<<log2TrafoSize)×(1<<log2TrafoSize) is decoded. Note that the quantization size corresponds to the size of the transform (size of the inverse transform).

Note that in the case in which the residual mode rru_flag is the second mode (!=0), it is also possible to halve the size of the quantized prediction residual in the horizontal direction only. In this case, if the residual mode rru_flag is the second mode (!=0), the quantized prediction residual of the size (1<<(log2TrafoSize−1))×(1<<log2TrafoSize) is decoded.

Note that in the case in which the residual mode rru_flag is the second mode (!=0), it is also possible to halve the size of the quantized prediction residual in the vertical direction only. In this case, if the residual mode rru_flag is the second mode (!=0), the quantized prediction residual of the size (1<<log2TrafoSize)×(1<<(log2TrafoSize−1)) is decoded.

The quantized prediction residual block size to actually decode may also be derived by treating log2TrafoSize-rru_flag as the logarithm of the size. In other words, in the case in which the residual mode rru_flag is the first mode (=0), the logarithm of the quantized prediction residual block size is taken to be the logarithm of the TU size log2TrafoSize, whereas in the case in which the residual mode rru_flag is the second mode (!=0), the logarithm of the quantized prediction residual block size is taken to be the logarithm of the TU size log2TrafoSize−1.

Details about the operation of S1800A is described as follows using the flowchart in FIG. 16.

(S1811) The TU information decoding section 13 determines whether the residual mode rru_flag is the first mode (=0).

(S1821) In the case in which the residual mode rru_flag is the first mode (=0), the TU information decoding section 13 takes the quantized prediction residual block size to be the TU size (the logarithm of the quantized prediction residual block size is set to log2TrafoSize). The quantized prediction residual block size (=inverse transform size) is (1<<log2TrafoSize)×(1<<log2TrafoSize).

(S1822) In the case in which the residual mode rru_flag is the second mode (!=0), the TU information decoding section 13 takes the quantized prediction residual block size to be ½ the TU size (the logarithm of the quantized prediction residual block size is set to log2TrafoSize−rru_flag=log2TrafoSize−1). The quantized prediction residual block size (=inverse transform size) is (1<<(log2TrafoSize−1))×(1<<(log2TrafoSize−1)).

(S1831) The TU information decoding section 13 derives the residual of the size of the quantized prediction residual block (logarithm of the quantized prediction residual block size).

Note that although the above flowchart deals with the luminance, a similar process may be performed on the other color components. Namely, in the case in which the chrominance TU size is log2TrafoSizeC, if the residual mode rru_flag is the first mode (==0), the quantized prediction residual of the size of log2TrafoSizeC is decoded, whereas if the residual mode rru_flag is the second mode (!=0), the quantized prediction residual of the size of log2TrafoSizeC−1 is decoded. With the above configuration, by decoding from the coded data the quantized prediction residual that is smaller (for example, residual information of ½ the target TU size) than the actual target TU size (transform block size), the prediction residual D of the target TU size can be derived, and an effect of reducing the code rate of the residual information is exhibited. Also, an effect of simplifying the process of decoding residual information is exhibited.

In the case of decoding and processing the quantized prediction residual of a reduced block, it is appropriate to perform enlargement at some point. Hereinafter, a method of enlarging at the stage of the prediction residual image (P2A) and a method of decoding at the stage of the decoded image (P2B) will be described. However, the method of enlargement does not depend on the following two, and enlargement may be performed at the time of storage in a frame buffer that saves the blocks of the decoded image, or enlargement may be performed when reading out from the frame buffer during prediction, playback, or the like, for example.

<<P2: Configuration of Block Pixel Value Decoding According to Residual Mode>>

<P2A: Enlargement of Prediction Residual D According to Residual Mode>

One configuration of the video image decoding device 1 will be described.

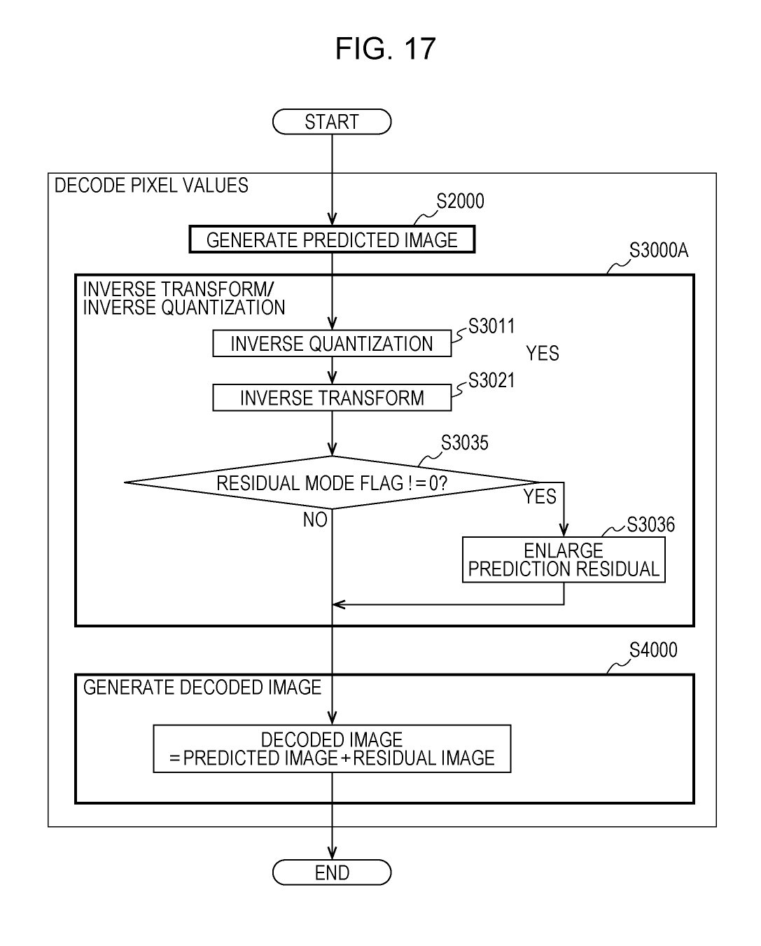

FIG. 17 is a flowchart explaining the schematic operation of the predicted image generating section 14 (prediction residual generation S2000), the inverse quantization/inverse transform section 15 (inverse quantization/inverse transform S3000A), and the adder 17 (decoded image generation S4000) according to an embodiment of the invention.

(S2000) The predicted image generating section 14 generates a predicted image on the basis of the PT information PTI for each PU included in the target CU.

(S3000A)

(S3011) The inverse quantization/inverse transform section 15 executes inverse quantization of the prediction residual residual TransCoeffLevel on the basis of the TT information TTI for each TU included in the target CU. For example, the prediction residual TransCoeffLevel is transformed into an inverse quantized prediction residual d[ ][ ] by the following formula.

d[x][y]=Clip3(coeffMin,coeffMax,((TransCoeffLevel[x][y]*m[x][y]*levelScale[qp %6]<<(qP/6))+(1<<(bdShift−1)))>>bdShift)

Herein, coeffMin and coeffMax are the minimum value and the maximum value of the inverse quantized prediction residual, and Clip3(x, y, z) is a clip function that limits z to a value equal to or greater than x, and less than or equal to y. Also, m[x][y] is a matrix indicating an inverse quantization weight for each frequency position (x, y), called a scaling list. The scaling list m[ ][ ] may be decoded from the PPS, or a fixed value (for example, 16) not dependent on the frequency position may be used as m[x][y], for example. Also, qP is a quantization parameter (for example, from 0 to 51) of the target block, while levelScale[qP %6] and bdShift are the quantization scale and the quantization shift value derived from each quantization parameter. By multiplying the quantization scale by the quantized prediction residual and right-shifting by the quantization shift value, computation that is equivalent to multiplying the quantization step by the quantized prediction residual with decimal precision is achieved by integer computation. Herein, if the transform block size is taken to be nTbS(=1<<log2TrafoSize), levelScale[qP %6] (=32*2^{(qP+1)/6}) may be derived from {40, 45, 51, 57, 64, 72}, bdShift=BitDepthY+log2(nTbS)−5, for example.

(S3021) The inverse quantization/inverse transform section 15 executes an inverse transform on the inversely quantized residual on the basis of the TT information TTI, and derives the prediction residual D.

For example, the inverse quantized prediction residual d[ ][ ] is transformed into a prediction residual g[x][y] by the following formula. First, the inverse quantization/inverse transform section 15 computes an intermediate value e[x][y] by a one-dimensional transform in the vertical direction.

e[x][y]=Σ(transMatrix[y][j]×d[x][j])

Herein, transMatrix[ ][ ] is a nTbS×nTbS matrix determined for each transform block size nTbS. In the case of a 4×4 transform (nTbS=4), transMatrix[ ][ ]={{29 55 74 84}{74 74 0 −74}{84 −29 −74 55}{55 −84 74 −29}} may be used, for example. The sign Σ denotes a process that adds together the product of the matrix transMatrix[y][j] and d[x][j] over the subscript j, where j=0 . . . nTbS−1. In other words, e[x][y] is obtained by lining up the columns obtained from product of each column d[x][y], namely, d[x][j] (where j=0 . . . nTbS−1) and the matrix transMatrix.

The inverse quantization/inverse transform section 15 clips the intermediate value e[ ][ ], and derives g[x][y].

g[x][y]=Clip3(coeffMin,coeffMax,(e[x][y]+64)>>7)

The inverse quantization/inverse transform section 15 derives the prediction residual r[x][y] by a one-dimensional transform in the horizontal direction.

r[x][y]=ΣtransMatrix[x][j]×g[j][y]

The above sign Σ denotes a process that adds together the product of the matrix transMatrix[x][j] and g[y][j] over the subscript j, where j=0 . . . nTbS−1. In other words, r[x][y] is obtained by lining up the rows obtained from product of each row g[x][y], namely, g[j][y] (where j=0 . . . nTbS−1) and the matrix transMatrix.

(S3035) In the case in which the residual mode indicates the second mode (!=0), the inverse quantization/inverse transform section 15 enlarges the inversely quantized and inversely transformed prediction residual D to the TU size (S3036). Otherwise (the residual mode is the first mode, namely 0), the inversely quantized and inversely transformed prediction residual D is not enlarged to the TU size.

For example, the inverse quantization/inverse transform section 15 enlarges the prediction residual rlPicSampleL[x][y] by the following formulas. r′[ ] [ ] [ ] is the enlarged prediction residual.

tempArray[n]=(fL[xPhase,0]*rlPicSampleL[xRef−3,yPosRL]+fL[xPhase,1]*rlPicSampleL[xRef−2,yPosRL]+fL[xPhase,2]*rlPicSampleL[xRef−1,yPosRL]+fL[xPhase,3]*rlPicSampleL[xRef−0,yPosRL]+fL[xPhase,4]*rlPicSampleL[xRef+1,yPosRL]+fL[xPhase,5]*rlPicSampleL[xRef+2,yPosRL]+fL[xPhase,6]*rlPicSampleL[xRef+3,yPosRL]+fL[xPhase,7]*rlPicSampleL[xRef+4,yPosRL]+offset1)>>shift1

r′=(fL[yPhase,0]*tempArray[0]+fL[yPhase,1]*tempArray[1]+fL[yPhase,2]*tempArray[2]+fL[yPhase,3]*tempArray[3]+fL[yPhase,4]*tempArray[4]+fL[yPhase,5]*tempArray[5]+fL[yPhase,6]*tempArray[6]+fL[yPhase,7]*tempArray[7]+offset2)>>shift2

Herein, xRef and yRefRL are the integer coordinates of the reference pixel, xPhase and yPhase are phases expressing the shift between ideal reference pixel coordinates and the reference pixel integer coordinates with 1/16 pixel precision, fL[i, j] is a weight depending on the relative position j from the integer coordinates of the reference pixel in the case where the phase is i, offset1 and offset2 are rounding variables, for which (1<<(shift1−1)) and (1<<(shift2−1)) are used, respectively, and shift1 and shift2 are shift values for normalizing to the range of the original value after multiplying by the weight. The above achieves enlargement by a filter process using a discrete filter, but the configuration is not limited thereto. For example, in the case of setting the enlargement ratio to 2×, the above values may derive the position of the target pixel from (x, y) according to xRef=x>>1, yRefRL=y>>1, xPhase=((x×16)>>1)−xRef×16, yPhase=((y×16)>>1)−xRefRL×16.

For the filter coefficients fL, with respect to the integer positions (phase=0) and the positions shifted by ½ pixel (phase=8 for a phase of 1/16 pixel precision) produced by 2× enlargement, the following values may be used, respectively.

fL[0,n]={0,0,0,64,0,0,0,0}

fL[8,n]={−1,4,−11,40,40,11,4,1}

Also, the enlargement ratio is not limited to 2×, and may also be 1.33×, 1.6×, (2×), 2.66×, 4×, and the like. Each of the above enlargement ratios is the value corresponding to the case of enlarging to an enlarged size of 16 when the size of the quantized prediction residual (inverse transform) is 12, 10, (8), 6, and 4.

(S4000) The decoding module 10 uses the adder 17 to add together the predicted image Pred supplied by the predicted image generating section 14 and the prediction residual D supplied by the inverse quantization/inverse transform section 15, thereby generating a decoded image P for the target CU.

With the above configuration, in the case in which the residual mode is the second mode (!=0), the inverse quantization/inverse transform section 15 enlarges the transformed image. Consequently, by decoding information smaller (for example, residual information of ½ the target TU size) than the actual target TU size, the prediction residual D of the target TU size can be derived, and an effect of reducing the code rate of the residual information is exhibited. Also, an effect of simplifying the process of decoding residual information is exhibited.

<P2B: Enlargement of Decoded Image According to Residual Mode>

One configuration of the video image decoding device 1 will be described.

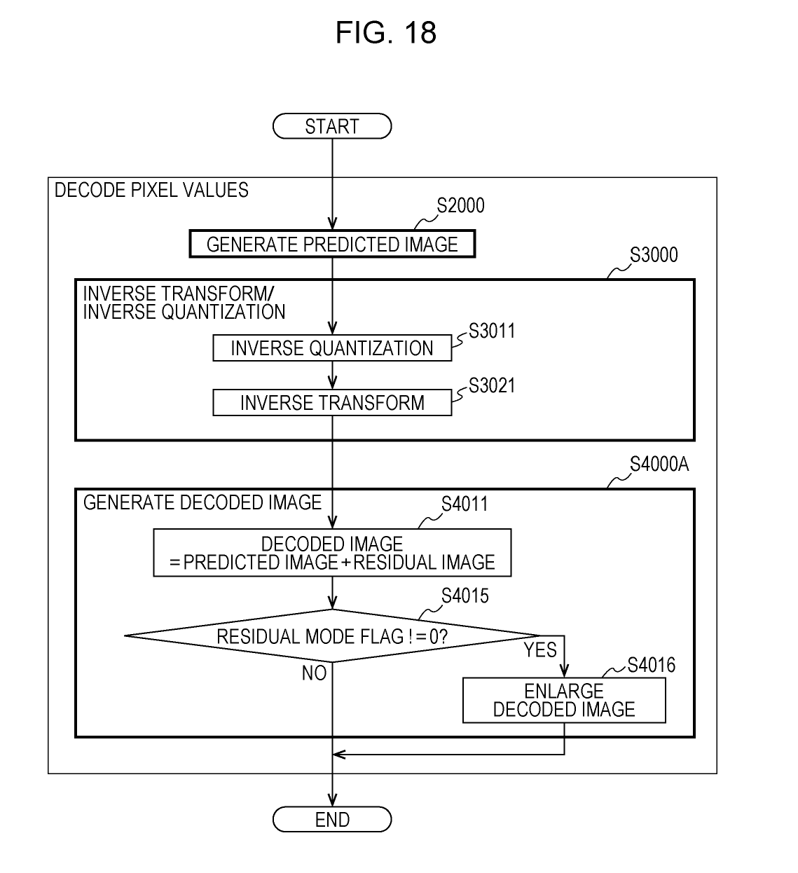

FIG. 18 is a flowchart explaining the schematic operation of the predicted image generating section 14 (prediction residual generation S2000), the inverse quantization/inverse transform section 15 (inverse quantization/inverse transform S3000A), and the adder 17 (decoded image generation S4000) according to an embodiment of the invention.

(S2000) The predicted image generating section 14 generates a predicted image on the basis of the PT information PTI for each PU included in the target CU.

(S3000) The inverse quantization/inverse transform section 15 conducts inverse quantization/inverse transform by the processes in S3011 and S3012.

(S3011) The inverse quantization/inverse transform section 15 executes inverse quantization on the basis of the TT information TTI for each TU included in the target CU. Since details regarding inverse quantization have already been described, further description is omitted.

(S3021) The inverse quantization/inverse transform section 15 executes an inverse transform on the inversely quantized residual on the basis of the TT information TTI, and derives the prediction residual D. Since details regarding inverse transform have already been described, further description is omitted.

(S4000A) The decoding module 10 generates a decoded image P.

(S4011) The decoding module 10 uses the adder 17 to add together the predicted image Pred supplied by the predicted image generating section 14 and the prediction residual D supplied by the inverse quantization/inverse transform section 15, thereby generating a decoded image P for the target CU.

(S4015) In the case in which the residual mode indicates the second mode (!=0), the decoded image decoded from the predicted image Pred and the predication residual D is enlarged (S3036). Otherwise (the residual mode is the first mode, namely 0), the decoded image is not enlarged.

Details regarding enlargement are similar to P2A, which enlarges the prediction residual image. However, the input rlPicSampleL[x][y] becomes the decoded image instead of the prediction residual, and the output r′[ ] [ ] [ ] becomes the enlarged decoded image.

With the above configuration, in the case in which the residual mode is the second mode (!=0), the decoding module 10 enlarges the decoded image. Consequently, by decoding just the prediction residual information of a region size smaller than the actual target region (for example, prediction residual information of ½ the size of the target region), a decoded image of the target region can be derived, and an effect of reducing the code rate of the residual information is exhibited. Also, an effect of simplifying the process of decoding residual information is exhibited.

<<P3: Exemplary Configuration of Quantization Control According to Residual Mode>>

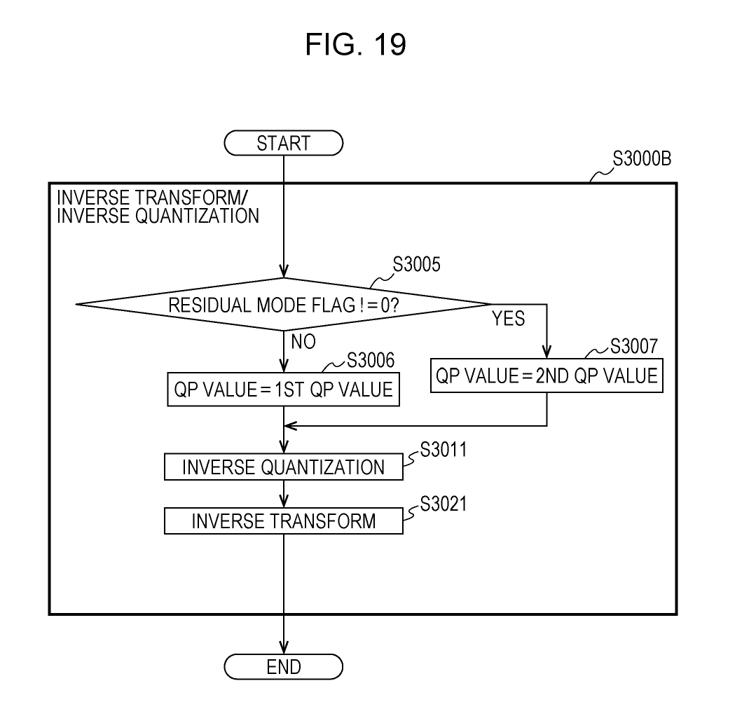

FIG. 19 is a flowchart explaining the schematic operation of the inverse quantization/inverse transform section 15 (inverse quantization/inverse transform S3000B) according to an embodiment of the invention.

(S3005) In the case in which the residual mode is the second mode (!=0), the inverse quantization/inverse transform section 15 sets a second QP value as the quantization parameter qP (S3007). Otherwise (the residual mode is the first mode, namely 0), a first QP value is set as the quantization parameter qP.

For example, as the first QP value, the inverse quantization/inverse transform section 15 uses the following value qP1 derived from a quantization correction value CuQpDeltaVal and a quantization parameter predicted value qPpred.

qP1=qP_{pred}+CuQpDeltaVal

Note that the following formula may also be used to derive qP1.

qP1=((qP_{pred}+CuQpDeltaVal+52+2*QpBdOffset_{Y})%(52+QpBdOffset_{Y}))−QpBdOffset_{Y}

Note that QpBdOffset_{Y} is a correction value for adjusting the quantization for each bit depth (for example, 8, 10, 12) of the pixel value.

Also, as the second QP value, the inverse quantization/inverse transform section 15 uses the following value qP2 derived from the quantization correction value CuQpDeltaVal and a quantization parameter predicted value QPpred. The quantization parameter predicted value QPpred uses the average or the like of the QP of the block to the left and the QP of the block above the target block, for example.

qP2=qP1+offset_rru

Herein, offset_rru may be a fixed constant (for example, 5 or 6), or a value coded in the slice header or the PPS may be used.

Next, the inverse quantization/inverse transform section 15 uses the quantization parameter qP (herein, qP1 or qP2) set according to the residual mode as already described, and conducts inverse quantization (S3011) and inverse transform (S3021).

<Another Exemplary Configuration of Quantization Control According to Residual Mode>

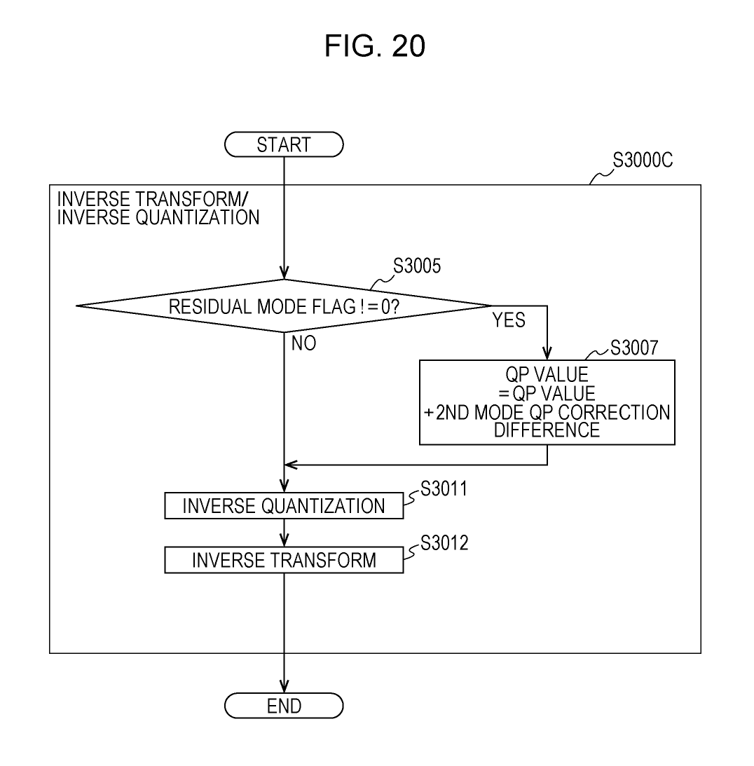

FIG. 20 is a flowchart explaining the schematic operation of the inverse quantization/inverse transform section 15 (inverse quantization/inverse transform S3000C) according to an embodiment of the invention.

(S3005) In the case in which the residual mode is the first mode (=0), a normal quantization step QP is set as the quantization step QP. Otherwise (the residual mode is the second mode, namely not equal to 0), the quantization step QP is corrected by adding a QP correction difference to the normal QP value.

For example, the inverse quantization/inverse transform section 15 uses a value obtained by adding the QP correction difference offset_rru to the normal QP value qP as the QP value.

qP=qP+offset_rru

Herein, offset_rru may be a fixed constant (for example, 5 or 6), or a value coded in the slice header or the PPS may be used.

Next, the inverse quantization/inverse transform section 15 uses the quantization parameter qP set according to the residual mode as already described, and conducts inverse quantization (S3011) and inverse transform (S3021).

According to the above quantization control according to the residual mode, by controlling the quantization parameter qP according to the residual mode, there is exhibited an effect of being able to control appropriately the amount of reduction in the code rate of the residual information regarding the region where the residual mode is applied (for example, the picture, slice, CTU, CT, CU, or TU). Also, since the code rate of the residual information is correlated with image quality, as a result, there is exhibited an effect of being able to control appropriately the image quality of the region where the residual mode is applied.

Note that the above configuration is due to the following findings that the inventor has discovered empirically and analytically. Set the resolution to ½. Empirically, if the size of a certain region is reduced by ½ and transformed, the code rate becomes roughly ½ with the same quantization parameter (quantization step). Particularly, if the resolution not of the entire picture but of a partial region of a picture, such as a slice or a coding unit, is lowered (the information about the quantization residual is lowered) by the residual mode, there is a possibility that changing to ½ the code rate will lower the code rate too much, or the lowering of the code rate will remain insufficient. To solve this problem, if a parameter for controlling the quantization on a per-region basis, namely a quantization parameter correction (also called the quantization step difference, qpOffset, deltaQP, dQP, and the like) is coded, then there is a problem in that code for the quantization parameter correction becomes necessary, leading to a smaller effect of reducing the code rate overall, or lowered coding efficiency.

Also, according to the inventor, it is analytically understood that if the size of a certain region is reduced by ½ and transformed, the coded energy becomes ½. In other words, compared to a transform (for example, the DCT transform) of size N, for a transform of size N/2, the energy of the pixel region becomes ¼ due to the surface area becoming ¼. Conversely, with a transform of size N/2, the number of divisions for the normalization process conducted during the transform (a type of quantization step) is normally set smaller by ½, and the small energy is set to remain as transform coefficients. As a result, in the case of reducing the size of a certain region by ½, the energy obtained in the transform coefficient domain becomes ½ (=¼*2) of that before the reduction. This fact means that if a mode that codes with little residual is selected as the residual mode, and the resolution of a partial region of a picture is lowered (the information about the quantization residual is lowered), at this point, the image quality is lowered by a predetermined reduction ratio, together with a reduction ratio of approximately ½ for the code rate. Since the reduction ratio is fixed, there is a problem in that the image quality may be lowered too much, or in some cases the lowering of the image quality may be insufficient, similarly to the code rate described above. An objective (advantageous effect) of the present embodiment is not to use a conventional quantization parameter correction, but instead to control the code rate and the image quality of a region that coarsens the quantization according to the residual mode.

<<P4: Configurations of Residual Mode Decoding Section>>

Hereinafter, embodiments of the video image decoding device 1 with different configurations of the residual mode decoding section will be described further in order. Hereinafter, P4a: configuration of CTU layer residual mode decoding section, P4b: configuration of CT layer residual mode, P4c: configuration of CU layer residual mode, and P4d: configuration of TU layer residual mode will be described in order.

<P4a: Configuration of CTU Layer Residual Mode Decoding Section>

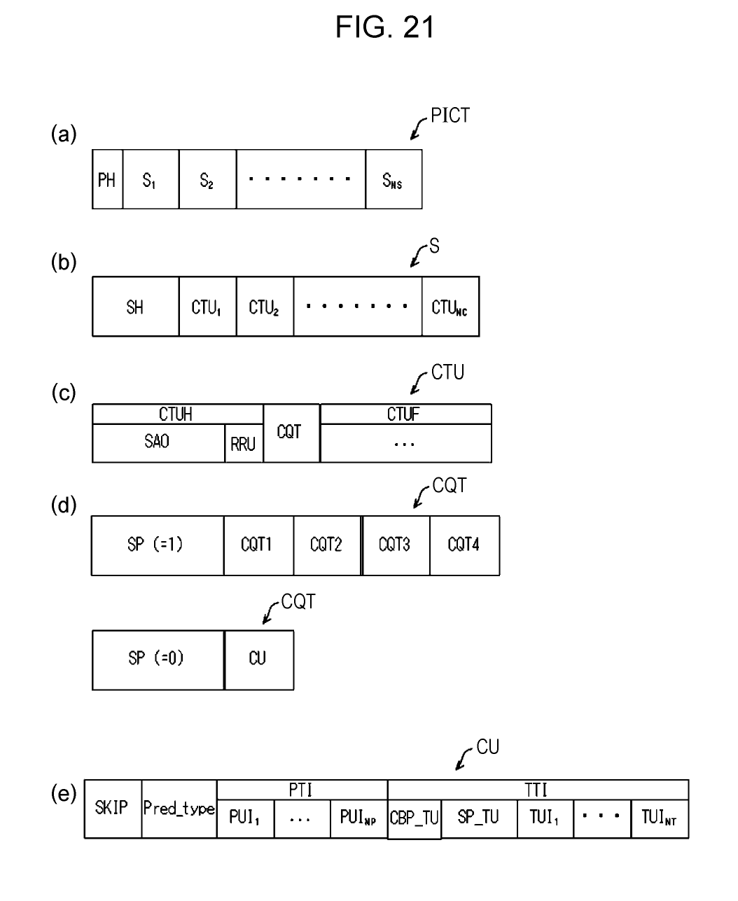

Hereinafter, one configuration of the video image decoding device 1 will be described using FIGS. 21 to 23.

FIG. 21 is a diagram illustrating the data structure of coded data generated by the video image coding device according to an embodiment of the present invention, and decoded by the above video image decoding device. As illustrated in FIG. 21(c), the video image decoding device 1 decodes the residual mode RRU (rru_flag) included in the CTU layer (herein, the CTU header, CTUH) in the coded data #1.

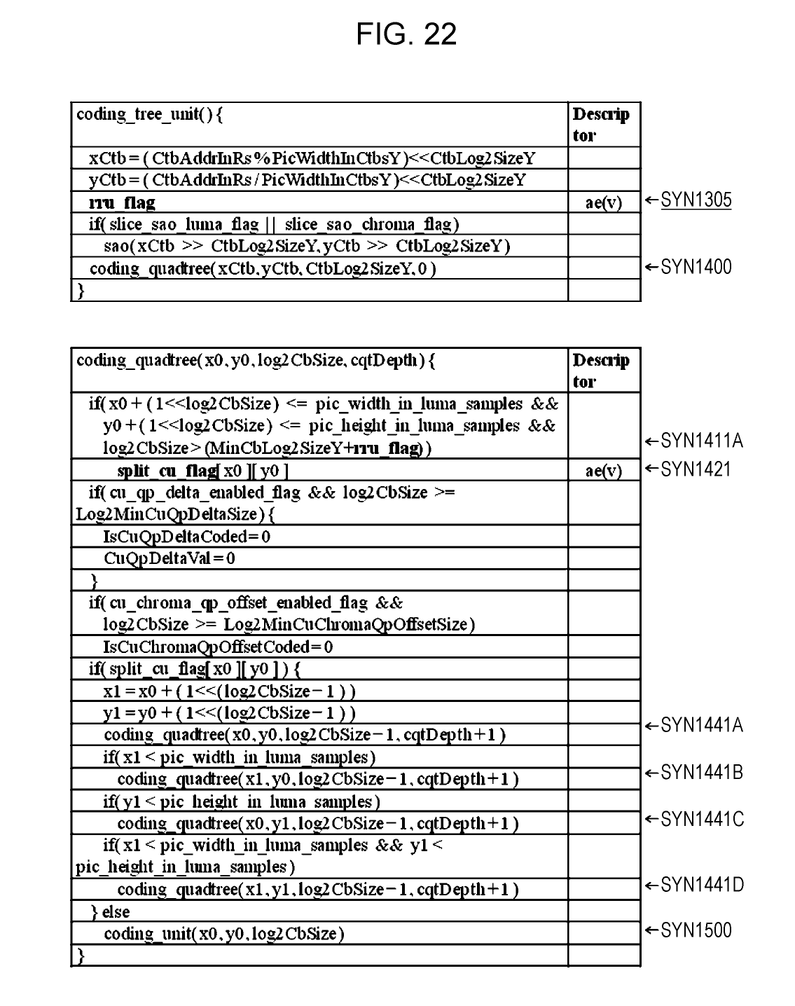

FIG. 22 is a diagram illustrating an exemplary configuration of a CU information syntax table according to an embodiment of the present invention.

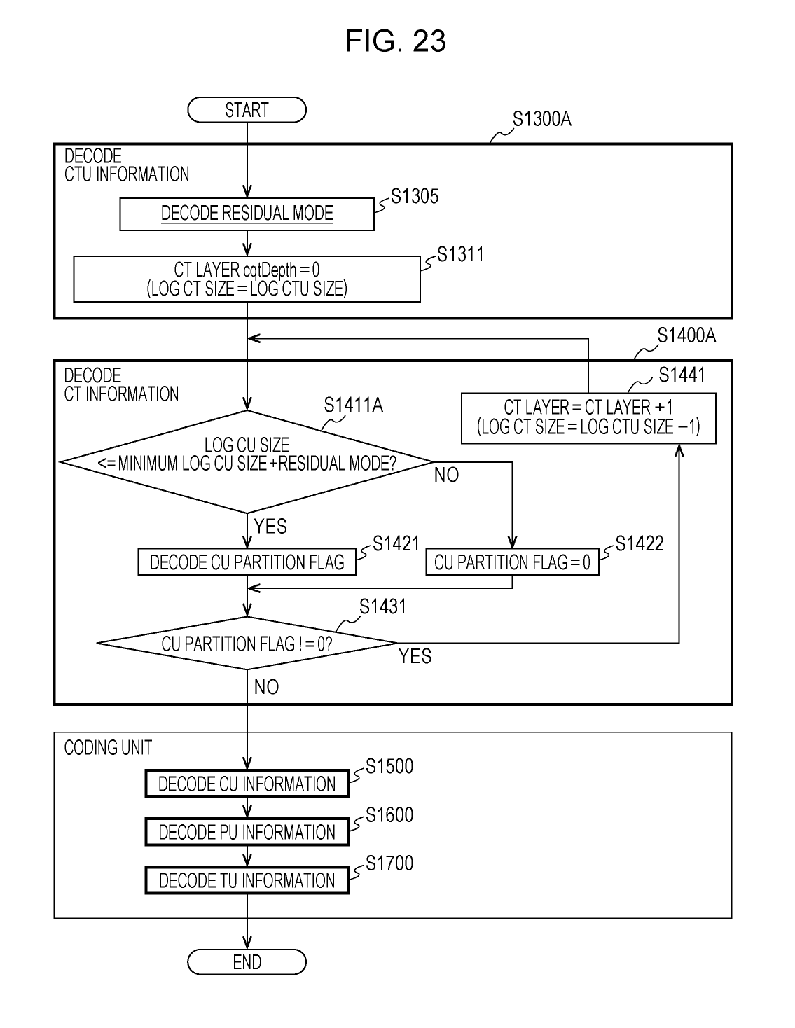

FIG. 23 is a flowchart explaining the schematic operation of the CU information decoding section 11 (CTU information decoding S1300, CT information decoding S1400A) according to an embodiment of the invention. Compared to FIG. 5 described already, the CU information decoding section 11 conducts S1300A instead of the process in S1300. Namely, before the CU information decoding section 11 decodes the coding unit (CU partitioning flag, CU information, PT information PTI, TT information TTI), the residual mode decoding section included in the CU information decoding section 11 decodes the residual mode rru_flag labeled SYN1305 (S1305) from the coded data.

Otherwise, the operation of the CU information decoding section 11 is the same as the process in S1300 described already using FIG. 5.

The residual mode decoding section of this configuration decodes the residual mode (rru_flag) from the coded data #1 only in the highest coding tree, namely the coding tree unit CTU. In lower coding trees, the residual mode (rru_flag) is not decoded, and the value of the residual mode decoded in the higher coding tree is used as the residual mode of the target block in the lower tree. For example, in the case in which the layer of the target CT is cqtDepth, the value of the residual mode decoded in the higher coding tree CT, namely the coding tree CT of cqtDepth−1, cqtDepth−2, or the like, the value of the residual mode decoded in the CTU header, or the value of the residual mode decoded in the slice header or the parameter set is used.

In the above configuration, since the residual mode rru_flag is included in the coded data only in the coding tree unit (CTU block) which is the maximum unit region less than the slice constituting the picture, there is an effect of reducing the code rate of the residual mode rru_flag. Also, since block partitioning by quadtree is jointly used below the coding tree unit, an effect of enabling prediction and transform at block sizes with a high degree of freedom is exhibited even in regions where the configuration of the residual is changed by the residual mode rru_flag.

Put simply, in the above configuration, it becomes possible to select the mode with the highest coding efficiency from among a case in which the residual mode is the first mode and the block size is large, a case in which the residual mode is the first mode and the block size is small, a case in which the residual mode is the second mode and the block size is large, and a case in which the residual mode is the second mode and the block size is small. Thus, an effect of improving the coding efficiency is exhibited.

<Decoding CU Partitioning Flag According to Value of Residual Mode>

Note that, in a configuration that decodes the residual mode before decoding the CU partitioning flag, like the present configuration that decodes the residual mode at the CTU level (P4a), and the configuration described later that decodes the residual mode at the CT level (P4b), it is appropriate to decode the CU partitioning flag according to the value of the residual mode. Hereinafter, this configuration will be described using the following process in S1411A illustrated in FIG. 23. The CU information decoding section 11 of the present configuration conducts the process in S1411A instead of the process in S1411.

(S1411A) As also illustrated in the syntax configuration of SYN1311A in FIG. 22, the CU information decoding section 11 determines whether or not the logarithm of the CU size log2CbSize is greater than a predetermined minimum CU size MinCbLog2SizeY, according to the residual mode. In the case in which the logarithm of the CU size log2CbSize+residual mode rru_mode is greater than MinCbLog2SizeY, the CU partitioning flag split_cu_flag illustrated by the syntax element of SYN1321 is decoded from the coded data (S1421). Otherwise, the decoding fo the CU partitioning flag split_cu_flag is skipped and estimated to be 0, which indicates not to partition (S1422).

Note that the term (log2CbSize+rru_mode) of the determination formula due to the addition of the value of the residual mode imay also be derived by a process that adds 1 unless the residual mode is 0 (log2CbSize+(rru_mode?1:0)) (the same applies hereinafter). The process of S1411A described above is equal to the following process. In other words, in the case in which the residual mode is the first mode, namely 0, if the logarithm of the CU size log2CbSize is greater than the predetermined minimum CU size MinCbLog2SizeY (if the coding block size is greater than the minimum coding block), the CU information decoding section 11 decodes the CU partitioning flag split_cu_flag (S1421). Otherwise, the CU information decoding section 11 does not decode the CU partitioning flag split_cu_flag and estimates 0, which indicates not to partition (S1422). In the case in which the residual mode is the second mode, namely 1, if the logarithm of the CU size log2CbSize is greater than the predetermined minimum CU size MinCbLog2SizeY+1 (if the coding block size is greater than the minimum coding block+1), the CU information decoding section 11 decodes the CU partitioning flag split_cu_flag (S1421). Otherwise, the CU information decoding section 11 does not decode the CU partitioning flag split_cu_flag and estimates 0, which indicates not to partition (S1422).

In the above, in the case in which the residual mode is the second mode, the CU partitioning flag decoding section included in the CU information decoding section 11 adds 1 to the partitioning threshold value, namely the minimum CU size MinCbLog2SizeY. In other words, in the case in which the residual mode is the first mode, if the CU partitioning size is equal to the minimum CU size MinCbLog2SizeY, the region is not partitioned, and the quadtree partitioning of the coding tree is ended. In the case in which the residual mode is the second mode, due to the addition of 1 above, if the CU partitioning flag is equal to the minimum CU size MinCbLog2SizeY+1, the region is not partitioned, and the quadtree partitioning of the coding tree is ended. This corresponds to decreasing by 1 the depth of the maximum layer of the coding tree which can be partitioned by quadtree partitioning in the case in which the residual mode is the second mode compared to the case of the first mode. Note that instead of the determination formula (log2CbSize+rru_mode) that adds 1 according to the value of the residual mode, a process that adds 2 unless the residual mode is 0 (log2CbSize+(rru_mode?2:0)) may be used as the determination formula. In this case, the maximum number of layers at which to conduct quadtree partitioning can be decreased by two levels in the case in which the residual mode is the second mode.

In the above configuration, an effect is exhibited whereby the block size is prevented from becoming too small by over-partitioning. Also, in the case in which the residual mode rru_flag is the second mode (!=0), compared to the case in which the residual mode rru_flag is the first mode (=0), partitioning is conducted down to only one fewer layer (the CU partitioning flag is not decoded), and thus an effect of decreasing the overhead related to the CU partitioning flag is exhibited.

<P4b: Configuration of CT Layer Residual Mode>

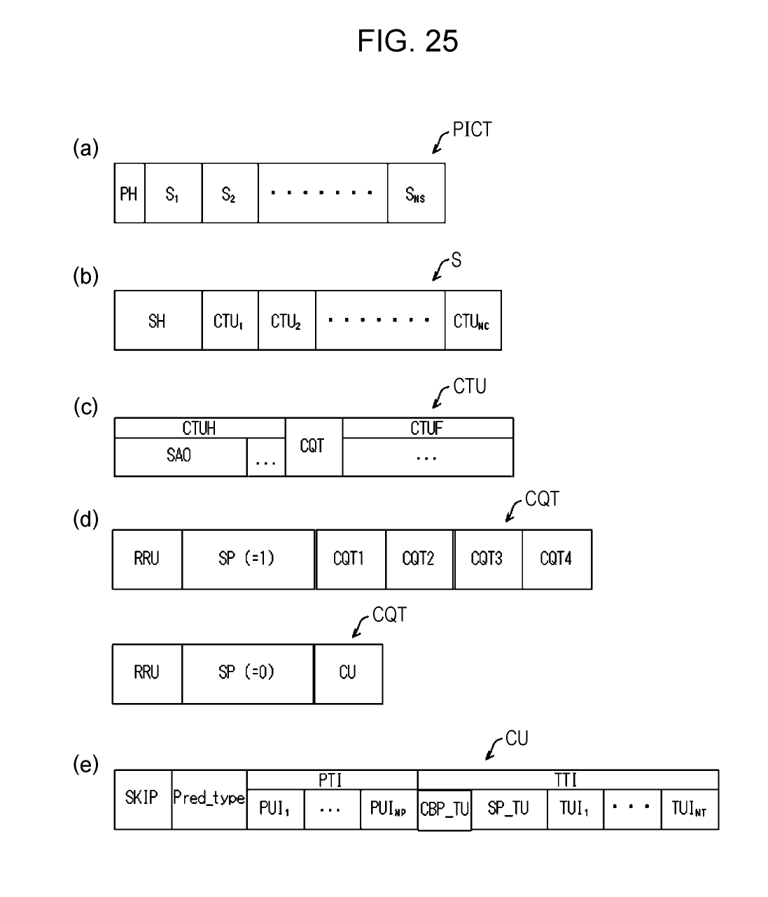

Hereinafter, one configuration of the video image decoding device 1 will be described using FIGS. 25 to 27.

FIG. 25 is a diagram illustrating the data structure of coded data generated by the video image coding device according to an embodiment of the present invention, and decoded by the above video image decoding device. As illustrated in FIG. 25(c), the video image decoding device 1 decodes the residual mode rru_flag included in the CT layer in the coded data #1.

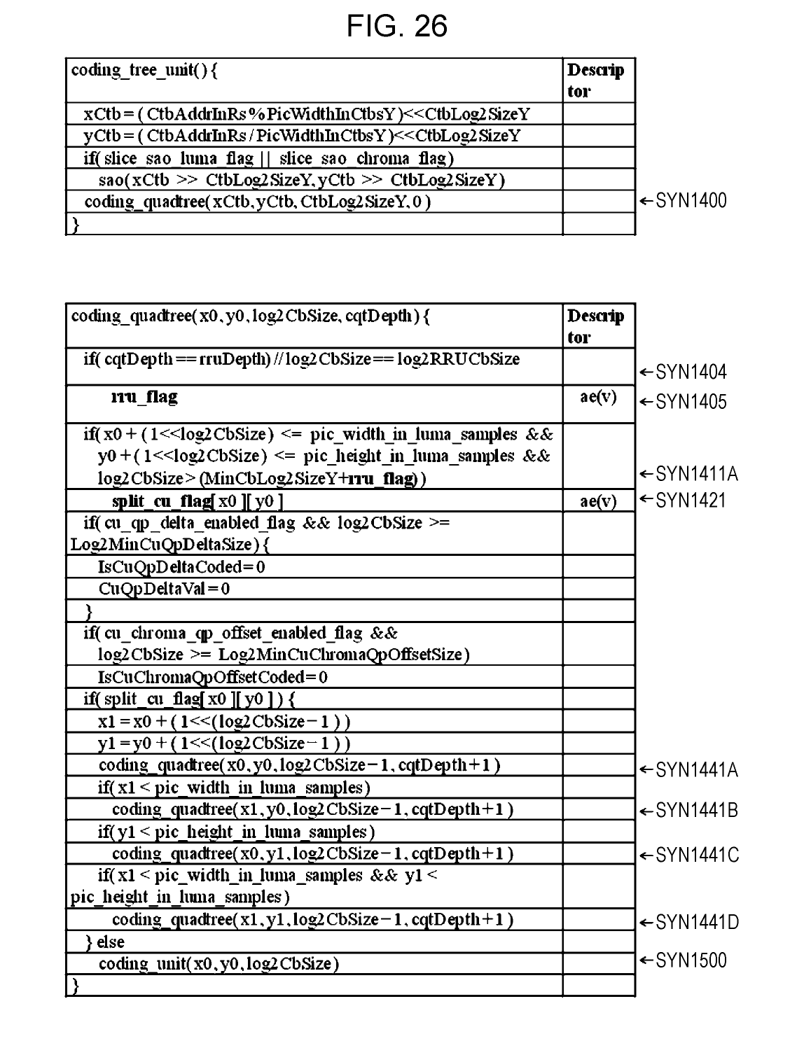

FIG. 26 is a diagram illustrating an exemplary configuration of a CU information syntax table according to an embodiment of the present invention.

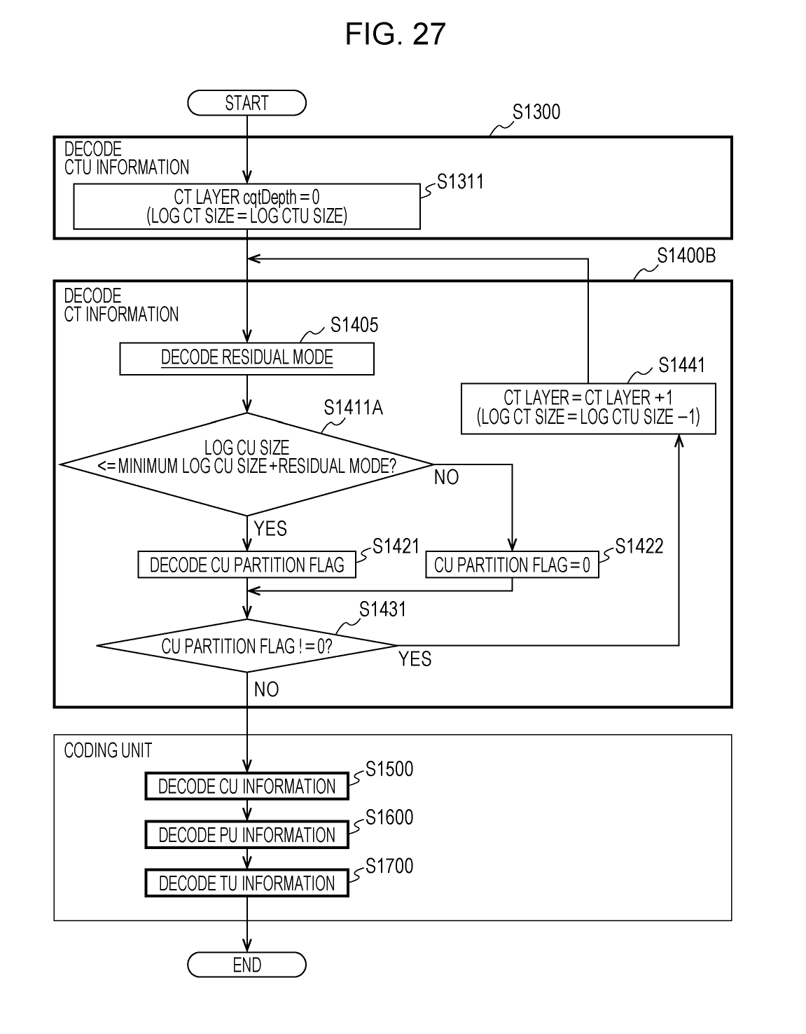

FIG. 27 is a flowchart explaining the schematic operation of the CU information decoding section 11 (CTU information decoding S1300, CT information decoding S1400B) according to an embodiment of the invention.

This differs from the CU information decoding section 11 already described using FIG. 6 in that a process of decoding the residual mode rru_flag in S1405 has been added.

(S1405) The CU information decoding section 11 decodes the syntax element labeled SYN1405, namely the residual mode rru_flag, in the coding tree (CT) obtained by partitioning the CTB.

Unlike S1305, the operation in S1405 can decode the residual mode rru_flag even in layers lower than the highest-layer coding tree (CTB).

Note that, as illustrated by SYN1404 in FIG. 26, it is desirable for the residual mode decoding section of the CU information decoding section 11 to decode the residual mode rru_flag in the case in which the CT layer cqtDepth satisfies a specific condition, such as when equal to a predetermined layer rruDepth, for example.

Note that decoding the residual mode rru_flag in the case in which the CT layer cqtDepth is equal to the predetermined layer rruDepth is equivalent to decoding the residual mode in the case in which the coding tree is a specific size. Consequently, the CT size (CU size) may also be used, without using the CT layer cqtDepth.

Like the formula below, in the case in which the logarithm of the CT size log2CbSize==log2RRUSize, it is desirable to decode the residual mode rru_flag. In other words, SYN1404′ may be used instead of SYN1404.

if(cqtDepth==rruDepth) SYN1404

if(Log2CbSize==Log2RRUSize) SYN1404′

Note that log2RRUSize is the size of the block in which to decode the residual mode. For example, 5 to 8 indicating from 32×32 to 256×256 or the like is appropriate. A configuration that includes the size log2RRUSize of the block in which to decode the residual mode in the coded data and decodes in the parameter set or the slice header is also acceptable.

In the above configuration, an effect of enabling prediction and transform at block sizes with a high degree of freedom is exhibited even in regions where the configuration of the residual is changed by the residual mode rru_flag. Also, in the case of decoding the residual mode rru_flag only in a specific layer, an effect of decreasing the overhead of the residual mode is exhibited.

Note that, as already described, the CU information decoding section 11 of the present configuration that decodes the residual mode in the CT layer may also use the process in S1411A described already in FIG. 23 (corresponding to SYN1411A in FIG. 23) instead of the process in S1411.

<P4b: Configuration of CT Layer Residual Mode>

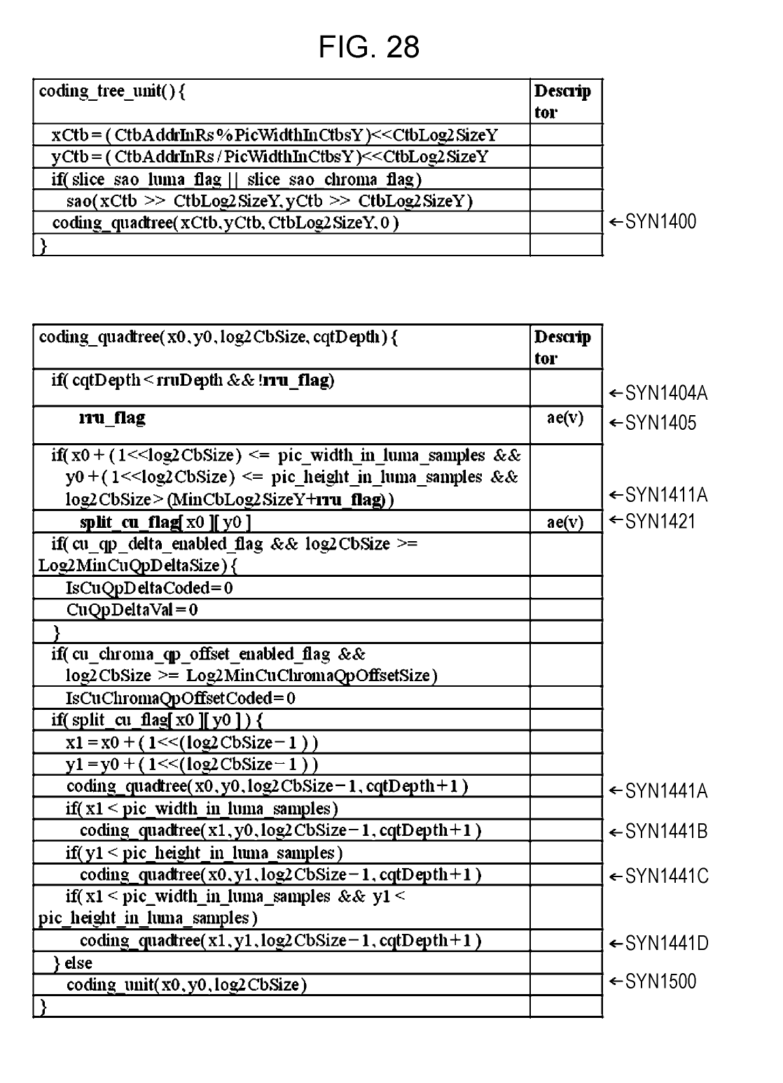

FIG. 28 is a diagram illustrating another exemplary configuration of a syntax table at the coding tree level. In this configuration, as illustrated by SYN1404A, the residual mode decoding section included in the CU information decoding section 11 decodes the residual mode rru_flag in the case in which the CT layer cqtDepth satisfies a specific condition, such as when the CT layer cqtDepth is less than a predetermined layer rruDepth, for example. Note that, as indicated by the !rru_flag condition in SYN1404A, in the case in which the residual mode rru_flag has already been decoded to be the second mode (!=0) in a higher layer, it is desirable to skip the decoding of the residual mode rru_flag (keep the value at 1). For example, in the case in which the predetermined layer rruDepth is a 64×64 block layer, the residual mode rru_flag is decoded in the case in which the CU size is 64×64.

Note that decoding the residual mode rru_flag in the case in which the CT layer cqtDepth is less than the predetermined layer rruDepth means that the residual mode is decoded only in the case in which the size of the coding tree is comparatively large and the layer of the coding tree is small. For this reason, the coding tree CT size (CU size) may also be used instead of the CT layer cqtDepth.

Like the formula below, in the case in which the logarithm of the CT size log2CbSize==log2RRUSize, it is desirable to decode the residual mode rru_flag. In other words, SYN1404A′ may be used instead of SYN1404A.

if(cqtDepth<rruDepth &&!Rru_Flag) SYN1404A

if(Log2CbSize<Log2RRUSize &&!Rru_Flag) SYN1404A′

In the above configuration, an effect of enabling prediction and transform at block sizes with a high degree of freedom is exhibited even in regions where the configuration of the residual is changed by the residual mode rru_flag. Also, an effect of decreasing the overhead of the residual mode is exhibited at the same time.

<P4c: Configuration of CU Layer Residual Mode>

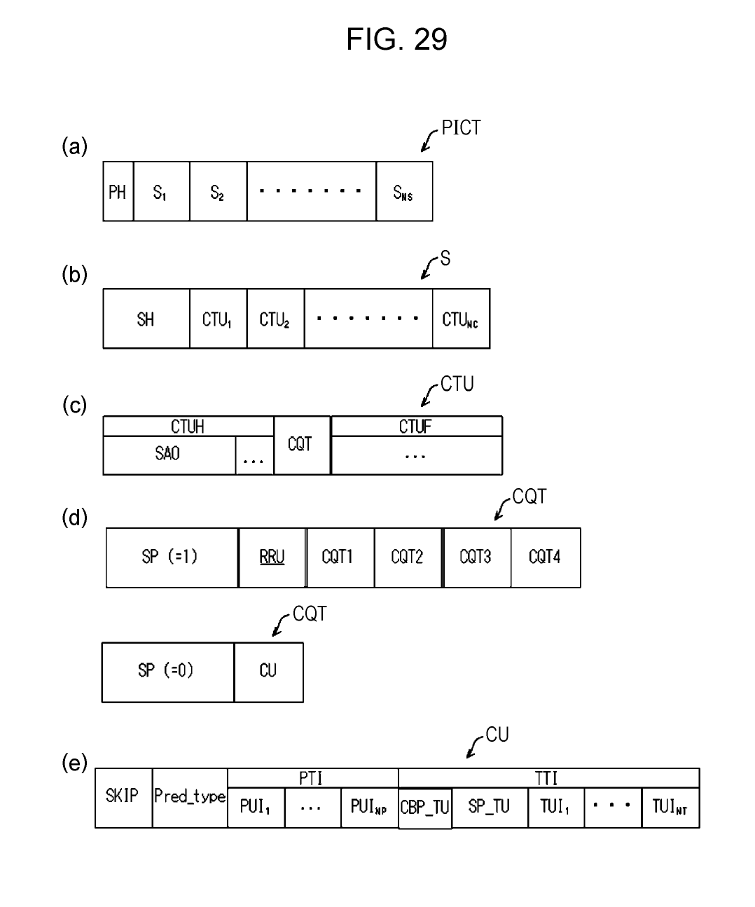

Hereinafter, one configuration of the video image decoding device 1 will be described using FIGS. 29 to 31.

FIG. 29 is a diagram illustrating the data structure of coded data generated by the video image coding device according to an embodiment of the present invention, and decoded by the above video image decoding device. As illustrated in FIG. 29(d), the video image decoding device 1 decodes the residual mode RRU (rru_flag) included in the CT layer in the case in which the CU partitioning flag SP is 1 in the coded data #1.

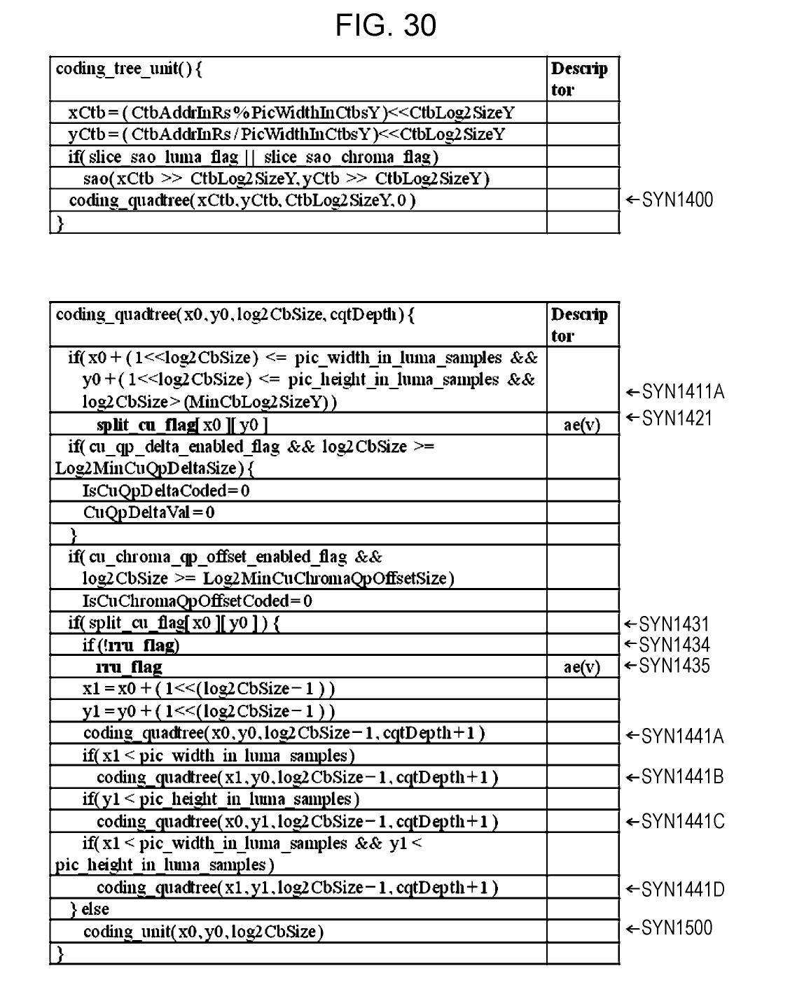

FIG. 30 is a diagram illustrating an exemplary configuration of a CU information syntax table according to an embodiment of the present invention.

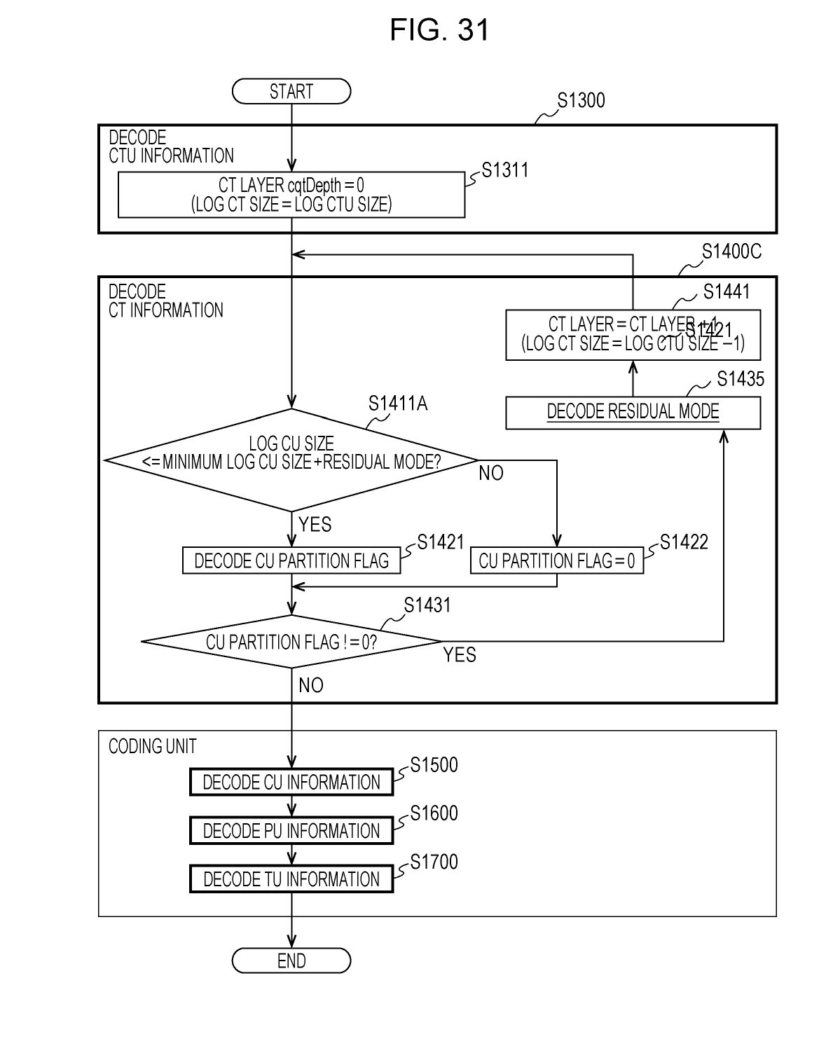

FIG. 31 is a flowchart explaining the schematic operation of the CU information decoding section 11 (CTU information decoding S1300, CT information decoding S1400C) according to an embodiment of the invention.

Compared to the process in S1400 already described using FIG. 6, the process of the CU information decoding section 11 differs in that the residual mode decoding process illustrated in S1435 has been added to the CU information decoding.

(S1435) In the case in which the CU partitioning flag split_cu_flag is 1 (S1431, SYN1431), the CU information decoding section 11 decodes the syntax element labeled SYN1435, namely, the residual mode rru_flag.

Unlike S1305, the operation in S1435 can decode the residual mode rru_flag even in layers lower than the highest-layer coding tree (CTB).

Note that, as indicated by the !rru_flag condition in SYN1434, in the case in which the residual mode rru_flag has already been decoded once to be the second mode (!=0) in a higher layer, it is desirable to skip the decoding of the residual mode rru_flag, and keep the target block in the second mode. Assume that the residual mode rru_flag is initialized to 0 until decoded in the target block or a higher layer of the target block.

In the above configuration, an effect of enabling prediction and transform at block sizes with a high degree of freedom is exhibited even in regions where the configuration of the residual is changed by the residual mode rru_flag.

Also, in the case of decoding the residual mode rru_flag only in a specific layer, an effect of decreasing the overhead of the residual mode is exhibited.

Note that the CU information decoding section 11 of this configuration may also use the process in S1411A described above and illustrated in FIG. 23 described already instead of the process in S1411.

In a configuration that uses S1411A, an additional effect is exhibited whereby the block size is prevented from becoming too small by over-partitioning. Also, in the case in which the residual mode rru_flag is the second mode (!=0), compared to the case in which the residual mode rru_flag is the first mode (=0), partitioning is conducted down to only one fewer layer (the CU partitioning flag is not decoded), and thus an effect of decreasing the overhead related to the CU partitioning flag is exhibited.

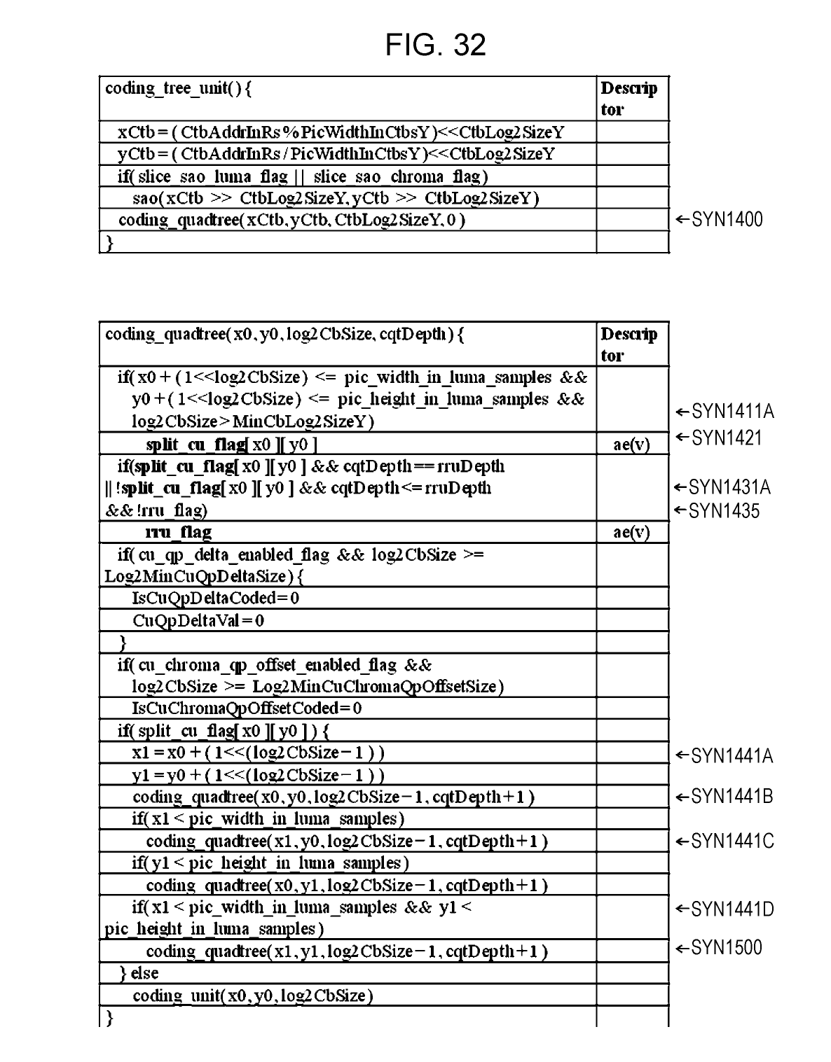

FIG. 32 is a diagram illustrating another exemplary configuration of a syntax table at the coding tree level. In this configuration, as illustrated by SYN1434A, it is desirable to decode the residual mode rru_flag in the case in which the CU partitioning flag split_cu_flag and the CT layer cqtDepth satisfy a predetermined condition. For example, in the case in which the CU partitioning flag split_cu_flag is 1 (the case of partitioning into a small CU), if the CT layer cqtDepth is the predetermined layer rruDepth, the residual mode rru_flag is decoded. In the case in which the CU partitioning flag split_cu_flag is 0 (the case of not partitioning into a small CU), if the CT layer cqtDepth is less than the predetermined layer rruDepth, the residual mode rru_flag is decoded. Otherwise, the decoding of the residual mode rru_flag is skipped. In the case of skipping the decoding of the residual mode rru_flag, if the residual mode rru_flag has already been decoded in the CT of a higher layer, the value of that residual mode is used. Otherwise, the value of the residual mode rru_flag is taken to be 0.

For example, in the case in which the predetermined layer rruDepth is a 64×64 block layer, the residual mode rru_flag is decoded in the case in which the CU size is 64×64 and additionally in the case of partitioning the CU (32×32). At the same time, even in the case of not partitioning the CU, the residual mode rru_flag is decoded if the CU size is 64×64 or greater.

<P4c: Configuration of CU Layer Residual Mode>

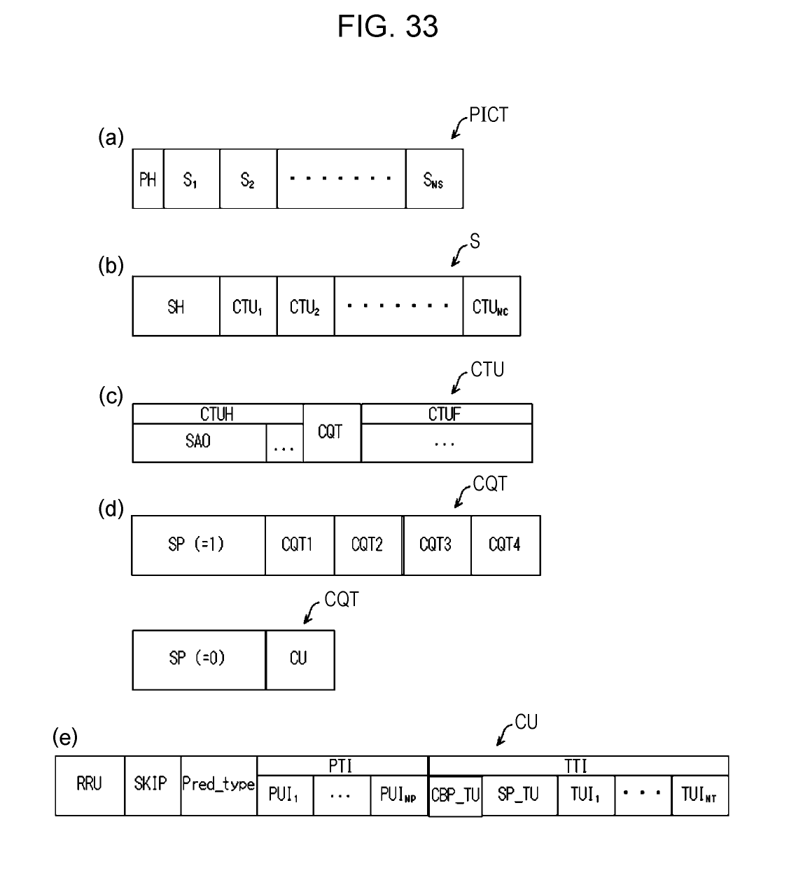

Hereinafter, one configuration of the video image decoding device 1 will be described using FIGS. 33 to 35.

FIG. 33 is a diagram illustrating the data structure of coded data generated by the video image coding device according to an embodiment of the present invention, and decoded by the above video image decoding device. As illustrated in FIG. 33(e), the video image decoding device 1 decodes the residual mode rru_flag included in the CU layer in the coded data #1.

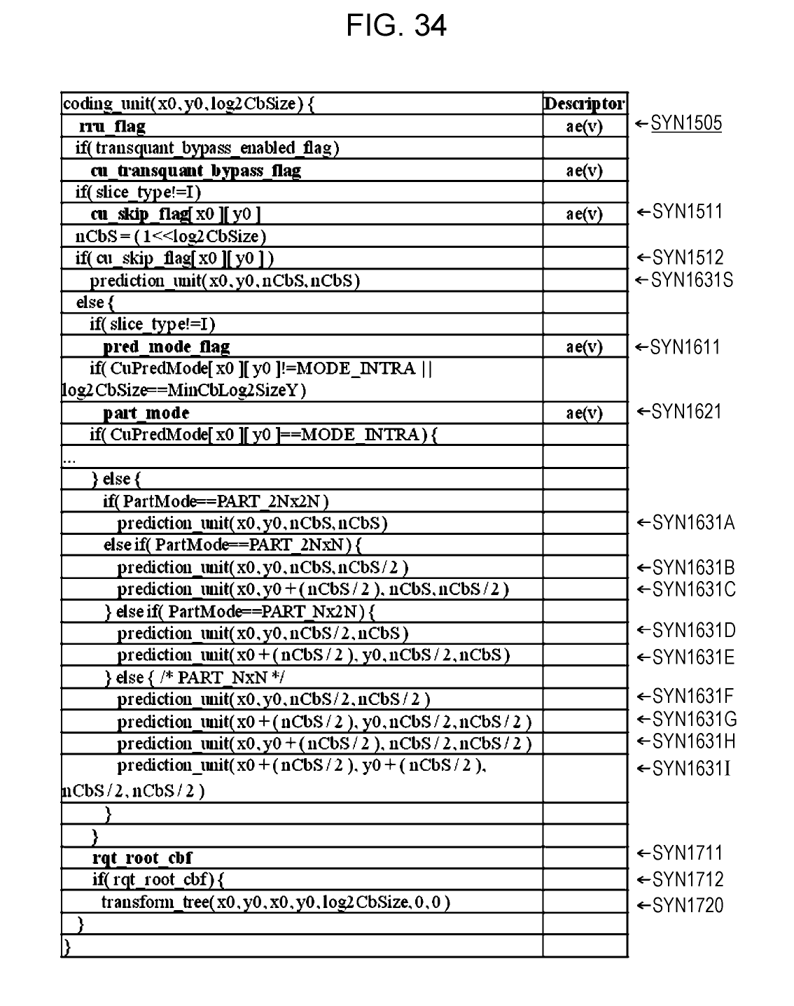

FIG. 34 is a diagram illustrating an exemplary configuration of a CU information, PT information PTI, and TT information TTI syntax table according to an embodiment of the present invention.

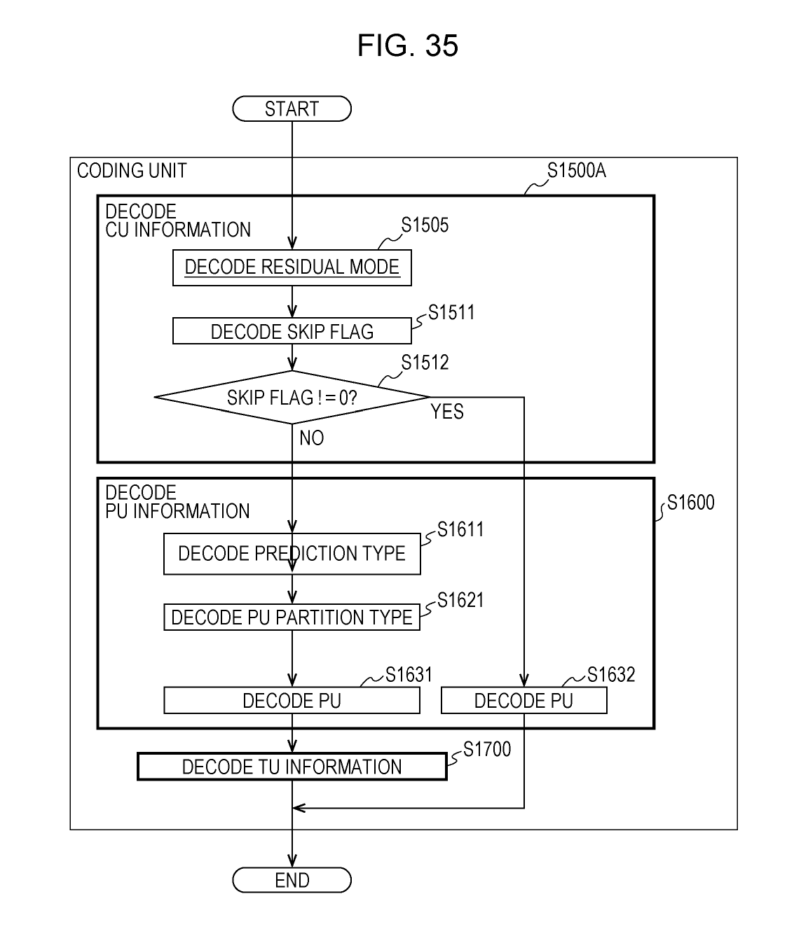

FIG. 35 is a flowchart explaining the schematic operation of the CU information decoding section 11 (CU information decoding S1500A), the PU information decoding section 12 (PU information decoding S1600), and the TU information decoding section 13 (TT information decoding S1700) according to an embodiment of the invention.

This differs from the CU information decoding section 11 already described using FIG. 6 in that a process of decoding the residual mode rru_flag in S1505 has been added.

(S1505) The CU information decoding section 11 decodes the syntax element labeled SYN1505, namely the residual mode rru_flag.

Unlike S1305, the operation in S1505 can decode the residual mode rru_flag in the coding unit CU which is the lowest-layer coding tree.

In the above configuration, an effect of enabling prediction and transform at block sizes with a high degree of freedom using quadtree is exhibited even in regions where the configuration of the residual is changed by the residual mode rru_flag. Also, since the residual mode rru_flag can be switched in each coding tree (CT), an effect of enabling a configuration with an even higher degree of freedom than the case of switching in the CTU is exhibited.

<P4c: Configuration of CU Layer Residual Mode>

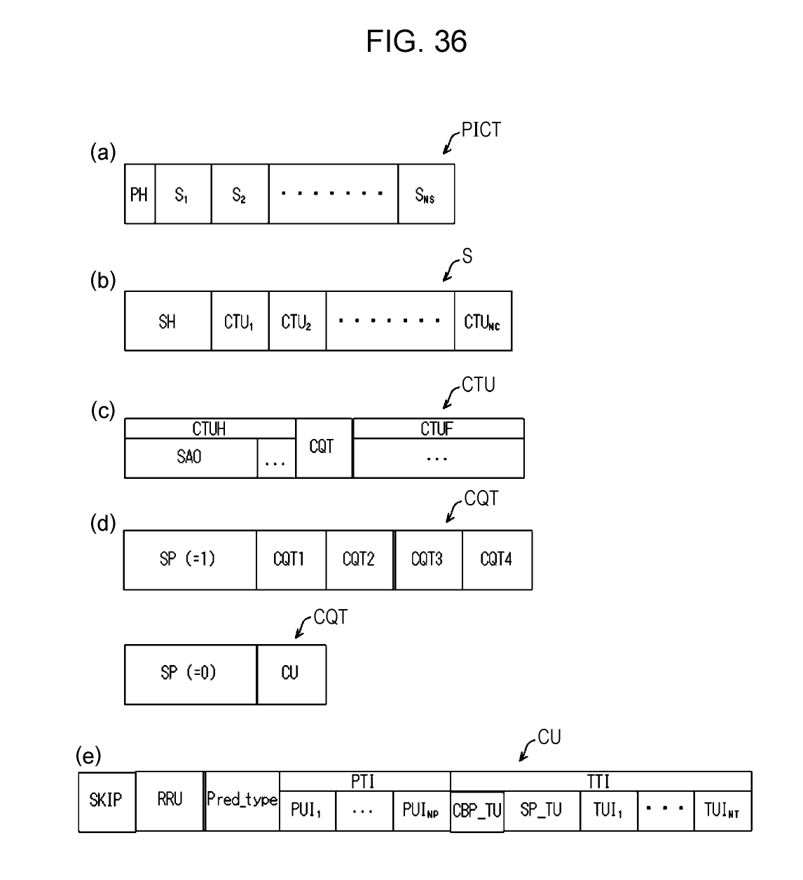

Hereinafter, one configuration of the video image decoding device 1 will be described using FIGS. 36 to 38.

FIG. 36 is a diagram illustrating the data structure of coded data generated by the video image coding device according to an embodiment of the present invention, and decoded by the above video image decoding device. As illustrated in FIG. 36(e), the video image decoding device 1 decodes the residual mode rru_flag positioned after the skip flag SKIP included in the CU layer in the coded data #1.

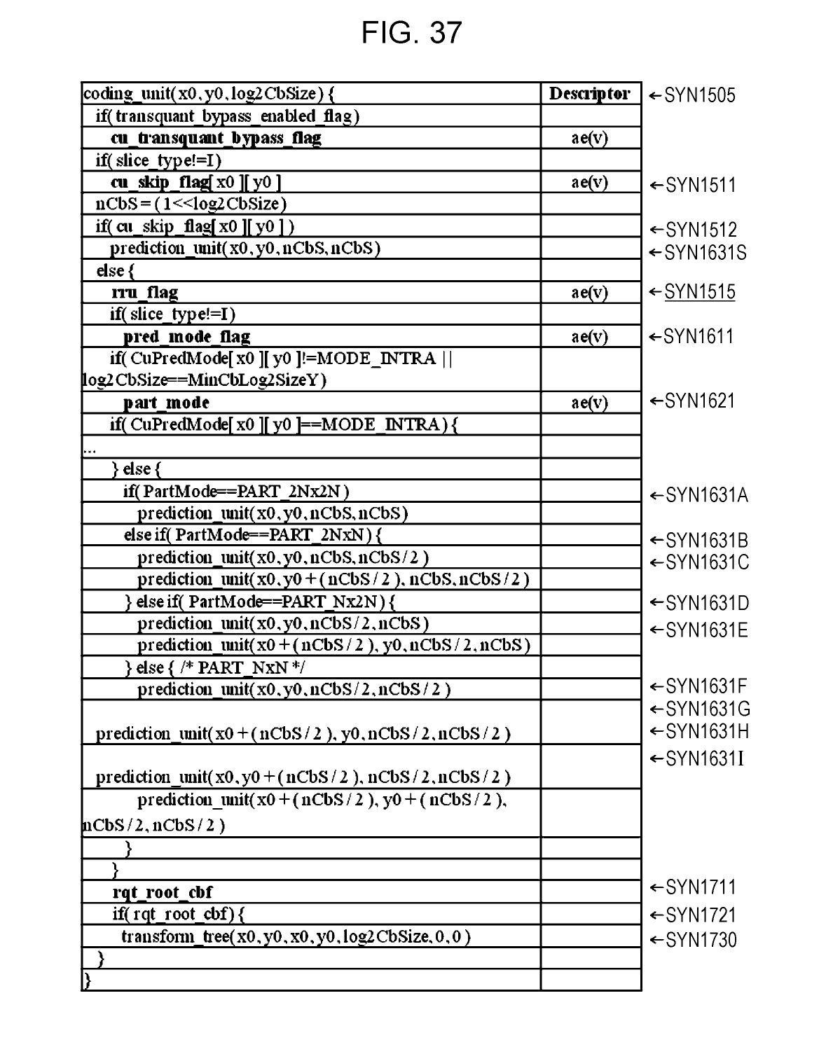

FIG. 37 is a diagram illustrating an exemplary configuration of a CU information, PT information PTI, and TT information TTI syntax table according to an embodiment of the present invention.

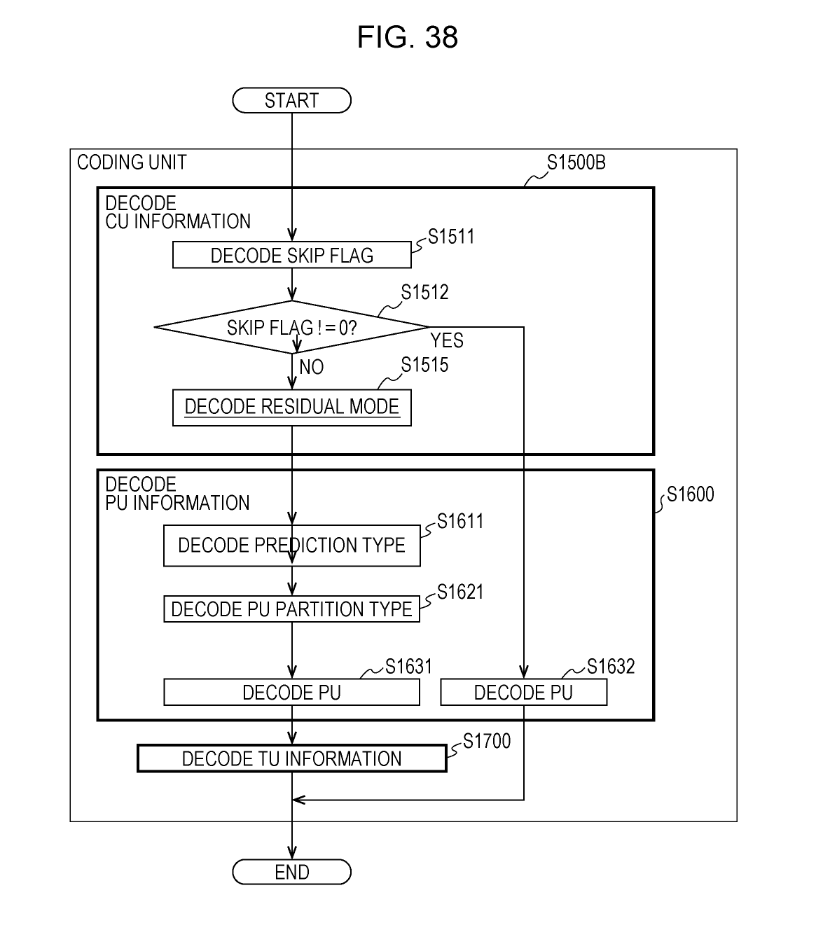

FIG. 38 is a flowchart explaining the schematic operation of the CU information decoding section 11 (CU information decoding S1500B), the PU information decoding section 12 (PU information decoding S1600), and the TU information decoding section 13 (TU information decoding S1700) according to an embodiment of the invention.

This differs from the CU information decoding section 11 already described using FIG. 6 in that a process of decoding the residual mode rru_flag in S1515 has been added.

(S1515) In the case in which the skip flag is 1 (S1512, SYN1512), the CU information decoding section 11 decodes the syntax element labeled SYN1515, namely, the residual mode rru_flag. Otherwise (skip flag=0), the CU information decoding section 11 skips the residual mode rru_flag, and derives 0, which indicates that the residual mode is the first mode.

Unlike S1305, the operation in S1515 can decode the residual mode rru_flag in the coding unit CU which is the lowest-layer coding tree.

In the above configuration, an effect of enabling quadtree partitioning with a high degree of freedom is exhibited even in the case of changing the configuration of the residual by the residual mode rru_flag. Also, since the residual mode rru_flag can be switched in each coding unit, an effect of enabling a configuration with a high degree of freedom is exhibited.

Furthermore, in the above configuration, the residual mode rru_flag is decoded as long as the mode is not the skip mode that skips the residual (a mode with a possibility of coding the residual), whereas the decoding of the residual mode rru_flag is skipped in the case in which the skip mode is 1 and no residual exists. For this reason, an effect of decreasing the overhead of the residual mode is exhibited.

<P4d: Configuration of TU Layer Residual Mode>

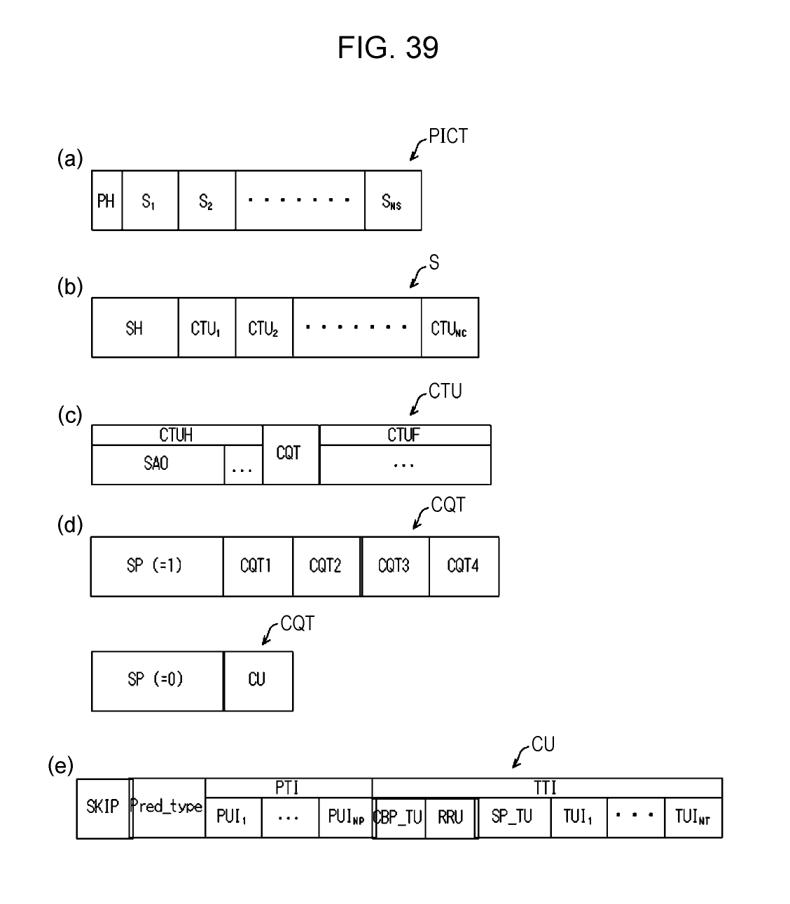

Hereinafter, one configuration of the video image decoding device 1 will be described using FIGS. 39 to 41.

FIG. 39 is a diagram illustrating the data structure of coded data generated by the video image coding device according to an embodiment of the present invention, and decoded by the above video image decoding device. As illustrated in FIG. 39(e), the video image decoding device 1 decodes the residual mode rru_flag positioned after the CU residual flag CBP_TU included in the TU layer in the coded data #1.

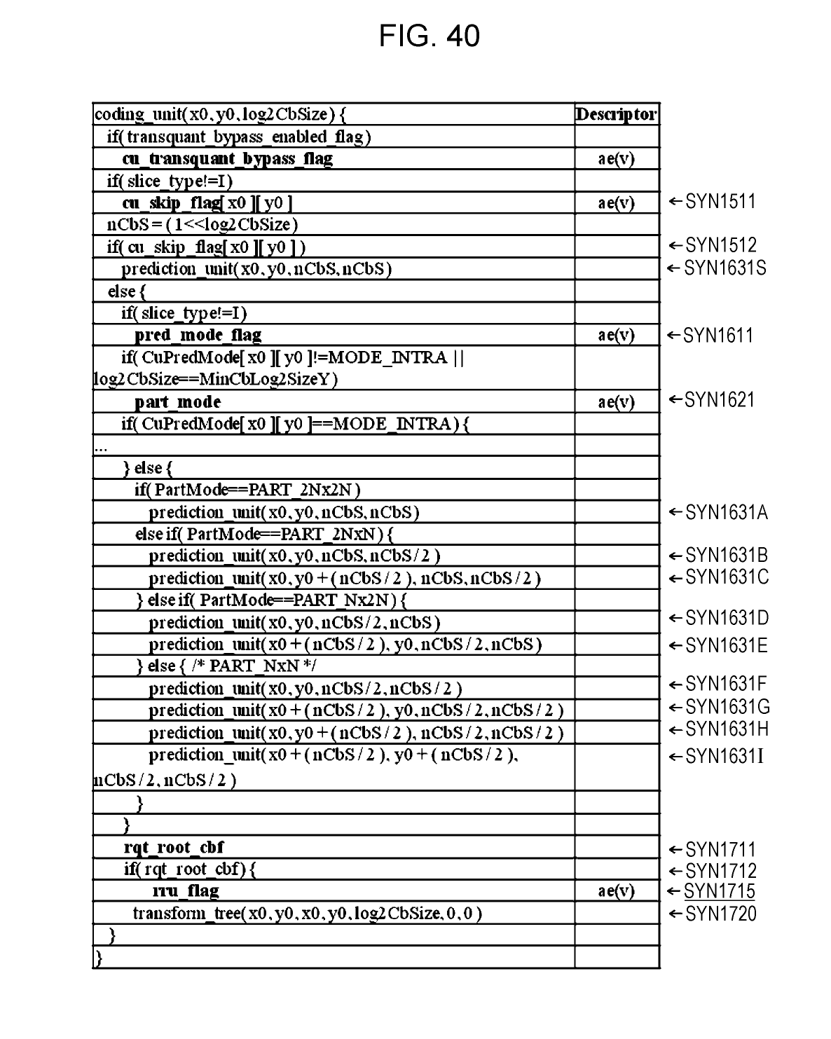

FIG. 40 is a diagram illustrating an exemplary configuration of a transform tree information TTI syntax table according to an embodiment of the present invention.

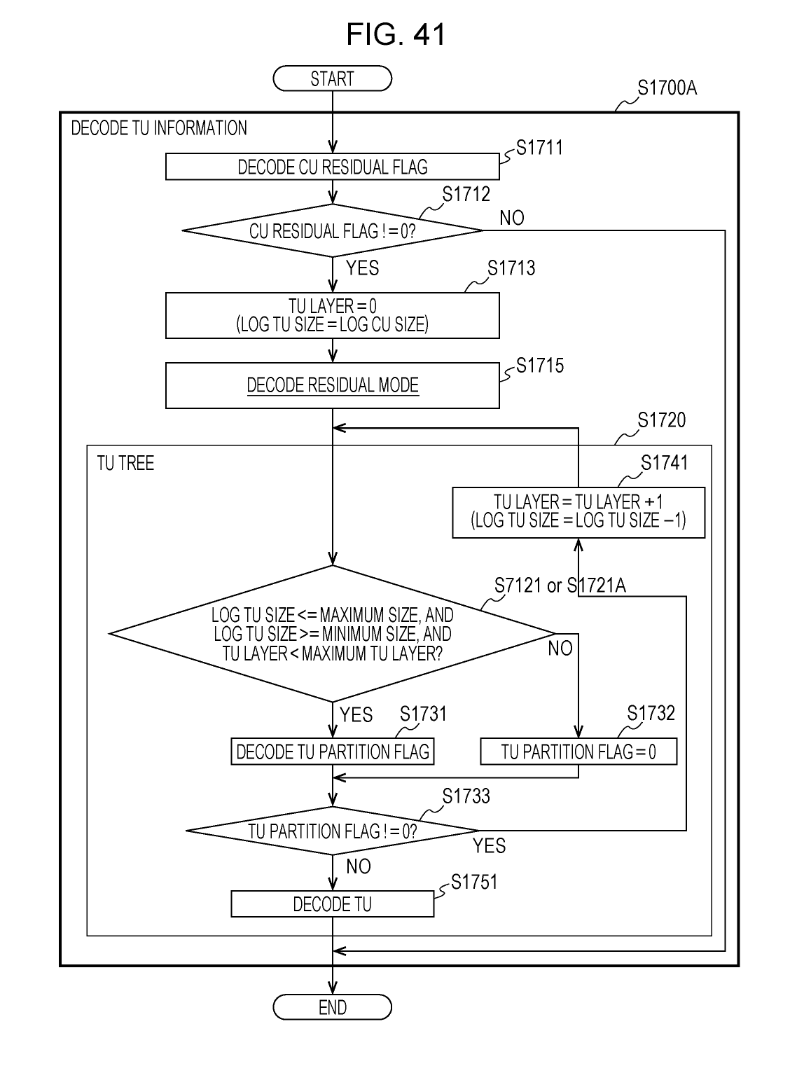

FIG. 41 is a flowchart explaining the schematic operation of the TU information decoding section 13 (TU information decoding S1700A) according to an embodiment of the invention.

This differs from the CU information decoding section 11 already described using FIG. 6 in that a process of decoding the residual mode rru_flag in S1715 has been added. In the present embodiment, the process in S1700 is replaced by the process in S1700A.

(S1715) In the case in which the CU residual flag rqt_root_cbf is non-zero (=1) (S1712, SYN1712), the TU information decoding section 11 decodes the syntax element labeled SYN1715, namely, the residual mode rru_flag. Otherwise (skip flag=0), the CU information decoding section 11 skips the residual mode rru_flag, and derives 0, which indicates that the residual mode is the first mode.

Unlike S1700, the operation in S1700A can decode the residual mode rru_flag in the coding unit CU which is the lowest-layer (leaf) coding tree not partitioned any further (S1715).

In the above configuration, an effect of enabling quadtree partitioning with a high degree of freedom is exhibited even in the case of changing the configuration of the residual by the residual mode rru_flag. Also, since the residual mode rru_flag can be switched in each coding unit, an effect of enabling a configuration with a high degree of freedom is exhibited.

Furthermore, in the above configuration, since the residual mode rru_flag is decoded as long as a residual (prediction quantization residual) exists in the CU (the case in which the CU residual flag is non-zero), and the decoding of the residual mode flag rru_flag is skipped in the case in which a residual does not exist in the CU (the case in which the CU residual flag is 0), an effect of decreasing the overhead of the residual mode is exhibited.

<<P5: Limitations of Flag Decoding According to Residual Mode>>

### <P5a: Limitations of PU Partitioning Flag Decoding According to Residual Mode>

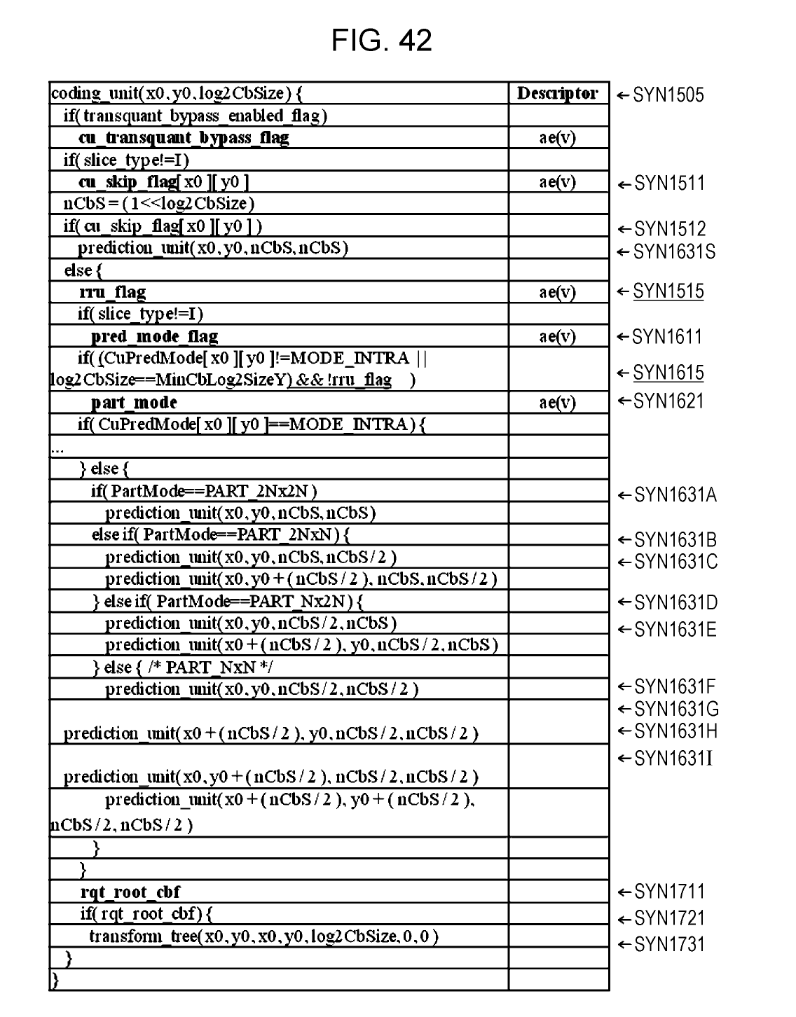

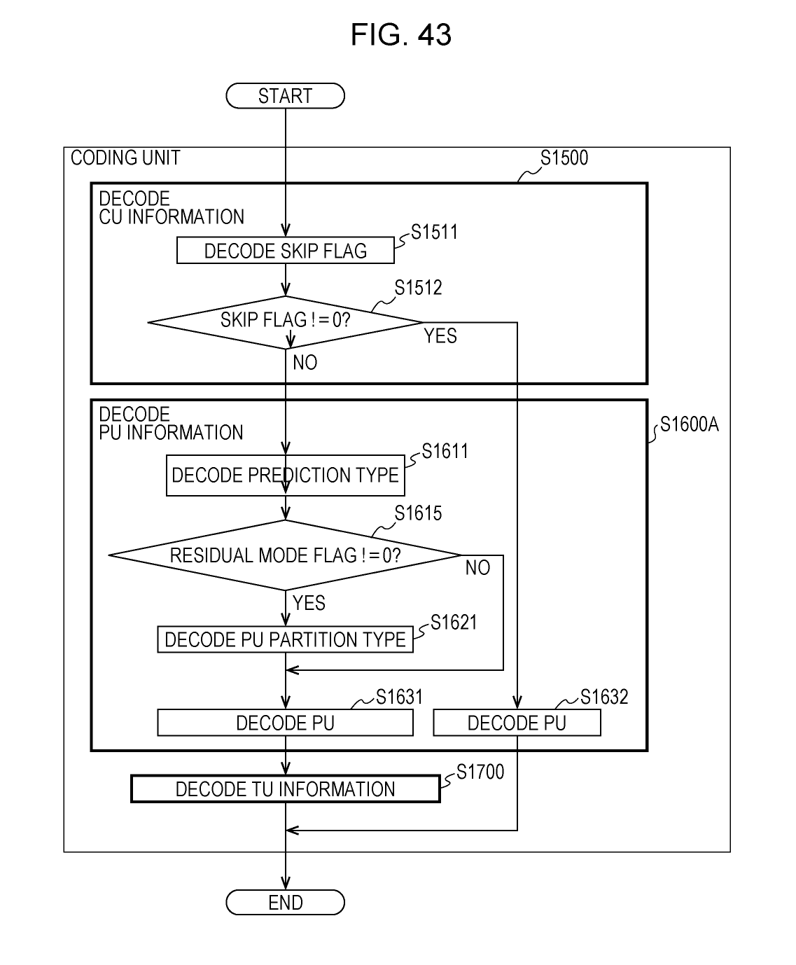

Hereinafter, one configuration of the video image decoding device 1 will be described using FIGS. 42 to 43.

FIG. 42 is a diagram illustrating an exemplary configuration of a CU information, PT information PTI, and TT information TTI syntax table according to an embodiment of the present invention.

FIG. 43 is a flowchart explaining the schematic operation of the CU information decoding section 11 (CU information decoding S1500), the PU information decoding section 12 (PU information decoding S1600), and the TU information decoding section 13 (TU information decoding S1700) according to an embodiment of the invention.

S1611 The PU information decoding section 12 decodes the prediction type Pred_type (CuPredMode, syntax element pred_mode_flag) from the coded data #1.

S1615 A PU partitioning mode decoding section provided in the PU information decoding section 12 decodes the PU partition type Pred_type only in the case in which the residual mode rru_flag is the first mode (=0) (S1621). Otherwise, the decoding of the PU partition type Pred_type is skipped, and a value indicating not to partition the prediction block (2N×2N) is derived as the PU partition type.

More specifically, as illustrated by SYN1615 in FIG. 42, in the case in which the prediction type CuPredMode is other than intra (MODE_INTRA), or the logarithm of the CT size log2CbSize is the logarithm of the minimum CT size MinCbLog2SizeY, and the residual mode rru_flag is 0 (=!rru_flag), the PU partition type is decoded from the coded data #1 (S1621). Otherwise, the decoding of the PU partition type is skipped, as a value indicating not to partition the prediction block (2N×2N) is derived as the PU partition type.

The above image decoding device is provided with the PU information decoding section 12 (PU partitioning mode decoding section) that decodes the PU partitioning mode indicating whether or not to partition the coding unit further into prediction blocks (PUs). In the case in which the residual mode indicates the “second mode”, the PU partitioning mode decoding section skips the decoding of the above PU partitioning mode, whereas in the case in which the above residual mode indicates the “first mode”, the PU partitioning mode decoding section decodes the above PU partitioning mode. In the case in which the residual mode indicates the “second mode”, or in other words, in the case in which the decoding of the PU partitioning mode is skipped, the PU information decoding section 12 derives a value indicating not to perform PU partitioning (2N×2N).

In the above configuration, since the PU partitioning mode is decoded only in the case in which the residual mode rru_flag is the first mode (=0), and the decoding of the PU partitioning mode is skipped in the case in which the residual mode rru_flag is the second mode (!=0), an effect of decreasing the overhead of the PU partitioning mode is exhibited.

<P5a: Limitations of PU Partitioning Flag Decoding According to Residual Mode>

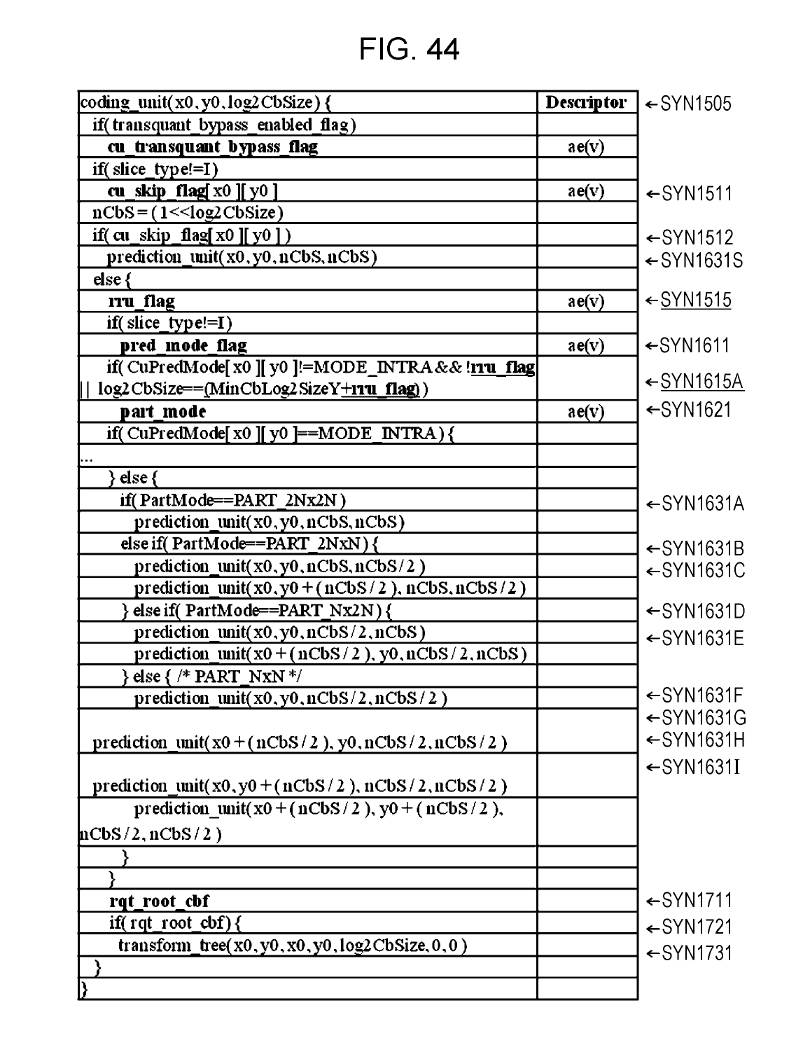

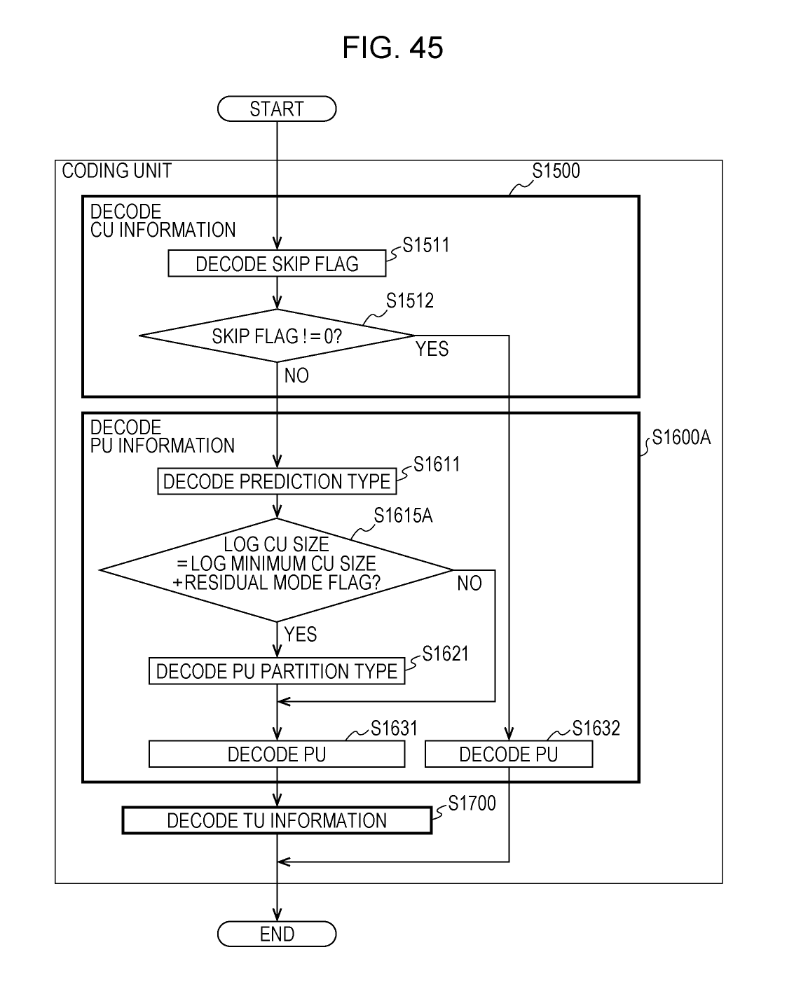

Hereinafter, one configuration of the video image decoding device 1 will be described using FIGS. 44 to 45.

FIG. 44 is a diagram illustrating an exemplary configuration of a CU information, PT information PTI, and TT information TTI syntax table according to an embodiment of the present invention.

FIG. 45 is a flowchart explaining the schematic operation of the CU information decoding section 11 (CU information decoding S1500), the PU information decoding section 12 (PU information decoding S1600A), and the TU information decoding section 13 (TU information decoding S1700) according to an embodiment of the invention.

(S1615A) The PU partitioning mode decoding section provided in the PU information decoding section 12 decodes the PU partition type only in the case in which the residual mode rru_flag is the first mode (=0) (S1621). Otherwise, the decoding of the PU partition type is skipped, and 2N×2N indicating not to partition is derived as the PU partition type.

More specifically, as illustrated by SYN1615A, in the case in which the prediction type CuPredMode is intra (MODE_INTRA) and the residual mode rru_flag is the first mode (=0) (=!rru_flag), or the logarithm of the CT size log2CbSize is equal to the logarithm of the minimum CT size MinCbLog2SizeY plus the residual mode (log2CBSize==MinCbLog2SizeY+rru_flag), the PU partition type is decoded from the coded data #1 (S1621). Otherwise, the decoding of the PU partition type is skipped, and the value 2N×2N(=0) indicating not to partition the prediction block is derived as the PU partition type.

Note that the case in which the logarithm of the CT size log2CbSize is the logarithm of the minimum CT size MinCbLog2SizeY plus the residual mode rru_flag is equivalent to determining whether or not the logarithm of the CT size log2CbSize is the logarithm of the minimum CT size MinCbLog2SizeY in the case in which the residual mode rru_flag is the first mode (=0), and determining whether or not the logarithm of the CT size log2CbSize is the logarithm of the minimum CT size MinCbLog2SizeY+1 in the case in which the residual mode rru_flag is the second mode (!=0).

The above image decoding device is provided with the PU partitioning mode decoding section that decodes the PU partitioning mode indicating whether or not to partition the coding unit further into prediction blocks (PUs). In the case in which the residual mode indicates the “second mode”, the PU partitioning mode decoding section skips the decoding of the above PU partitioning mode and derives a value indicating not to perform PU partitioning (2N×2N), whereas in the case in which the above residual mode indicates the “first mode”, the PU partitioning mode decoding section decodes the above PU partitioning mode.

Furthermore, in the above configuration, since the PU partitioning mode is decoded only in the case in which the residual mode rru_flag is the first mode (=0), and the decoding of the PU partitioning mode is skipped in the case in which the residual mode rru_flag is the second mode (!=0), an effect of decreasing the overhead of the PU partitioning mode is exhibited.

<P5b: TU Partitioning Flag Decoding Limitation C According to Residual Mode>

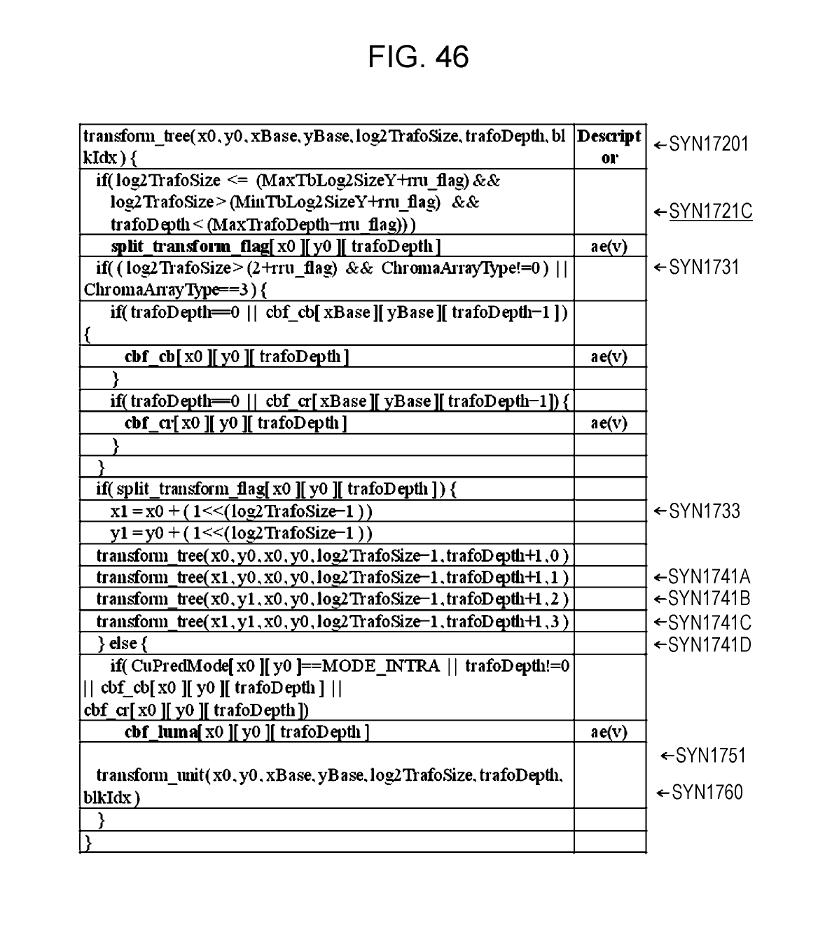

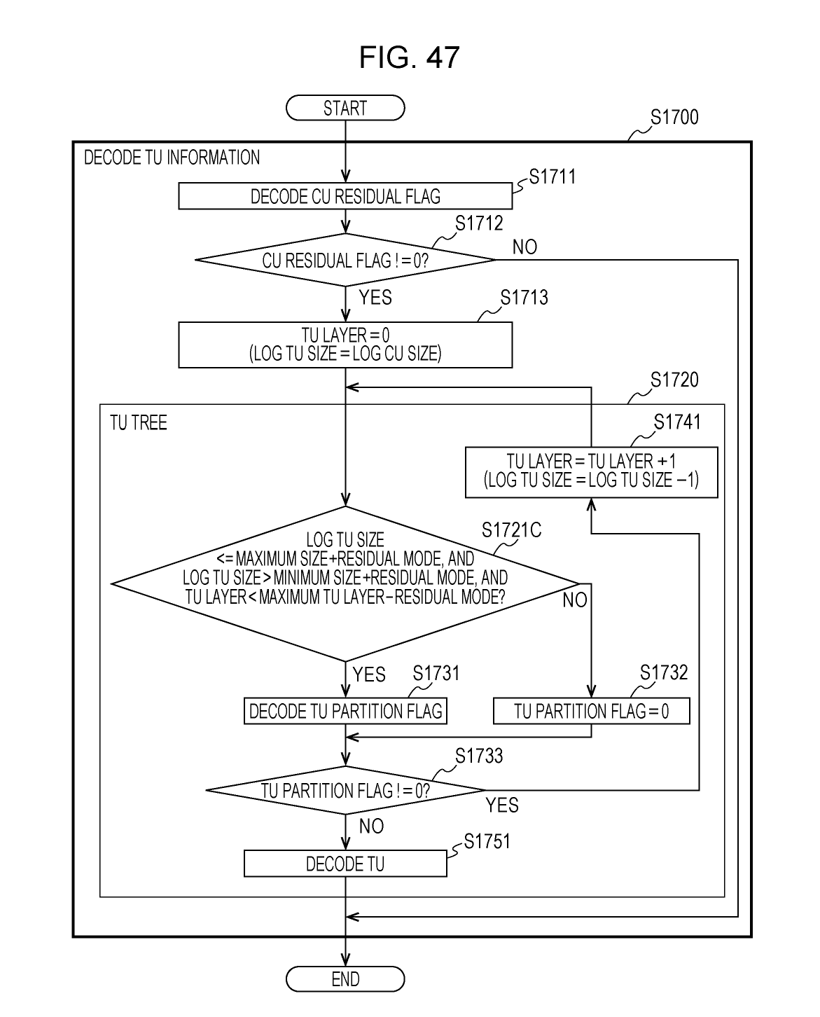

Hereinafter, one configuration of the video image decoding device 1 will be described using FIGS. 46 to 47. FIG. 46 is a diagram illustrating an exemplary configuration of a TT information TTI syntax table according to an embodiment of the present invention. FIG. 47 is a flowchart explaining the schematic operation of the TU information decoding section 13 (TU information decoding 1700C) according to an embodiment of the invention.

The TU partitioning flag decoding section included in the TU information decoding section 13 decodes a TU partitioning flag (split_transform_flag) in the case in which the target TU size is within a predetermined transform size range, or the layer of the target TU is less than a predetermined layer. More specifically, as illustrated by SYN1721C in FIG. 46, in the case in which the logarithm of the TU size log2TrafoSize<=the sum of the maximum TU size MaxTbLog2SizeY and the residual mode (MaxTbLog2SizeY+residual mode rru_flag), and the logarithm of the TU size log2TrafoSize>the sum of the minimum TU size MinTbLog2SizeY and the residual mode (MaxTbLog2SizeY+residual mode rru_flag), and the TU layer trafoDepth<the difference between the maximum TU layer MaxTrafoDepth and the residual mode (MaxTrafoDepth−residual mode rru_flag), the TU partitioning flag (split_transform_flag) is decoded (S1731). Otherwise, that is, in the case in which split_transform_flag does not appear in the coded data, the decoding of the TU partitioning flag is skipped, and the TU partitioning flag split_transform_flag is derived as 1 in the case in which the logarithm of the TU size log2TrafoSize is greater than the maximum TU size MaxTbLog2SizeY+the residual mode rru_flag, otherwise (when the logarithm of the TU size log2TrafoSize is equal to the sum of the minimum TU size MaxTbLog2SizeY and the residual mode (MaxTbLog2SizeY+residual mode rru_flag) or when the TU layer trafoDepth is equal to the difference between the maximum TU layer and the residual mode (MaxTrafoDepth−residual mode rru_flag)), the TU partitioning flag split_transform_flag is derived as 0, which indicates not to partition (S1732).

This configuration is a configuration combining a TU partitioning flag decoding limitation A according to residual mode and a TU partitioning flag decoding limitation B according to residual mode described later, and exhibits the effects of the limitation A and the effects of the limitation B.

<P5b: TU Partitioning Flag Decoding Limitation C According to Residual Mode>

Note that in the above, the TU information decoding section 13 according to an embodiment of the invention decodes the TU partitioning flag (split_transform_flag) according to the condition labeled SYN1721C in FIG. 46 (=S1721C in FIG. 47). In other words, the logarithm of the target TU size log2TrafoSize and the TU layer trafoDepth are both used to decode the TU partitioning flag (split_transform_flag), but a conditional determination using the target TU size log2TrafoSize as illustrated in S1721A below may also be performed.

log2TrafoSize<=(MaxTbLog2SizeY+rru_flag)&& log2TrafoSize<(MinTbLog2SizeY+rru_flag) (S1721A)

In this configuration, there is provided a TU information decoding section 13 (TU partitioning mode decoding section) that decodes the TU partitioning mode indicating whether or not to partition the coding unit further into transform blocks (TUs). In the case in which the above residual mode indicates the “second mode”, the above TU partitioning mode decoding section decodes the above TU partitioning flag (split_transform_flag) when the coding block size log2CbSize is less than or equal to the maximum transform block MaxTbLog2SizeY+1 and greater than the minimum transform block MinCbLog2Size+1. In the case in which the above residual mode indicates the “first mode”, the above TU partitioning mode decoding section decodes the above TU partitioning flag (split_transform_flag) when the coding block size log2CbSize is less than or equal to the maximum transform block MaxTbLog2SizeY and greater than the minimum transform block MinCbLog2Size. Otherwise (in the case in which the coding block size log2CbSize is greater than the maximum transform block MaxTbLog2SizeY, or less than or equal to the minimum transform block MinCbLog2Size), the decoding of the above TU partitioning flag (split_transform_flag) is skipped, and a value indicating not to partition is derived.

In other words, in the case in which the residual mode rru_flag is the first mode, namely 0, the normal maximum TU size MaxTbLog2SizeY (maximum size of the transform block) and minimum TU size MinTbLog2SizeY (minimum size of the transform block) are used, whereas in the case in which the residual mode rru_flag is the second mode, namely 1, the sum of the normal maximum TU size MaxTbLog2SizeY and 1 (MaxTbLog2SizeY+1) is used as the maximum size, while the sum of the normal minimum TU size MinTbLog2SizeY and 1 (MinTbLog2SizeY+1) is used as the minimum TU size. This is a process corresponding to decoding the quantized prediction residual not of the target TU size (nTbS×nTb) but of ½ the size of the target TU size (nTbS/2×nTb/2), for example, as the quantized prediction residual of the target TU (size is nTbS×nTbS, where nTbS=1<<log2TrafoSize) in the case in which the residual mode is the second mode, namely non-zero (<<P1: TU information decoding according to residual mode>> described earlier).

For example, in the case in which the maximum size of the block to inversely transform (quantized prediction residual block) is 32×32 (MaxTbLog2SizeY=5), and the minimum size of the block to inversely transform is 4×4 (MaxTbLog2SizeY=2), the following process is performed in accordance with the residual mode rru_flag.

In the case in which the residual mode rru_flag is the first mode, namely 0, if the target TU size (logarithm of the TU size log2TrafoSize) is greater than the maximum size of 32×32 (MaxTbLog2SizeY=5), the decoding of the TU partitioning flag split_transform_flag is skipped and derived as 1, which indicates to partition. If the target TU size (logarithm of the TU size log2TrafoSize) is equal to the minimum size of 4×4 (MaxTbLog2SizeY=2), the decoding of the TU partitioning flag split_transform_flag is skipped and derived as 0, which indicates not to partition.

In the case in which the residual mode rru_flag is the second mode, namely non-zero, if ½ the target TU size (logarithm of the TU size log2TrafoSize−1) is greater than the maximum size of 32×32 (MaxTbLog2SizeY=5), the decoding of the TU partitioning flag split_transform_flag is skipped and derived as 1, which indicates to partition. If ½ the target TU size (logarithm of the TU size log2TrafoSize−1) is equal to the minimum size of 4×4 (MaxTbLog2SizeY=2), the decoding of the TU partitioning flag split_transform_flag is skipped and derived as 0, which indicates not to partition.

According to the above, an effect of keeping the size of the block to inversely transform from becoming too small in conjunction with the residual mode being the second mode is exhibited. With this arrangement, there is exhibited an effect of not using processing that has little meaning from the perspective of coding efficiency, in which the processing has become more complicated due to using a transform size (2×2 transform) that is smaller than necessary. Also, there is exhibited an effect of not implementing specialized small block prediction and small block transform because of the residual mode being the second mode.

<P5b: TU Partitioning Flag Decoding Limitation B According to Residual Mode>

Note that in the above, the TU information decoding section 13 according to an embodiment of the invention decodes the TU partitioning flag (split_transform_flag) according to the condition labeled SYN1721A in FIG. 46 (=S1721C in FIG. 47). In other words, the logarithm of the target TU size log2TrafoSize and the TU layer trafoDepth are both used to decode the TU partitioning flag (split_transform_flag), but a conditional determination using the target TU layer trafoDepth as illustrated in S1721B below may also be performed.

(S1721B) trafoDepth<(MaxTrafoDepth-rru_flag) In the above configuration, the above video image decoding device is provided with a TU partitioning mode decoding section that decodes the TU partitioning mode indicating whether or not to partition the coding unit further into transform blocks (TUs). In the case in which the above residual mode indicates the “second mode”, the above TU partitioning mode decoding section decodes the above TU partitioning flag split_transform_flag when the coding transform depth trafoDepth is less than the difference between the maximum coding depth MaxTrafoDepth and 1 (MaxTrafoDepth−1). In the case in which the above residual mode indicates the “first mode”, the above TU partitioning mode decoding section decodes the above TU partitioning flag split_transform_flag when the coding transform depth trafoDepth is less than the maximum coding depth MaxTrafoDepthY. Otherwise (in the case in which the residual mode is the “first mode” and the target TU layer trafoDepth is equal to or greater than the maximum coding depth MaxTrafoDepthY, or in the case in which the residual mode is the “second mode” and the target TU layer trafoDepth is equal to or greater than MaxTrafoDepthY+1), the decoding of the above TU partitioning flag (split_transform_flag) is skipped, and a value (2N×2N) indicating not to partition the transform block (TU) is derived.

According to the above, an effect of keeping the size of the block to inversely transform from becoming too small in conjunction with the residual mode being the second mode is exhibited.

### MODIFICATIONS

For the above limitation A, limitation B, and limitation C, the conditions of the following formulas additionally can be used.

log2TrafoSize<=(MaxTbLog2SizeY+(rru_flag?1:0))&& log2TrafoSize>(MinTbLog2SizeY+(rru_flag?2:0)) (S1721A″)

trafoDepth<(MaxTrafoDepth−(rru_flag?2:0)) (S1721B″)

log2TrafoSize<=(MaxTbLog2SizeY+(rru_flag?1:0))&& log2TrafoSize>(MinTbLog2SizeY+(rru_flag?2:0))&& trafoDepth<(MaxTrafoDepth−(rru_flag?2:0)) (S1721C″)

Note that in the above, the sum of the minimum transform block size MinCbLog2Size and 1 (MinCbLog2Size+1) is used in the case in which the residual mode is the second mode, but to further limit small blocks, the sum of the minimum transform block size MinCbLog2Size and 2 (MinCbLog2Size+2) may also be used in the case in which the residual mode is the second mode. More specifically, in the case in which the logarithm of the TU size log2TrafoSize<=the maximum TU size MaxTbLog2SizeY+(residual mode rru_flag?1:0), and the logarithm of the TU size log2TrafoSize>MinTbLog2SizeY+(residual mode rru_flag?2:0), and the TU layer trafoDepth<the maximum TU layer MaxTrafoDepth+residual mode rru_flag, the TU partitioning flag (split_transform_flag) is decoded (S1731). Otherwise, that is, in the case in which split_transform_flag does not appear in the coded data, the decoding of the TU partitioning flag is skipped, and the TU partitioning flag split_transform_flag is derived as 1 in the case in which the logarithm of the TU size log2TrafoSize is greater than the maximum size MaxTbLog2SizeY+(residual mode rru_flag?1:0), otherwise (when the logarithm of the TU size log2TrafoSize is equal to the minimum size MaxTbLog2SizeY+(residual mode rru_flag?2:0) or when the TU layer trafoDepth is equal to the maximum TU layer MaxTrafoDepth), the TU partitioning flag split_transform_flag is derived as 0, which indicates not to partition (S1732).

<<P6: Resolution Change at Slice Level>>

The foregoing describes an example of decoding the residual mode at the CTU level, but the residual mode may also be decoded at the slice level. Hereinafter, an example of decoding the residual mode at the CTU level will be described. The residual mode reduces the quantized prediction residual, and allows the image of a certain region to be coded at a lower code rate. Also, regions of the same size can be decoded with smaller transform blocks. Conversely, a larger region (for example, 128×128) than the original maximum size of the transform block (for example, 64×64) can be transformed. For this reason, the residual mode is effective for coding using large blocks. Thus, in the example below, the residual mode is treated as a resolution transform mode, and an image decoding device that changes the coding tree block size (maximum block size) according to the residual mode (hereinafter, the resolution transform mode) will be described.

<P6 Common: Per-Slice Residual Mode>

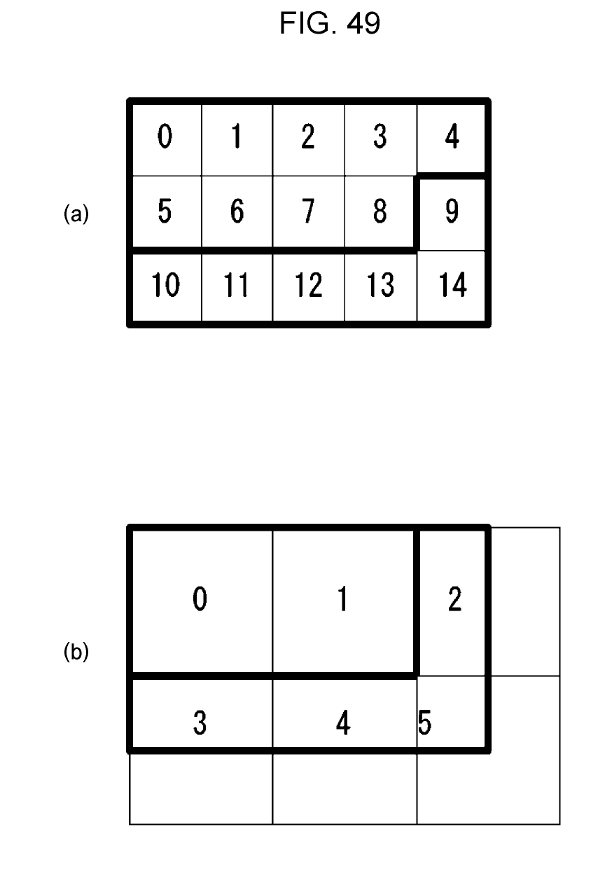

FIG. 49 is a diagram explaining a configuration that uses a different coding tree block (value of the residual mode) in units of pictures according to an embodiment of the present invention. The CU decoding section 11 of the video image coding device 1 of the present embodiment decodes the slice header at the beginning of slice from the coded data #1, and decodes the resolution transform mode (residual mode) defined in the slice header. Additionally, the CU decoding section 11 changes the size of the tree block (CTU) which is the highest-layer block that partitions the picture and slice, according to the resolution transform mode (residual mode). For example, the CTU size in the case in which the resolution transform mode (residual mode) is the first mode (=0) is taken to be double compared to the case in which the resolution transform mode (residual mode) is the first mode (=0). More specifically, the CU decoding section 11 decodes the resolution transform mode (residual mode) at the beginning of the slice, and in the case in which the resolution transform mode (residual mode) is the first mode (=0), decoding is performed using a decoded predetermined tree block size (CTU size) as the size (CTU size) of the tree block (CTU) which is the highest-layer block that partitions the picture and the slice, whereas in the case in which the residual mode is the second mode (=1), decoding is performed using double the tree block size (CTU size) of the decoded predetermined coding tree block size as the CTU size. As described already in P1: TU information decoding according to residual mode, in the case in which the residual mode rru_flag of the target slice is the first mode (=0), the TU information decoding section 13 decodes the quantized prediction residual of the size (TU size) of a region corresponding to the target TU of the target CU belonging to the target slice, whereas in the case in which the residual mode rru_flag is the second mode (!=0), the TU information decoding section 13 decodes the quantized prediction residual of half the size of the TU size. Also, to decode the image of the region of the decoded predetermined coding tree block size, in the case in which the residual mode is the second mode, the prediction residual image may be enlarged as described in P2a, or the decoded image may be enlarged as described in P2b. This configuration is also similar to the configurations of P6a and P6b described below.

<P6a: Derivation of Slice Position>

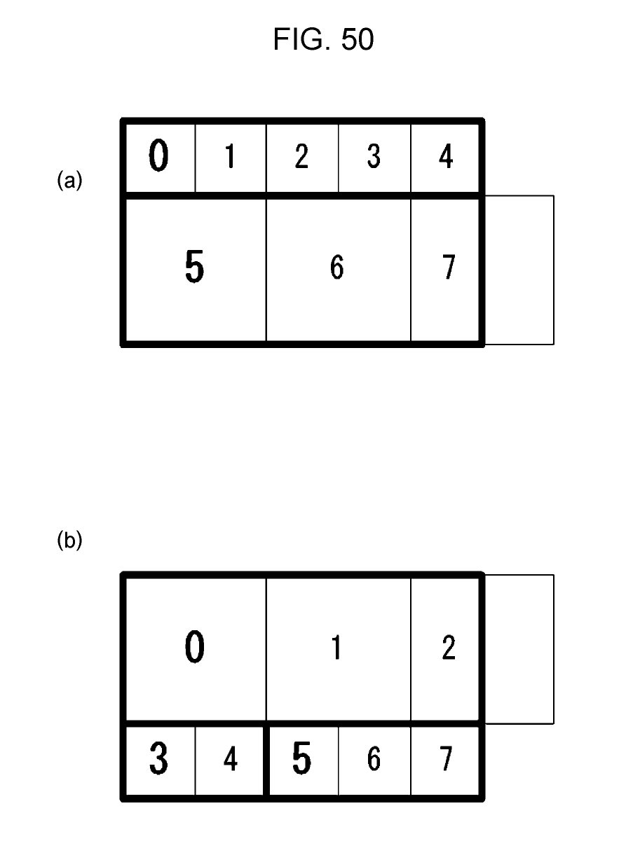

FIG. 50 is a diagram explaining a configuration that uses a different coding tree block (highest-layer block size) for each slice within a picture according to an embodiment of the present invention. The present invention is an image decoding device characterized in that, in an image decoding device that partitions a picture into units of slices, and further partitions each slice into units of coding tree blocks, the coding tree block inside each slice (highest-layer block size, CTU size) is made to be variable. The CU decoding section 11 is provided with a residual mode decoding section that decodes, in the slice header, information indicating the above resolution, namely a resolution change mode (residual mode). With this arrangement, an effect is exhibited whereby the code rate of the quantized prediction residual can be controlled in finer units than the picture.

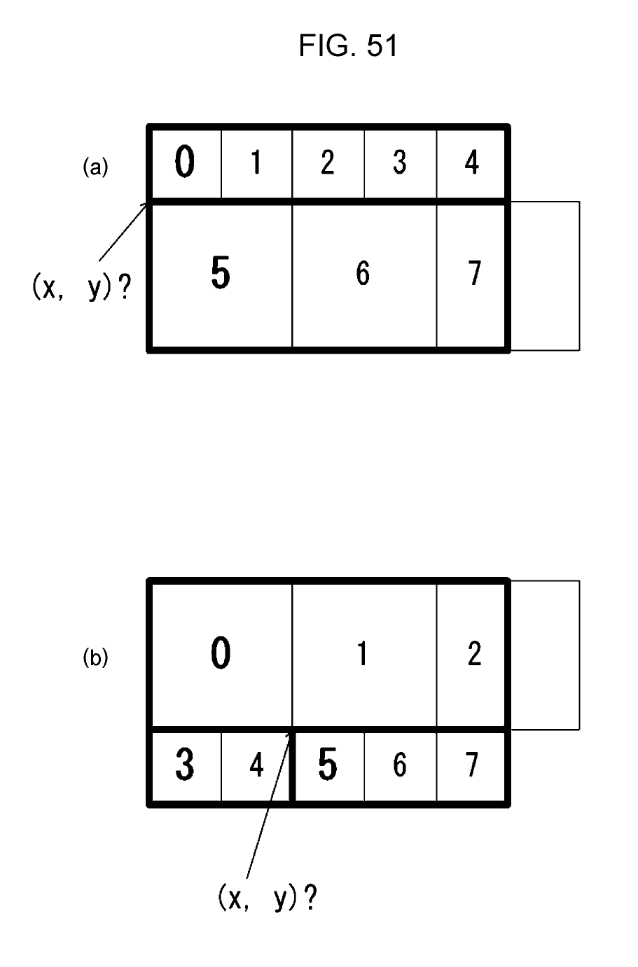

FIG. 51 is a diagram explaining the problem of the slice beginning position in the case of using a different coding tree block (highest-layer block size) for each slice within a picture according to an embodiment of the present invention. FIG. 51(a) illustrates a slice #0 including CTUs from 0 to 4 having a coding tree block size of 64×64 (resolution transform mode=0), and a slice #1 including CTUs from 5 to 7 having a coding tree block size of 128×128 (resolution transform mode=1). FIG. 51(b) illustrates a slice #0 including CTUs from 0 to 2 having a coding tree block size of 128×128 (resolution transform mode=1), a slice #1 including CTUs from 3 to 4 having a coding tree block size of 64×64 (resolution transform mode=0), and a slice #2 including CTUs from 5 to 7 having a coding tree block size of 64×64 (resolution transform mode=0). In the case in which a slice address slice_segment_address is coded at the beginning of the slice, slice #1 in FIG. 51(a) and slice #3 in FIG. 51(b) have the same slice_segment_address of 5, but the position (horizontal position, vertical position) of the beginning of the slice is different. In the past, in the case of the same coding tree block size within the picture, the position of the beginning of the slice could be derived uniquely from the slice address slice_segment_address. However, in the case in which the coding tree block size is different for each slice within the picture, the position of the beginning of the slice depends not only on the slice address slice_segment_address and the coding tree block size of the target slice, but also the coding tree block size of the slice positioned ahead of the target slice in the picture. Consequently, there is a problem of being unable to derive the position of the beginning of the slice from the slice address slice_segment_address.

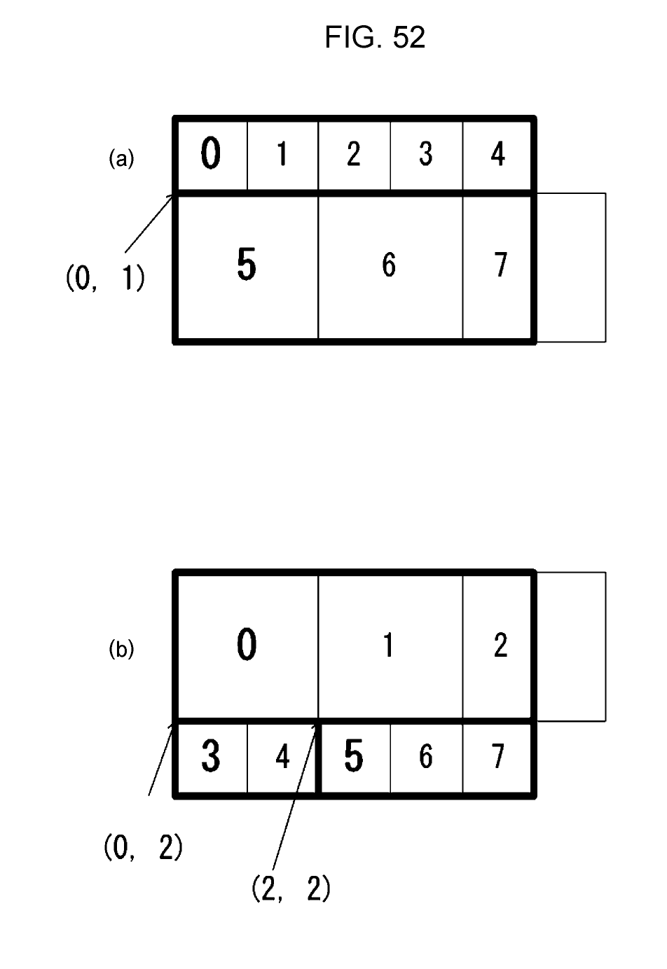

FIG. 52 is a diagram explaining an example of including a horizontal position slice_addr_x and a vertical position slice_addr_y of the slice beginning position in coded data in the case of using a different coding tree block (highest-layer block size) for each slice within the picture according to an embodiment of the present invention. In this example, the position of the beginning of the slice is derived by explicitly decoding the horizontal position and the vertical position of the slice beginning position at the beginning of the slice. For example, the value indicating the horizontal position and the vertical position of the beginning of the slice may be set on the basis of a minimum value of the coding tree block usable within the picture, or set on the basis of a fixed size. In the example of FIG. 52(a), with respect to slice #1, (horizontal position slice_addr_x, vertical position slice_addr_y)=(0, 1). Herein, since the coding tree block size is set on the basis of 32×32 blocks, the beginning coordinates of slice #1 become (0, 32) of (32×slice_addr_x, 32×slice_addr_y). In the example of FIG. 52(b), with respect to slice #1, (horizontal position slice_addr_x, vertical position slice_addr_y)=(0, 2). With respect to slice #2, (horizontal position slice_addr_x, vertical position slice_addr_y)=(2, 2). Herein, since the coding tree block size is set on the basis of 32×32 blocks, the beginning coordinates of slice #1 and slice #2 becomes (0, 32) and (64, 64), respectively. In other words, the present embodiment is characterized by decoding the value indicating the horizontal position and the value indicating the vertical position of the beginning of the slice. Note that since the horizontal position and the vertical position of the slice beginning position is always (0, 0) for the leading slice, a configuration that decodes the horizontal position and the vertical position of the slice beginning position in slices other than the leading slice is also acceptable.

According to the image decoding device with the above configuration, even in the case of using a different coding tree block (highest-layer block size) for each slice within the picture, an effect of being able to specify the position of the beginning of the slice is exhibited.

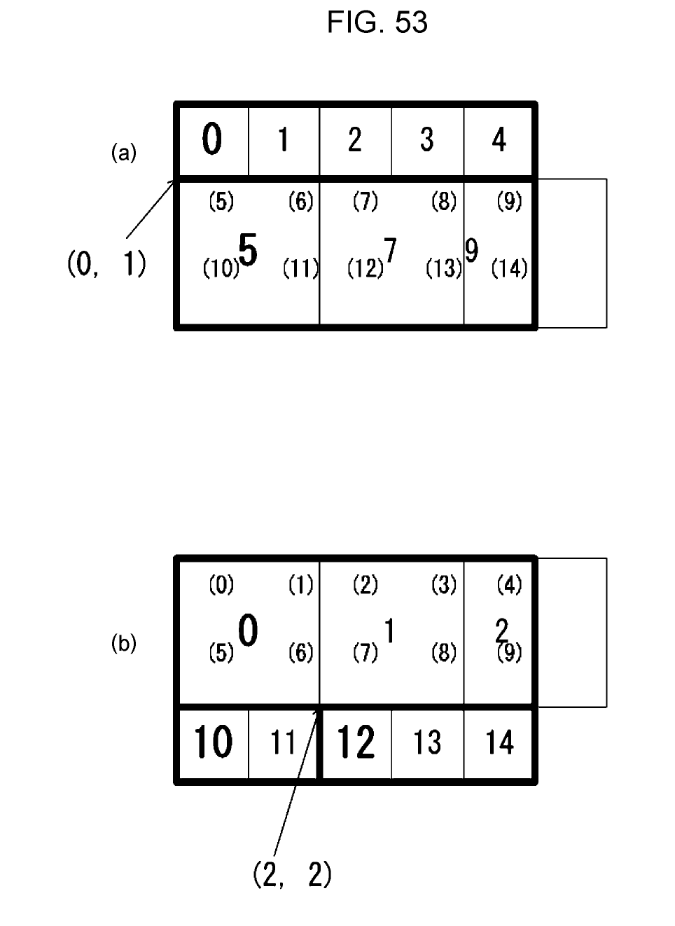

FIG. 53 is a diagram explaining a method of deriving the horizontal position and vertical position of the slice beginning position from the slice address slice_segment_address in the case of using a different coding tree block (highest-layer block size) for each slice within a picture according to an embodiment of the present invention. In this example, a minimum value MinCtbSizeY of the coding tree block usable within the picture is used to derive the position of the beginning of the slice (xSicePos, ySlicePos) from the slice address slice_segment_address. First, the slice address slice_segment_address is substituted for SliceAddrRs. From the picture width pic_width_in_luma_samples and height pic_height_in_luma_samples, a width PicWidthInMinCtbsY and a height PicHeightInMinCtbsY of the minimum value MinCtbSizeY of the coding tree block constituting the picture are derived as follows.

MinCtbSizeY=1<<MinCtbLog2SizeY

PicWidthInMinCtbsY=Ceil(pic_width_in_luma_samples/MinCtbSizeY)

PicHeightInMinCtbsY=Ceil(pic_height_in_luma_samples/MinCtbSizeY)

Note that Ceil(x) is a function that transforms a real number x into the smallest integer equal to or greater than x. Next, the position (xSicePos, ySlicePos) of the beginning of the slice is derived from the following formulas.

xSlicePos=(SliceAddrRs % PicWidthInMinCtbsY)<<MinCtbLog2SizeY

ySlicePos=(SliceAddrRs % PicWidthInMinCtbsY)<<MinCtbLog2SizeY

To put it another way, the slice address slice_segment_address is set on the basis of the minimum value of the coding tree block usable within the picture. In the example of FIG. 53, since the usable coding tree block size are 64×64 and 128×128, the minimum value is 64×64. In FIG. 53(a), the beginning address of slice #1 is set to 5 (decoded). The values in parentheses indicate the number of each region in the case in which the coding tree block size is 64×64. This number is coded as the address of the beginning of the slice. In FIG. 53(b), the beginning address of slice #1 is set to 10 (decoded). The values in parentheses indicate the number of each region in the case in which the coding tree block size is 64×64. This number is coded as the address of the beginning of the slice.

In other words, the present embodiment is characterized by decoding a value indicating the beginning address of the beginning of the slice, and on the basis of the smallest block size among the highest-layer block sizes available for selection, deriving the horizontal position and the vertical position of the slice beginning position or the target block.

According to the image decoding device with the above configuration, even in the case of using a different coding tree block (highest-layer block size) for each slice within the picture, an effect of being able to specify the position of the beginning of the slice is exhibited.

<P6b: Resolution Change Limitations>

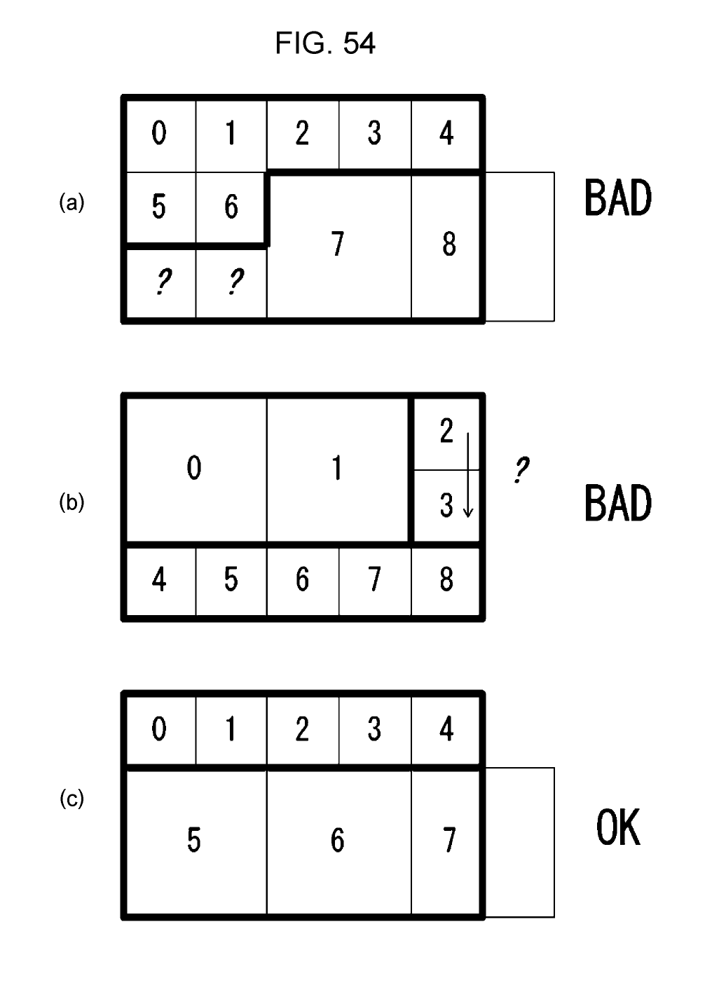

FIG. 54 is a diagram explaining a configuration that uses a different coding tree block for each picture according to a comparative example. FIGS. 54(a) and 54(b) illustrate examples of changing the coding tree block size even in the case of a slice boundary not on the left edge of the picture (the case of a non-zero horizontal coordinate of the slice start position). In this example, in an example in which the coding tree block size of the next slice becomes larger than the coding tree block size of the previous slice at a location other than the left edge, like in FIG. 54(a), for example, which slice to allocate the region labeled “?” and how to decode such a region is unclear. Also, there is a problem in that the processing becomes complicated in the case of defining an allocation method. In FIG. 54(b), in an example in which the coding tree block size becomes smaller than the previous slice at a location other than a slice on the left edge of the picture, which slice to allocate the region labeled “?” is resolved relatively easily, but there is a problem in that the processing becomes complicated, such as that a scan order other than raster scan becomes necessary, or that the scan order of coding tree blocks within slices becomes different.

FIG. 50 will be used again to described resolution change limitations. The image decoding device of the present embodiment changes the coding tree block size (highest-layer block size) only in the case in which the slice start position is on the left edge of the picture (only in the case in which the horizontal position of the slice start position is 0), as illustrated in FIG. 50. In other words, a coding tree block size that is different from the previous slice is applied only in the case in which the slice start position is on the left edge of the picture or the left edge of a tile. For example, FIG. 50(a) is an example in which the coding tree block size becomes larger on the left edge of the picture, while FIG. 50(b) is an example in which the coding tree block size becomes smaller on the left edge of the picture.

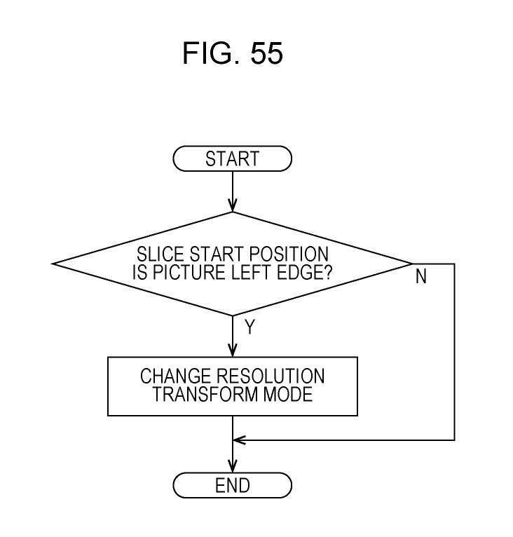

FIG. 55 is a flowchart of a configuration illustrating an example of performing a resolution change (coding tree block change) process only in a slice positioned on the left edge of a picture according to an embodiment of the present invention. As illustrated in FIG. 55, the image decoding device 1 of the preceding applies to a certain slice a resolution transform mode (residual mode) different from the resolution transform mode of the previous (immediately preceding) slice only in the case in which the horizontal position of the slice start position of the certain slice is 0 (the slice start position on the left edge of the picture).

In other words, for a certain slice, a coding tree block size that is different from the immediately precious slice is used only in the case in which the horizontal position of the slice start position of the certain slice is 0 (the slice start position is on the left edge of the picture). Note that in the case in which tiles partitioning the picture into rectangles are used as a higher-layer structure (each tile includes slices), the resolution transform mode may be changed (the coding tree block size may be changed) at the left edge of the tile, without being limited to the left edge of the picture. In other words, the image decoding device 1 of the present invention applies a resolution transform mode (residual mode) different from the previous slice only in the case in which the horizontal position of the slice start position is 0 or the horizontal position within the tile is 0 (the slice start position is on the left edge of the picture or on the left edge of the tile). The image decoding device 1 of the present invention applies, to a certain slice, a coding tree block size different from the previous slice only in the case in which the horizontal position of the slice start position of the certain slice is 0 or the horizontal position within the tile is 0 (the slice start position is on the left edge of the picture or on the left edge of the tile).

As above, the coding tree block size of the previous slice and the highest-layer block size (coding tree block size) of the next slice within the same picture must be equal, except in cases in which the slice start position of the next slice is on the left edge of the picture (or the left edge of the tile). The image decoding device 1 of the present invention, by decoding coded data #1 like the above, can change the highest-layer block size without complicated processing. The image decoding device 1 of the present invention decodes coded data #1 in which the highest-layer block sizes of the previous and next slices must be equal to each other, except in cases in which the horizontal position within the picture or the horizontal position within the tile of the slice start position of the next slice is 0.

According to the image decoding device with the configuration illustrated in FIG. 55, since the resolution change (coding tree block change) process is performed only on the left edge of the picture in the case of using a different coding tree block (highest-layer block size) for each slice, an effect is exhibited whereby scan processing of the coding tree block becomes easy.

<Video Image Coding Device>

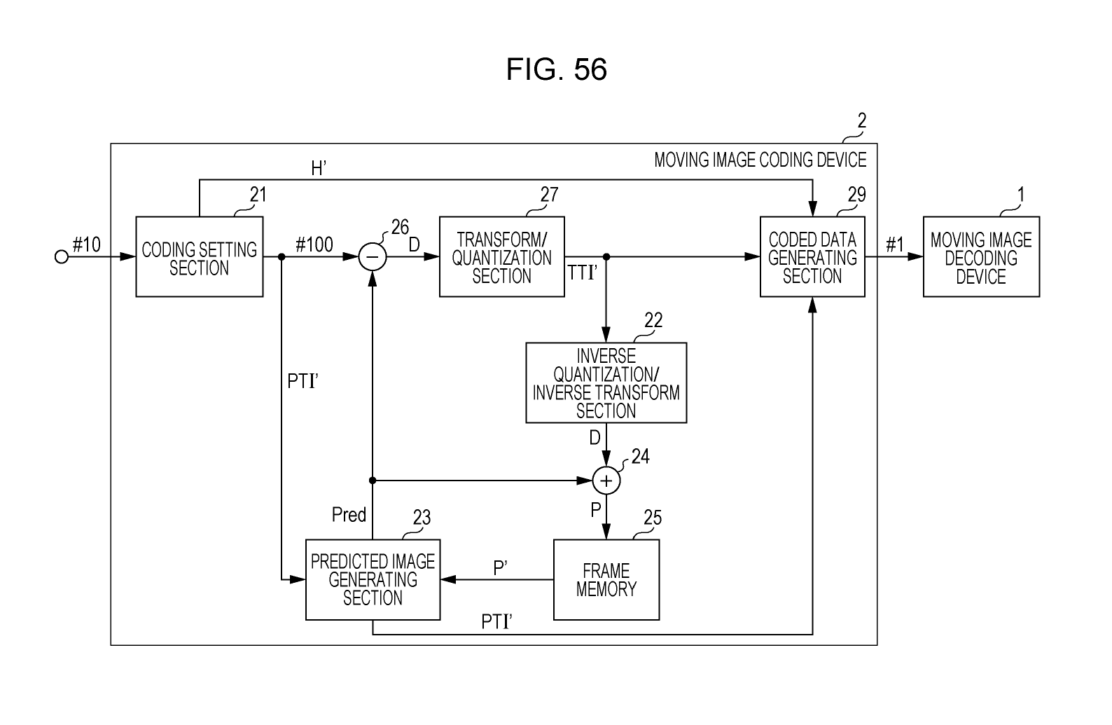

Hereinafter, the video image coding device 2 according to the present embodiment will be described with reference to FIG. 56.

(Overview of Video Image Coding Device)

Generally speaking, the video image coding device 2 is a device that generates and outputs coded data #1 by coding an input image #10.

(Configuration of Video Image Coding Device)

First, FIG. 56 will be used to describe an exemplary configuration of the video image coding device 2. FIG. 56 is a function block diagram illustrating a configuration of the video image coding device 2. As illustrated in FIG. 56, the video image coding device 2 is provided with a coding setting section 21, an inverse quantization/inverse transform section 22, a predicted image generating section 23, an adder 24, frame memory 25, a subtractor 26, a transform/quantization section 27, and a coded data generating section (adaptive processing means) 29.

The coding setting section 21 generates image data related to coding and various setting information on the basis of an input image #10.

Specifically, the coding setting section 21 generates the following image data and setting information.

First, the coding setting section 21 generates a CU image #100 for the target CU by successively partitioning the input image #10 in units of slices and units of tree blocks.

Additionally, the coding setting section 21 generates header information H′ on the basis of the result of the partitioning process. The header information H′ includes (1) information about the sizes and shapes of tree blocks belonging to the target slice, as well as the positions within the target slice, and (2) CU information CU′ about the sizes and shapes of CUs belonging to each tree block, as well as the positions within the target tree block.

Furthermore, the coding setting section 21 references the CU image #100 and the CU information CU′ to generate PT configuration information PTI′. The PT information PTI′ includes (1) available partitioning patterns for partitioning the target CU into each PU, and (2) information related to all combinations of prediction modes assignable to each PU.

The coding setting section 21 supplies the CU image #100 to the subtractor 26. Also, the coding setting section 21 supplies the header information H′ to the coded data generating section 29. Also, the coding setting section 21 supplies the PT information PTI′ to the predicted image generating section 23.

The inverse quantization/inverse transform section 22 reconstructs the prediction residual for each block by applying an inverse quantization and an inverse orthogonal transform to the quantized prediction residual of each block supplied by the transform/quantization section 27. Since the inverse orthogonal transform has already been described with respect to the inverse quantization/inverse transform section 13 illustrated in FIG. 1, description thereof will be omitted herein.

Additionally, the inverse quantization/inverse transform section 22 consolidates the prediction residual of each block according to the partitioning pattern designated by the TT partitioning information (described later), and generates the prediction residual D for the target CU. The inverse quantization/inverse transform section 22 supplies the generated prediction residual D for the target CU to the adder 24.

The predicted image generating section 23 references a locally decoded image P′ recorded in the frame memory 25, as well as the PT configuration information PTI′, to generate a predicted image Pred for the target CU. The predicted image generating section 23 sets prediction parameters obtained by the predicted image generation process in the PT configuration information PTI′, and forwards the set PT configuration information PTI′ to the coded data generating section 29. Note that since the predicted image generation process by the predicted image generating section 23 is similar to that of the predicted image generating section 14 provided in the video image decoding device 1, description herein is omitted.

The adder 24 adds together the predicted image Pred supplied by the predicted image generating section 23 and the prediction residual D supplied by the inverse quantization/inverse transform section 22, thereby generating the decoded image P for the target CU.

Decoded images P that have been decoded are successively recorded in the frame memory 25. At the time of decoding the target tree block, decoded images corresponding to all tree blocks decoded prior to that target tree block (for example, all preceding tree blocks in the raster scan order) are recorded in the frame memory 25, together with the parameters used to decode each decoded image P.

The subtractor 26 generates the prediction residual D for the target CU by subtracting the predicted image Pred from the CU image #100. The subtractor 26 supplies the generated prediction residual D to the transform/quantization section 27.

The transform/quantization section 27 generates a quantized prediction residual by applying an orthogonal transform and quantization to the prediction residual D. Note that the orthogonal transform at this point refers to an orthogonal transform from the pixel domain to the frequency domain. Also, examples of the inverse orthogonal transform include the discrete cosine transform (DCT) and the discrete sine transform (DST).

Specifically, the transform/quantization section 27 references the CU image #100 and the CU information CU′, and decides a partitioning pattern for partitioning the target CU into one or multiple blocks. Also, the prediction residual D is partitioned into a prediction residual for each block according to the decided partitioning pattern.

In addition, after generating the prediction residual in the frequency domain by orthogonally transforming the prediction residual for each block, the transform/quantization section 27 generates the quantized prediction residual for each block by quantizing the prediction residual in the frequency domain.

Also, the transform/quantization section 27 generates the TT configuration information TTI′ that includes the generated quantized prediction residual for each block, the TT partitioning information designating the partitioning pattern of the target CU, and information about all available partitioning patterns for partitioning the target CU into each block. The transform/quantization section 27 supplies the generated TT configuration information TTI′ to the inverse quantization/inverse transform section 22 and the coded data generating section 29.

The coded data generating section 29 codes the header information H′, the TT configuration information TTI′, and the PT configuration information PTI′, and generates and outputs the coded data #1 by multiplexing the coded header information H, the TT configuration information TTI, and the PT configuration information PTI.

(Corresponding Relationship with Video Image Decoding Device)

The video image coding device 2 includes components that correspond to each component of the video image decoding device 1. Herein, correspondence refers to being in a relationship of performing a similar process or an inverse process.

For example, as described earlier, the predicted image generation process by the predicted image generating section 14 provided in the video image decoding device 1 and the predicted image generation process by the predicted image generating section 23 provided in the video image coding device 2 are similar.

For example, the process of decoding syntax values from the bit sequence in the video image decoding device 1 corresponds as an inverse process to the process of coding the bit sequence from syntax values in the video image coding device 2.

Hereinafter, what kind of correspondence each component in the video image coding device 2 has with the CU information decoding section 11, the PU information decoding section 12, and the TU information decoding section 13 of the video image decoding device 1 will be described. In so doing, the operation and function of each component in the video image coding device 2 will be clear in further detail.

The coded data generating section 29 corresponds to the decoding module 10. More specifically, whereas the decoding module 10 derives syntax values on the basis of the coded data and the syntax class, the coded data generating section 29 generates the coded data on the basis of the syntax values and the syntax class.

The coding setting section 21 corresponds to the CU information decoding section 11 of the video image decoding device 1 described above. When compared, the coding setting section 21 and the CU information decoding section 11 described above are as follows.

The predicted image generating section 23 corresponds to the PU information decoding section 12 and the predicted image generating section 14 of the video image decoding device 1 described above. When compared, these are as follows.

As described above, the PU information decoding section 12 supplies coded data and the syntax class related to motion information to the decoding module 10, and derives motion compensation parameters on the basis of the motion information decoded by the decoding module 10. Also, the predicted image generating section 14 generates the predicted image on the basis of the derived motion compensation parameters.

In contrast, in the predicted image generation process, the predicted image generating section 23 decides the motion compensation parameters, and supplies syntax values and the syntax class related to the motion compensation parameters to the coded data generating section 29.

The transform/quantization section 27 corresponds to the TU information decoding section 13 and the inverse quantization/inverse transform section 15 of the video image decoding device 1 described above. When compared, these are as follows.

A TU partition setting section 131 provided in the TU information decoding section 13 described above supplies coded data and the syntax class related to information indicating whether or not to partition a node to the decoding module 10, and performs TU partitioning on the basis of the information indicating whether or not to partition the node decoded by the decoding module 10.

Additionally, a transform coefficient reconstruction section 132 provided in the TU information decoding section 13 described above supplies coded data and the syntax class related to determination information and transform coefficients to the decoding module 10, and derives the transform coefficients on the basis of the determination information and the transform coefficients decoded by the decoding module 10.

In contrast, the transform/quantization section 27 decides the partitioning method for TU partitioning, and supplies syntax values and the syntax class related to information indicating whether or not to partition a node to the coded data generating section 29.

Also, the transform/quantization section 27 supplies syntax values and the syntax class related to the quantized transform coefficients obtained by transforming and quantizing the prediction residual to the coded data generating section 29.

The video image coding device 2 of the present embodiment is provided with, in an image coding device that codes by partitioning a picture into coding tree block units, a coding tree partitioning section that recursively partitions the coding tree block as a root coding tree, a CU partitioning flag decoding section that codes a coding unit partitioning flag indicating whether or not to partition the coding tree, and a residual mode decoding section that codes a residual mode indicating whether to decode a residual of the coding tree and below in a first mode, or code in a second mode different from the first mode.

<<P1: TU Information Coding According to Residual Mode>>

Also, the transform section provided in the transform/quantization section 27 described above exhibits an effect of reducing the code rate of residual information by coding, as the coded data, the quantized prediction residual that is smaller (for example, residual information of ½ the target TU size) than the actual size of the transform block (target TU size). Also, an effect of simplifying the process of coding residual information is exhibited.

<<P2: Configuration of Block Pixel Value Coding According to Residual Mode>>

Also, the transform section provided in the transform/quantization section 27 described above reduces and then transforms the prediction residual in the case in which the residual mode is the second mode.

Furthermore, in the case in which the residual mode is the second mode, the inverse quantization/inverse transform section 15 provided in the TU information decoding section 13 described above corresponds to enlarging the transform image (corresponds to P2A) or the decoded image (P2B). Consequently, by coding just the prediction residual information of a region size smaller than the actual target region (for example, prediction residual information of ½ the size of the target region), a decoded image of the target region can be derived, and an effect of reducing the code rate of the residual information is exhibited. Also, an effect of simplifying the process of coding residual information is exhibited.

<<P3: Exemplary Configuration of Quantization Control According to Residual Mode>>

The video image coding device 2 additionally is provided with the transform/quantization section 27 that transforms and quantizes the residual, and the coded data generating section 29 that decodes the quantized residual. The transform/quantization section 27 performs quantization according to a first quantization parameter in the case in which the residual mode is the “second mode” (0), and performs quantization according to a second quantization parameter derived from the first quantization parameter in the case in which the residual mode is the “first mode” (1).

The video image coding device 2 additionally is provided with a quantization parameter control information coding that codes a quantization parameter correction value, and the inverse quantization section derives the second quantization parameter by adding a quantization step correction value to the first quantization parameter.

Also, according to the TU coding section provided in the TU information decoding section 13 described above, by controlling the quantization parameter qP according to the residual mode, there is exhibited an effect of being able to control appropriately the amount of reduction in the code rate of the residual information regarding the region targeted by the residual mode.

<<P4: Configuration of Residual Mode Coding Section>>

Furthermore, the residual mode coding section codes the residual mode (rru_flag) from the coded data only in the highest-layer coding tree, and does not code the residual mode (rru_flag) in lower coding trees.

Furthermore, the residual mode coding section codes the residual mode only in the coding tree of a designated layer, and skips the coding of the residual mode outside the coding tree of a designated layer in lower coding trees.

Furthermore, in the case in which the residual mode indicates “coding in the second mode”, the partitioning flag coding section decreases the partitioning depth by 1 compared to the case in which the residual mode indicates “coding in the first mode”.

Furthermore, in the case in which the residual mode is the first mode, the partitioning flag coding section codes the CU partitioning flag from the coded data if the size of the coding tree, namely the coding block size log2CbSize, is greater than the minimum coding block MinCbLog2Size. In the case in which the residual mode is the second mode, the partitioning flag coding section codes the CU partitioning flag from the coded data if the size of the coding tree, namely the coding block size log2CbSize, is greater than the minimum coding block MinCbLog2Size+1. Otherwise, the partitioning flag coding section skips the coding of the CU partitioning flag, and sets the CU partitioning flag to 0, which indicates not to partition.

Furthermore, the residual mode coding section codes the residual mode in the coding unit which is the coding tree not partitioned any further, or in other words, the leaf coding tree.

Furthermore, the video image coding device 2 is provided with a skip flag coding section that codes a skip flag indicating whether or not to code by skipping the coding of the residual in the coding unit which is the coding tree not partitioned any further, or in other words, the leaf coding tree. In the case in which the skip flag indicates not to code the residual in the coding unit, the residual mode coding section codes the residual mode. Otherwise, the residual mode coding section does not code the residual mode.

Furthermore, the video image coding device 2 is provided with a CBF flag coding section that code a CBF flag (rqt_root_flag) indicating whether or not the coding unit includes a residual. In the case in which the CBF flag indicates that a residual exists (!=0), the residual mode coding section codes the residual mode. Otherwise, the residual mode coding section derives that the residual mode is the first mode.

Also, according to the TU coding section provided in the TU information decoding section 13 described above, an effect of enabling quadtree partitioning with a high degree of freedom is exhibited even in the case of changing the configuration of the residual by the residual mode rru_flag.

<<P5: Configuration of Residual Mode Coding Section>>

The video image coding device 2 is provided with the PU information coding section 12 (PU partitioning mode coding section) that codes the PU partitioning mode indicating whether or not to partition the coding unit further into prediction blocks (PUs). In the case in which the residual mode indicates the “first mode”, the PU partitioning mode coding section skips the coding of the PU partitioning mode, whereas in the case in which the residual mode indicates the “second mode”, the PU partitioning mode coding section codes the PU partitioning mode. In the case in which the residual mode indicates the “first mode”, or in other words, in the case in which the coding of the PU partitioning mode is skipped, the PU information coding section 12 sets a value indicating not to perform PU partitioning (2N×2N).

The video image coding device 2 is provided with the TU partition setting section 131 that codes the TU partitioning flag split_transform_flag indicating whether or not to partition the coding unit further into transform blocks (TUs). In the case in which the residual mode indicates the “first mode”, the TU partition setting section 131 codes the TU partitioning flag split_transform_flag when the coding block size log2CbSize is less than or equal to the maximum transform block MaxTbLog2SizeY+1 and greater than the minimum transform block MinCbLog2Size+1. In the case in which the residual mode indicates the “second mode”, the TU partition setting section 131 codes the TU partitioning flag split_transform_flag when the coding block size log2CbSize is less than or equal to the maximum transform block MaxTbLog2SizeY and greater than the minimum transform block MinCbLog2Size. Otherwise (in the case in which the coding block size log2CbSize is greater than the maximum transform block MaxTbLog2SizeY, or less than or equal to the minimum transform block MinCbLog2Size), the coding of the TU partitioning flag split_transform_flag is skipped, and a value indicating not to partition is set.

<Applications>

The video image coding device 2 and the video image decoding device 1 described above can be installed and utilized in various devices that transmit, receive, record, or play back video images. Note that a video image may be a natural video image recorded by a camera or the like, but may also be a synthetic video image (including CG and GUI images) generated by a computer or the like.

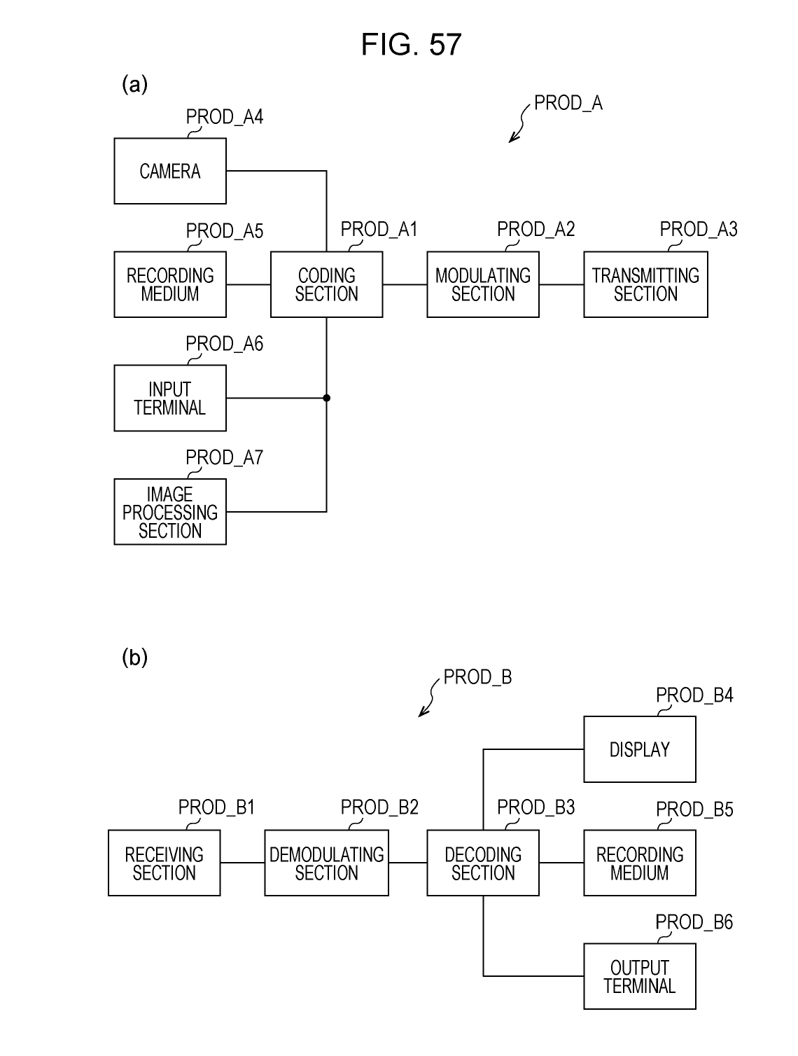

First, the ability to utilize the video image coding device 2 and the video image decoding device 1 described above to transmit and receive a video image will be described with reference to FIG. 57.

FIG. 57(a) is a block diagram illustrating a configuration of a transmitting device PROD_A equipped with the video image coding device 2. As illustrated in FIG. 57(a), the transmitting device PROD_A is provided with a coding section PROD_A1 that obtains coded data by coding a video image, a modulating section PROD_A2 that obtains a modulated signal by modulating a carrier wave with the coded data obtained by the coding section PROD_A1, and a transmitting section PROD_A3 that transmits the modulated signal obtained by the modulating section PROD_A2. The video image coding device 2 described above is used as the coding section PROD_A1.

As sources for supplying a video image to input into the coding section PROD_A1, the transmitting device PROD_A may be additionally provided with a camera PROD_A4 that takes a video image, a recording medium PROD_A5 onto which a video image is recorded, an input terminal PROD_A6 for externally inputting a video image, and an image processing section A7 that generates or processes an image. Although FIG. 57(a) illustrates an example of a configuration of the transmitting device PROD_A provided with all of the above, some may also be omitted.

Note that the recording medium PROD_A5 may be a medium storing an uncoded video image, or a medium storing a video image coded by a coding scheme for recording that differs from the coding scheme for transmission. In the latter case, a decoding section (not illustrated) that decodes the coded data read out from the recording medium PROD_A5 in accordance with the coding scheme for recording may be interposed between the recording medium PROD_A5 and the coding section PROD_A1.

FIG. 57(b) is a block diagram illustrating a configuration of a receiving device PROD_B equipped with the video image decoding device 1. As illustrated in FIG. 57(b), the receiving device PROD_B is provided with a receiving section PROD_B1 that receives a modulated signal, a demodulating section PROD_B2 that obtains coded data by demodulating the modulated signal received by the receiving section PROD_B1, and a decoding section PROD_B3 that obtains a video image by decoding the coded data obtained by the demodulating section PROD_B2. The video image decoding device 1 described above is used as the decoding section PROD_B3.

As destinations to supply with a video image output by the decoding section PROD_B3, the receiving device PROD_B may be additionally provided with a display PROD_B4 that displays a video image, a recording medium PROD_B5 for recording a video image, and an output terminal PROD_B6 for externally outputting a video image. Although FIG. 57(b) illustrates an example of a configuration of the receiving device PROD_B provided with all of the above, some may also be omitted.

Note that the recording medium PROD_B5 may be a medium for recording an uncoded video image, or a medium for recording a video image coded by a coding scheme for recording that differs from the coding scheme for transmission. In the latter case, a coding section (not illustrated) that codes the video image acquired from the decoding section PROD_B3 in accordance with the coding scheme for recording may be interposed between the decoding section PROD_B3 and the recording medium PROD_B5.

Note that the transmission medium via which the modulated signal is transmitted may be wireless or wired. Also, the transmission format by which the modulated signal is transmitted may be broadcasting (herein indicating a transmission format in which the recipient is not specified in advance) or communication (herein indicating a transmission format in which the recipient is specified in advance). In other words, the transmission of the modulated signal may be realized by any of wireless transmission, wired transmission, wireless communication, and wired communication.

For example, a digital terrestrial broadcasting station (such as a broadcasting facility)/receiving station (such as a television receiver) is an example of a transmitting device PROD_A/receiving device PROD_B that transmits or receives the modulated signal by wireless broadcasting. Also, a cable television broadcasting station (such as a broadcasting facility)/receiving station (such as a television receiver) is an example of a transmitting device PROD_A/receiving device PROD_B that transmits or receives the modulated signal by wired broadcasting.

Also, a server (such as a workstation)/client (such as a television receiver, personal computer, or smartphone) for a service such as a video on demand (VOD) service or video sharing service using the Internet is an example of a transmitting device PROD_A/receiving device PROD_B that transmits or receives the modulated signal by communication (ordinarily, either a wireless or wired medium is used as the transmission medium in a LAN, while a wired medium is used as the transmission medium in a WAN). Herein, the term personal computer encompasses desktop PCs, laptop PCs, and tablet PCs. Also, the term smartphone encompasses multifunction mobile phone devices.

Note that a client of a video sharing service includes functions for decoding coded data downloaded from a server and displaying the decoded data on a display, and additionally includes functions for coding a video image captured with a camera and uploading the coded data to a server. In other words, a client of a video sharing service functions as both the transmitting device PROD_A and the receiving device PROD_B.

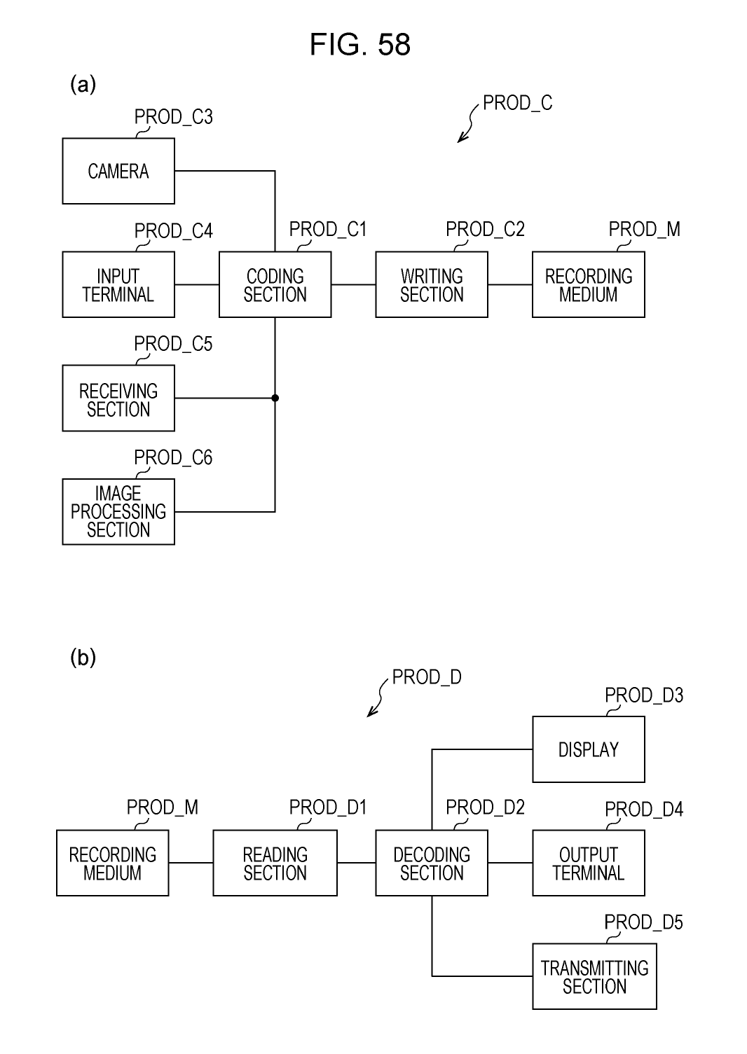

Next, the ability to utilize the video image coding device 2 and the video image decoding device 1 described above to record and play back a video image will be described with reference to FIG. 58.

FIG. 58(a) is a block diagram illustrating a configuration of a recording device PROD_C equipped with the video image coding device 2 described above. As illustrated in FIG. 58(a), the recording device PROD_C is provided with a coding section PROD_C1 that obtains coded data by coding a video image, and a writing section PROD_C2 that writes coded data obtained by the coding section PROD_C1 to a recording medium PROD_M. The video image coding device 2 described above is used as the coding section PROD_C1.

Note that the recording medium PROD_M may be (1) of a type that is built into the recording device PROD_C, such as a hard disk drive (HDD) or a solid-state drive (SSD), (2) of a type that is connected to the recording device PROD_C, such as an SD memory card or Universal Serial Bus (USB) flash memory, or (3) loaded into a drive device (not illustrated) built into the recording device PROD_C, such as a Digital Versatile Disc (DVD) or Blu-ray Disc (BD; registered trademark).

Also, as sources for supplying a video image to input into the coding section PROD_C1, the recording device PROD_C may be additionally provided with a camera PROD_C3 that captures a video image, an input terminal PROD_C4 for externally inputting a video image, a receiving section PROD_C5 for receiving a video image, and an image processing section C6 that generates or processes an image. Although FIG. 58(a) illustrates an example of a configuration of the recording device PROD_C provided with all of the above, some may also be omitted.

Note that the receiving section PROD_C5 may be one that receives an uncoded video image, or one that receives coded data that has been coded with a coding scheme for transmission that differs from the coding scheme for recording. In the latter case, a transmission decoding section (not illustrated) that decodes coded data that has been coded with the coding scheme for transmission may be interposed between the receiving section PROD_C5 and the coding section PROD_C1.

Examples of such a recording device PROD_C are, for example, a DVD recorder, a BD recorder, or a hard disk drive (HDD) recorder (in this case, the input terminal PROD_C4 or the receiving section PROD_C5 becomes the primary source for supplying video images). In addition, devices such as a camcorder (in this case, the camera PROD_C3 becomes the primary source for supplying video images), a personal computer (in this case, the receiving section PROD_C5 or the image processing section C6 becomes the primary source for supplying video images), a smartphone (in this case, the camera PROD_C3 or the receiving section PROD_C5 becomes the primary source for supplying video images) are also examples of such a recording device PROD_C.

FIG. 58(b) is a block diagram illustrating a configuration of a playback device PROD_D equipped with the video image decoding device 1 described earlier. As illustrated in FIG. 58(b), the playback device PROD_D is provided with a reading section PROD_D1 that reads out coded data written to a recording medium PROD_M, and a decoding section PROD_D2 that obtains a video image by decoding the coded data read out by the reading section PROD_D1. The video image decoding device 1 described earlier is used as the decoding section PROD_D2.

Note that the recording medium PROD_M may be (1) of a type that is built into the playback device PROD_D, such as an HDD or SSD, (2) of a type that is connected to the playback device PROD_D, such as an SD memory card or USB flash memory, or (3) loaded into a drive device (not illustrated) built into the playback device PROD_D, such as a DVD or BD.

Also, as destinations to supply with a video image output by the decoding section PROD_D2, the playback device PROD_D may be additionally equipped with a display PROD_D3 that displays a video image, an output terminal PROD_D4 for externally outputting a video image, and a transmitting section PROD_D5 that transmits a video image. Although FIG. 58(b) illustrates an example of a configuration of the playback device PROD_D provided with all of the above, some may also be omitted.

Note that the transmitting section PROD_D5 may be one that transmits an uncoded video image, or one that transmits coded data that has been coded with a coding scheme for transmission that differs from the coding scheme for recording. In the latter case, a coding section (not illustrated) that codes a video image with the coding scheme for transmission may be interposed between the decoding section PROD_D2 and the transmitting section PROD_D5.

Examples of such a playback device PROD_D includes a DVD player, a BD player, or an HDD player (in this case, the output terminal PROD_D4 connected to a television receiver or the like becomes the primary destination to supply with video images). Additionally, devices such as a television receiver (in this case, the display PROD_D3 becomes the primary destination to supply with video images), digital signage (also referred to as electronic signs or electronic billboards; the display PROD_D3 or the transmitting section PROD_D5 becomes the primary destination to supply with video images), a desktop PC (in this case, the output terminal PROD_D4 or the transmitting section PROD_D5 becomes the primary destination to supply with video images), a laptop or tablet PC (in this case, the display PROD_D3 or the transmitting section PROD_D5 becomes the primary destination to supply with video images), a smartphone (in this case, the display PROD_D3 or the transmitting section PROD_D5 becomes the primary destination to supply with video images) are also examples of such a playback device PROD_D.

(Hardware Realization and Software Realization)

In addition, each block of the video image decoding device 1 and the video image coding device 2 described earlier may be realized in hardware by logical circuits formed on an integrated circuit (IC chip), but may also be realized in software using a central processing unit (CPU).

In the latter case, each of the above devices is provided with a CPU that executes the commands of a program that realizes each function, read-only memory (ROM) that stores the above program, random access memory (RAM) into which the above program is loaded, a storage device (recording medium) such as memory that stores the above program and various data, and the like. The object of the present invention is then achievable by supplying each of the above devices with a recording medium upon which is recorded, in computer-readable form, program code (a program in executable format, an intermediate code program, or source program) of the control program of each of the above devices that is software realizing the functions discussed above, and by having that computer (or CPU or MPU) read out and execute program code recorded on the recording medium.

As the above recording medium, a tape-based type such as magnetic tape or a cassette tape, a disk-based type such as a floppy (registered trademark) disk/hard disk, and also including optical discs such as a Compact Disc-Read-Only Memory (CD-ROM)/magneto-optical disc (MO disc)/MiniDisc (MD)/Digital Versatile Disc (DVD)/CD-Recordable (CD-R)/Blu-ray Disc (registered trademark), a card-based type such as an IC card (including memory cards)/optical memory card, a semiconductor memory-based type such as mask ROM/erasable programmable read-only memory (EPROM)/electrically erasable and programmable read-only memory (EEPROM; registered trademark)/flash ROM, a logical circuit-based type such as a programmable logic device (PLD) or field-programmable gate array (FPGA), or the like may be used.

In addition, each of the above devices may be configured to be connectable to a communication network, such that the above program code is supplied via a communication network. The communication network is not particularly limited, insofar as program code is transmittable. For example, a network such as the Internet, an intranet, an extranet, a local area network (LAN), an Integrated Services Digital Network (ISDN), a value-added network (VAN), a community antenna television/cable television (CATV) communication network, a virtual private network, a telephone line network, a mobile communication network, or a satellite communication network is usable. Also, the transmission medium constituting the communication network is not limited to a specific configuration or type, insofar as program code is transmittable. For example, a wired medium such as the Institute of Electrical and Electronic Engineers (IEEE) 1394, USB, power line carrier, cable TV line, telephone line, or asymmetric digital subscriber line (ADSL), or a wireless medium such as infrared as in the Infrared Data Association (IrDA) or a remote control, Bluetooth (registered trademark), IEEE 802.11 wireless, High Data Rate (HDR), Near Field Communication (NFC), the Digital Living Network Alliance (DLNA; registered trademark), a mobile phone network, a satellite link, or a digital terrestrial network is usable. Note that the present invention may also be realized in the form of a computer data signal in which the above program code is embodied by electronic transmission, and embedded in a carrier wave.

The present invention is not limited to the foregoing embodiments, and various modifications are possible within the scope indicated by the claims. In other words, embodiments that may be obtained by combining technical means appropriately modified within the scope indicated by the claims are to be included within the technical scope of the present invention.

### INDUSTRIAL APPLICABILITY

The present invention may be suitably applied to an image decoding device that decodes coded data into which image data is coded, and an image coding device that generates coded data into which image data is coded. The present invention may also be suitably applied to a data structure of coded data that is generated by an image coding device and referenced by an image decoding device.

### REFERENCE SIGNS LIST

1 video image decoding device (image decoding device)
10 decoding module
11 CU information decoding section (residual mode decoding section, CU partitioning flag decoding section)
12 PU information decoding section
13 TU information decoding section (residual mode decoding section, TU partitioning flag decoding section)
16 frame memory
2 video image coding device (image coding device)
131 TU partition setting section
21 coding setting section
25 frame memory
29 coded data generating section (CU partitioning flag coding section, TU partitioning flag decoding section, residual mode coding section)

1. An image decoding device that decodes by partitioning a picture into coding tree block units, characterized by comprising:
a coding tree partitioning section that recursively partitions the coding tree block as a root coding tree;
a CU partitioning flag decoding section that decodes a coding unit partitioning flag indicating whether or not to partition the coding tree; and
a residual mode decoding section that decodes a residual mode indicating whether to decode a residual of the coding tree and below in a first mode, or in a second mode different from the first mode.

2. The image decoding device according to claim 1, characterized in that
the residual mode decoding section decodes the residual mode (rru_flag) from the coded data only in the highest-layer coding tree, and does not decode the residual mode (rru_flag) in lower coding trees.

3. The image decoding device according to claim 1, characterized in that
the residual mode decoding section decodes the residual mode only in the coding tree of a designated layer, and skips the decoding of the residual mode outside the coding tree of a designated layer in lower coding trees.

4. The image decoding device according to claim 1, characterized in that
in a case in which the residual mode indicates decoding in the second mode, the CU partitioning flag decoding section decreases the partitioning depth by 1 compared to a case in which the residual mode indicates decoding in the first mode.

5. The image decoding device according to claim 1, characterized in that
the CU partitioning flag decoding section, in a case in which the residual mode is the first mode,
decodes the CU partitioning flag from the coded data in a case in which a size of the coding tree, namely a coding block size (log2CbSize) is greater than a minimum coding block (MinCbLog2Size),
in a case in which the residual mode is the second mode,
decodes the CU partitioning flag from the coded data in a case in which the size of the coding tree, namely the coding block size (log2CbSize) is greater than the minimum coding block (MinCbLog2Size+1), and
in all other cases, skips the decoding of the CU partitioning flag, and derives the CU partitioning flag as 0, which indicates not to partition.

6. The image decoding device according to claim 1, characterized in that
the residual mode decoding section decodes the residual mode in a leaf coding tree, namely a coding unit.

7. The image decoding device according to claim 6, characterized by comprising:
a skip flag decoding section that, in the leaf coding tree, namely the coding unit, decodes a skip flag indicating whether or not to decode by skipping the decoding of the residual, wherein
the residual mode decoding section, in the coding unit,
decodes the residual mode in a case in which the skip flag indicates not to decode the residual, and
in all other cases, does not decode the residual mode.

8. The image decoding device according to claim 6, characterized by comprising:
a CBF flag decoding section that decodes a CBF flag indicating whether or not the coding unit includes the residual, wherein
the residual mode decoding section,
decodes the residual mode in a case in which the CBF flag indicates that the residual exists, and
in all other cases, derives the residual mode indicating that the residual mode is the first mode.

9. The image decoding device according to claim 6, characterized in that
the residual mode decoding section
decodes the residual mode from the coded data in a case in which a size of the coding tree, namely a coding block size (log2CbSize), is greater than a predetermined minimum coding block size (MinCbLog2Size), and
in all other cases, derives the residual mode as the first mode in a case in which the residual mode does not exist in the coded data.

10. The image decoding device according to claim 6, characterized by comprising:
a PU partitioning mode decoding section that decodes a PU partitioning mode indicating whether or not to further partition the coding unit into prediction blocks, wherein
the residual mode decoding section
decodes the residual mode only in a case in which the PU partitioning mode is a value indicating not to PU partition, and
in all other cases, does not decode the residual mode.

11. The image decoding device according to claim 6, characterized by comprising:
a PU partitioning mode decoding section that decodes a PU partitioning mode indicating whether or not to further partition the coding unit into prediction blocks, wherein
the PU partitioning mode decoding section,
in a case in which the residual mode indicates the second mode, skips the decoding of the PU partitioning mode, and derives a value indicating not to PU partition, and
in a case in which the residual mode indicates the first mode, decodes the PU partitioning mode.

12. The image decoding device according to claim 1, characterized by comprising:
a PU partitioning mode decoding section that decodes a PU partitioning mode indicating whether or not to further partition the coding unit into prediction blocks, wherein
the PU partitioning mode decoding section,
in a case in which the residual mode indicates the second mode, decodes the PU partitioning mode if the coding block size (log2CbSize) is equal to the sum of the minimum coding block (MinCbLog2Size) and 1 (MinCbLog2Size+1),
in a case in which the residual mode indicates the first mode, decodes the PU partitioning mode if inter or if the coding block size (log2CbSize) is equal to the minimum coding block (MinCbLog2Size), and
in all other cases, skips the decoding of the PU partitioning mode, and derives a value indicating not to PU partition.

13. The image decoding device according to claim 1, characterized by comprising:
a TU partitioning mode decoding section that decodes a TU partitioning mode indicating whether or not to further partition the coding unit into transform blocks, wherein
the TU partitioning mode decoding section,
in a case in which the residual mode indicates the second mode, decodes the TU partitioning flag if the coding block size (log2CbSize) is less than or equal to the sum of a maximum transform block (MaxTbLog2SizeY) and 1 (MaxTbLog2SizeY+1) and also greater than the sum of a minimum transform block (MinCbLog2Size) and 1 (MinCbLog2Size+1),
in a case in which the residual mode indicates the first mode, decodes the TU partitioning flag if the coding block size (log2CbSize) is less than or equal to the maximum transform block (MaxTbLog2SizeY) and also greater than the minimum transform block (MinCbLog2Size), and
in all other cases, skips the decoding of the TU partitioning flag, and derives a value of the TU partitioning flag indicating not to partition.

14. The image decoding device according to claim 1, characterized by comprising:
a TU partitioning mode decoding section that decodes a TU partitioning mode indicating whether or not to further partition the coding unit into transform blocks, wherein
the TU partitioning mode decoding section,
in a case in which the residual mode indicates the second mode, decodes the TU partitioning flag if a coding transform depth (trafoDepth) is less than the difference between a maximum coding depth (MaxTrafoDepth) and 1 (MaxTrafoDepth−1),
in a case in which the residual mode indicates the first mode, decodes the TU partitioning flag if the coding transform depth (trafoDepth) is less than the maximum coding depth (MaxTrafoDepth), and
in all other cases, skips the decoding of the TU partitioning flag, and derives a value indicating not to partition.

15. The image decoding device according to claim 1, characterized by comprising:
a residual decoding section that decodes the residual; and
an inverse quantization section that inversely quantizes that inversely quantizes the decoded residual, wherein
the inverse quantization section,
in a case in which the residual mode is the first mode, performs inverse quantization according to a first quantization step, and
in a case in which the residual mode is the second mode, performs inverse quantization according to a second quantization step derived from the first quantization step.

16. The image decoding device according to claim 15, characterized by comprising:
a quantization step control information decoding section that decodes a quantization step correction value, wherein
the inverse quantization section derives the second quantization step by adding the quantization step correction value of the first quantization step.

17. An image decoding device that partitions a picture into units of slices, and further partitions each slice into units of coding tree blocks, characterized in that a highest-layer block size inside each slice is made to be variable.

18. The image decoding device according to claim 16, characterized by
decoding a value indicating a horizontal position and a value indicating a vertical position of a beginning of a slice.

19. The image decoding device according to claim 16, characterized by
decoding a value indicating a beginning address of the beginning of the slice, and on a basis of a smallest block size among highest-layer block sizes available for selection, deriving the horizontal position and the vertical position of a slice beginning position or a target block.

20. An image coding device that codes by partitioning a picture into coding tree block units, characterized by comprising:
a coding tree partitioning section that recursively partitions the coding tree block as a root coding tree;
a CU partitioning flag decoding section that codes a coding unit partitioning flag indicating whether or not to partition the coding tree; and
a residual mode decoding section that codes a residual mode indicating whether to decode a residual of the coding tree and below in a first mode, or code in a second mode different from the first mode.
